(19) United States
(12) Patent Application Publication
(10) Pub. No.: US 2019/0050532 A1
(43) Pub. Date: Feb. 14, 2019

(54) Distributed systems and methods for learning about a bioprocess from redox indicators and local conditions

(71) Applicant: BioElectron Technology Corporation, Mountain View, CA (US)

(72) Inventor: Stephen J. Brown, Woodside, CA (US)

(21) Appl. No.: 15/675,364

(22) Filed: Aug. 11, 2017

(51) Int. Cl. G06F 19/24; G06F 19/12

(52) U.S. Cl. CPC G06F 19/24; G06F 19/12

(57) ABSTRACT

The present invention concerns methods and systems for learning about the redox status of a biological process experienced by a biological entity under local conditions by postulating hidden states that are locally inaccessible but are related to the redox status. The learning system uses a reference bioprocess model from which a master learner establishes an observable basis of redox indicators that are real-valued, measureable, and exclude hidden states. Meanwhile, a local learner receives at least a portion of model redox data from the reference bioprocess model, and measured redox data from the biological entity. The learning system runs a distributed learning algorithm using the observable basis established by the master learner to determine an optimal composition of redox data to be included in measured redox data collected under local conditions.

### FIELD OF THE INVENTION

The present invention relates to apparatus and methods for applying distributed computer learning algorithms to bioprocesses at both the level of reduction-oxidation (redox) reactions that are not directly observable and thus assigned to hidden states, and at the level of local conditions under which the bioprocesses of interest occur in biological entities of interest. Relevant biological entities cover biological systems such as bioreactors, and also living entities such as live plants, animals, cells, cell cultures and human subjects.

### BACKGROUND OF THE INVENTION

By most definitions, all entities or systems undergoing a biological process or a bioprocess are considered to be alive. Living biological entities range from biological systems, e.g., biomasses in controlled bioreactors, to living organisms. The latter include animals and plants. Often, biological entities at this level are viewed in the context of their environments or local conditions that are either conducive to their existence or not.

Living entities on planet Earth can be broken down into bacteria, archaea and eukaryotes. Their sizes, from smallest to largest, span many orders of magnitude. The bioprocesses that these biological entities undergo are extremely varied and highly complex. The study of biological entities at this level belongs to the fields of biology, ecology, zoology and botany.

Despite the truly remarkable amount of differentiation among biological entities, they do share common structures and operating principles. One such operating principle is that all biological entities depend on harvesting external energy sources to stay alive. In terms of common structures, all biological entities, except perhaps viruses, are made up of a smallest basic living component: the cell. While being the smallest units of life, cells also coincide with the smallest living biological entities of interest: bacteria.

At the cell level, life is again found to exhibit myriads of complex structures and processes. The processes of interest happen here on much shorter time scales than at the higher level of multi-cellular biological entities. A new set of common operating principles and shared structures are found at the cell level.

In particular, processes occurring at the cell level are described by molecular biology and biochemistry. They can be understood in terms of biochemical structures and reactions. The most important biochemical reactions include construction, replication, feeding, repair, energy regulation, and carrying out of primary cell functions (dependent on cell type).

Below the cell level is the realm of processes and structures operating on still shorter time scales. It is the level of physical organic chemistry and, ultimately, quantum chemistry and quantum physics. The latter govern the actions of atoms and of small molecules by rules that transcend classical logic and assumptions.

Even the ability to assign probabilities to measurements in this realm is conditional. It is preceded by operations on propensities that depend on context and are unobservable even in principle. (We are referring here to entities such as electron wave functions.) Still, common structures and processes are found even at this level.

Many approaches and techniques for understanding the structures and processes of physical organic chemistry have been proposed over the past fifty years. One prominent modeling approach attempting to explain the relationship between specific structures and activities is the Quantitative Structure-Activity Relationship (QSAR) model. QSAR was introduced by Corwin Hansch et al. in 1962. An excellent text describing this contribution and the consequent approaches developed form it is provided by Hugo Kubinyi, “QSAR: Hansch Analysis and Related Approaches”, Methods and Principles in Medicinal Chemistry, New York, 1993.

More recent 3D QSAR and Comparative Molecular Field Analysis (CoMFA) models have attempted to apply quantum-chemical tools to determine chemical reactivity at the level of physical organic chemistry. These models track the formation of hydrogen bonds, proton movement/hopping, electron exchanges and/or oxidation-reduction (redox) reactions as well as steric effects. The latter affect ligand binding preferences and are also related 3D alignment effects. Although the practice of 3D QSAR is inherently limited to local models at this level of study, it can be expected to make further progress. Specifically, the expansion of published databases such as ChEMBL and PubChem along with annotations and 3D alignment protocols, may continue to provide better validated physical organic chemistry models for both screening (e.g., drug or toxic substance screening) and machine learning applications in this field. An excellent summary of the present state of the art in this realm is afforded by Cherkasov, et al., “QSAR Modeling: Where have you been? Where are you going to?”, J. Med. Chem., Volume 57, No. 12, Jun. 26, 2014, pp. 4977-5010 and the numerous references cited therein.

Systems biology examines life as it builds on top of the low level of physical organic chemistry, which is in the purview of 3D QSAR and other Field Models addressed above. Systems biology is further informed by data collected in the various-omes, and in particular the genome and the proteome. In examining the Genome-Protein-Reaction (GPR) chain, systems biology brings to bear traditional tools of applied mathematics and linear algebra. It has attempted to deploy these tools to model biology in terms of metabolic networks, elements, reactions, fluxes as they act under certain constraints to achieve local equilibria or homeostasis. The differential equations of systems biology address processes that attempt to reach the level of entire cells and even entire multi-cellular biological entities.

Systems biology has advanced the understanding of structure and biological function of simple single celled biological entities. For example, a curated genome-scale metabolic network reconstruction of Escherichia coli has been achieved in the recent past. A general review of the state of the art in systems biology is found in the textbook by Bernhard O. Palsson, “Systems Biology: Constraint-based Reconstruction and Analysis”, Dept. of Bioengineering, University of California San Diego, Cambridge University Press, 2015, and in the sources recited therein.

As is likely already clear from the above, division of life into various levels of study can only take us so far. Reconstruction from the genome information of the overall cell proteins and structure is not sufficient to tell us what regulatory processes are active at shorter time scales, e.g., in the physical chemistry layer. Thus, understanding the translation of the genetic code into proteins provides only a background against which the processes of physical chemistry unfold. Specifically, regulatory mechanisms involving the available enzymes that catalyze the millions of cell reactions occurring during each second have to be included in order to understand cell regulation. Still differently put, many of the crucial effects and regulatory mechanisms are found in the interstices between levels at which the life of the biological entity and its cells is being investigated. We also observe direct inter-level effects. Activity at the physical chemistry level, i.e., below the cell level, directly affects activity and structure at the cell level and at the level of the biological entity and its local conditions or environment.

These considerations bring back into focus the physical chemistry processes that involve the transfer of electrons and proton hopping. These processes are due to underlying field effects and molecular conformations (topology). They are generally known as reduction-oxidation reactions. Their effects occur at the cell level. Indeed, within any cell there are a number of specialized enzymes and affiliated compounds that are also involved in the regulation of these reactions. They include enzymes generally categorized as oxidoreductases, as well as their co-factors and other electron carrying molecules and/or complexes. These enzymes, co-factors and complexes participate in redox reactions to provide a critical level of balance and regulation for bioprocesses. For an introductory level review of these issues the reader is referred to standard texts, such as Bruce Alberts et al., “Molecular Biology of the Cell”, Garland Science, 5^{th} Edition, New York, 2008.

In their seminal article, Bucher, T. and Klingenberg M., “Pathways of hydrogen in the living organization”, Angewandte Chemie (Applied Chemistry), 70, pp. 225-570, 1958 examined the pathways of hydrogen in a living organization of a biological system or biological entity (bio-entity). This study addressed the interactions within the network of redox reactions extending over essential functions of living cells. The crucial nature of redox systems and redox reactions in bioprocesses occurring in biological systems and entities was thus firmly established. A redox code for classifying redox reactions was developed. The redox code consists of four principles by which biological systems and entities are organized.

The first redox principle is the use of the reversible electron accepting and donating properties in NAD and NADP to provide organization of metabolism (at or near equilibrium). The second redox principle is the use of redox electron transfers to adjust protein structure through kinetically controlled redox switches (a.k.a. S-switches or Sulphur switches) in the proteome to control tertiary structure, macromolecular interactions and trafficking, activity and function. The third redox principle is redox sensing as used in activation/deactivation cycles of redox metabolism, especially involving H₂O₂, support of spatiotemporal sequencing in differentiation and life cycles of cells and biological entities, e.g., organisms. The fourth principle is that redox networks form an adaptive system to respond to local conditions including the external environment. This adaptive system extends from micro-compartments through subcellular systems to the level of the cell and still further to tissue organization. A detailed explanation of these four redox principles is found in Jones, Dean P. et al., “The Redox Code”, Review Article appearing in Antioxidants and Redox Signaling, Vol. 0, No. 0, 2015, pp. 1-14. Further background provided by the same main author on select redox couples can be found in Jones, Dean P. et al., “Cysteine/cysteine couple is a newly recognized node in the circuitry for biologic redox signaling and control”, The FASEB Journal, Vol. 18, August, 2004, pp. 1246-1248.

Certain redox reactions and the electron balances they establish have been proposed to monitor cell status (e.g., oxidative stress) in some contexts. For example, U.S. Pat. No. 9,273,343 to Cali et al. suggests the use of compounds and methods for assaying the redox state of metabolically active cells and for measuring NAD(P)NAD(P)H balance. Tracking of certain redox reactions in conjunction with genome-scale metabolic network reconstruction has also been considered in U.S. Pat. No. 8,311,790 to Senger et al. This teaching addresses the identification of incomplete metabolic pathways to allow for the completion of genome-scale metabolic network for C. acetobutylicum. The program could thus provide a potential model of a genome-scale stoichiometric matrix that could attempt to model cell growth in silico.

The use of redox reactions for detecting certain analytes has also been investigated beyond the normal cell environment, e.g., in vitro. For example, U.S. Pat. No. 7,807,402 to Horn et al. proposes a method and reagent for detecting the presence and/or the amount of a certain analyte by a redox reaction and a fluorimetric determination. The redox reaction would be monitored here by a certain redox indicator. The oxidizing or reducing system would act directly on the redox indicator or via a mediator. The presence of the analyte would result in a reduction or oxidation of the redox indicator, which would allow for a qualitative or quantitative determination. U.S. Pat. No. 9,605,295 to Yau suggests an ultrasensitive and selective system and method for detecting certain reactants of the chemical/biochemical reaction catalyzed by an oxidoreductase. The action of the electrical field is suggested to facilitate the interfacial electron transfer between oxidoreductase and the working electrode of his electrochemical system by the quantum mechanical tunneling effect. Additional teachings of Yau involving bio-reactive systems and their voltage-controlled metabolism are found in U.S. Pat. Appl. No. 2016/0333301.

Within a living cell, redox status is often not directly observable or measurable for practical reasons. Concomitantly, influencing the electron balance in a biological entity, and especially in a large organism, has been problematic. U.S. Pat. Appl. No. 2016/0166830 to Avent et al. illustrates the difficulties in devising systems, devices and methods to selectively provide antioxidant or pro-oxidant effects to control free radical damage in an organism. The therapeutic electron and ion transfer via half-cell involves providing electrodes, which may include syringe needles, to establish conductive paths to or from the organism, e.g., a human patient.

In principles, a needle-type testing apparatus could be miniaturized and improved by leveraging MEMS technologies for specific analytes. Examples of such apparatus and methods proposed to measure certain chemical species in biological samples, including certain specific reduction-oxidation potentials are found in the literature. The reader is referred to Hyoung-Lee, W. et al., “Needle-type environmental microsensors: design, construction and uses of microelectrodes and multi-analyte MEMS sensor arrays”, Measurement Science and Technology, Vol. 22, March 2011 (22 pgs.) and to Lee, Jin-Hwan et al., “MEMS Needle-type Sensor Array for in Situ Measurements of Dissolved Oxygen and Redox Potential”, Environmental Science and Technology, Vol. 42, No. 22, 2007, pp. 7857-7863.

Clearly, access to observing hidden states even with highly specific targets within a functioning cell or organism remains a challenge. Even if it were technically feasible, the observation or measurement of an electron balance condition between specific redox participants such as known redox couples is not desirable under most local conditions where the biological entity of interest undergoes the bioprocess to be monitored. Consider when the biological entity is instantiated by liver cells, and the local conditions under which the subject whose liver cells are to be monitored are dictated by typical home and work routine. Deploying a needle-type sensor directly into such subject's liver on a frequent basis is not feasible.

Thus, despite the advanced state of the art with respect to very specific redox reactions with known functions, the study of biological entities and systems in light of the redox reactions they undergo lacks in proper contextualization. Differently put, the local conditions under which the biological entities experience the bioprocesses need to be reflected in the systems that learn and produce the models. Given the multitude of processes and structures at the many levels or scales on which life transpires, it is important to use models of redox reactions and measurements obtained via appropriate redox indicators in a more complete and context-sensitive manner.

More importantly, the state of the art only has been able to determine the biological function of a small subset of the 584 oxidoreductases encoded by the human genome. 28% have no function ascribed, and 50% have no function or only chemical function definition ascribed but no biological definition associated. Even less is known about the redox activity of small molecules or co-factors. Of the thousands of potential co-factors that may be important to metabolism, only a small fraction is known or has been characterized with respect to their biological importance. Still less is understood about the contexts in which these compounds may be relevant or the context-dependence of their function, as the patterns of redox reactions important to synchronizing the metabolism common and fundamental to all life forms may be subject to significant variation given such a wide range of environmental stressors, nutrient inputs, competition for resources, and other contexts. A single cell will execute over a billion chemical reactions per second in the synthesis of energy alone, yet today very little is understood about how nature performs this function. DNA-based control mechanisms lack the features required to carry out tasks of such complexity and speed, and the biochemical pathway maps generated since the 1950s do not accurately reflect the complexity or control of biological systems.

The inability to define and measure all of the chemicals that are essential for life, their interrelationships, and the control of metabolism has created a roadblock. This is impeding solutions to a wide range of problems in life sciences and industrial biotechnology.

For example, the current definition of health is simply the absence of disease. On the other hand, there are few predictive metrics for helping to ensure wellness. Definitions of nutrition change dramatically while the full set of molecules required for humans to thrive is not known. Petroleum is used intensively as the feedstock for the chemical manufacturing industry, and the world has not harnessed the potential of industrial biotechnology. Policies for climate change are not sufficiently based on objective measures of the planetary biota, therefore no one can accurately assess the effectiveness of these policies. The current approach to solving all of these problems is DNA-based. While DNA tools have yielded valuable insights, this approach fundamentally cannot account for the control of a system that can execute over a billion reactions per second. DNA and DNA-derived objects do not possess the temporal or spatial properties to control a system of such complexity. A new approach is needed.

What is lacking are learning systems and methods that measure a broader set of chemicals and other redox data and identify patterns of potential redox indicators from alternative compartments and/or from otherwise imprecise sensors. It would be desirable for such learning systems and methods to learn new patterns from field or local measurements in learned local contexts, rather than only in the highly controlled lab environment.

### Objects and Advantages

In view of the shortcomings of the prior art, provided herein are learning systems and methods that deploy distributed learning algorithms in a manner that permits improved learning from redox reactions under local conditions in which the biological entity of interest is embedded.

In addition, the systems and methods described herein may reduce reliance on expensive laboratory testing equipment in lab settings and to promote less expensive field or local measurement systems. Use of less expensive equipment and sensors can still be effective in estimating redox data under generally less controlled local conditions where one or more biological entities are undergoing the bioprocess of interest. This can be addressed through the application of distributed learning.

Also provided are distributed learning algorithms that adjust for inter-level relationships between processes and structures in light of redox reactions.

Distributed learning algorithms that learn about redox indicators and appropriate observable bases of such redox indicators in light of local conditions are also provided.

These and other objects and advantages of the invention will become apparent upon reading the detailed specification and reviewing the accompanying drawing figures.

### SUMMARY OF THE INVENTION

The present invention relates to computer implemented learning methods and systems that can learn about the redox status of a biological process or bioprocess. The bioprocess is experienced by a local biological entity as it undergoes the bioprocess under field or local conditions. Given that the redox status is not a directly observable parameter of any typical biological system under local conditions it will be considered as indirect, inferred or otherwise derived knowledge. Correspondingly, the bioprocess is postulated to have hidden states that are not directly observable by measuring equipment or sensors deployed under local conditions. The hidden states may, and in typical embodiments of the present invention will, include unknown states beyond those of just the redox status of the bioprocess that the biological entity is experiencing.

The bioprocess from which the learning system learns or on which it can be trained is a reference bioprocess model. The reference bioprocess model is preferably obtained from a reference biological entity. The reference bioprocess model yields redox data of reference biological entity performing the bioprocess in a controlled environment or under model conditions. Depending on application, such reference biological entity can be a living reference subject or a reference bioreactor that is undergoing or performing the bioprocess of interest. In other words, the reference bioprocess model is derived from an empirical bioprocess under model conditions. For example, the reference bioprocess can be performed in lab settings or in a bioreactor operating in a controlled facility.

In many cases the reference bioprocess model may be set up or configured such that it can yield useful model redox data about the bioprocess, despite the fact that the redox status may not be observable directly and the bioprocess has hidden states. In other words, a judicious choice of model redox data is used to operate the learning system. More specifically, model redox data should be such that a master learner configured to receive it is able to establish from it an observable basis of redox indicators. An observable basis excludes any hidden states or otherwise hidden or inaccessible data. Thus, any vector spaces established using the observable basis of redox indicators are real-valued and measurable. Any candidate redox indicators in such vector spaces can be assigned real values and measured.

Learning systems according to aspects of the invention may require a local biological entity that performs or undergoes the bioprocess of interest. This is the bioprocess for which the reference bioprocess model has been configured under lab or model conditions. Meanwhile, if the local biological entity is a live subject then it undergoes the bioprocess under local conditions, such as in their natural environment or habitat. If the local biological entity is a bioreactor then it may or may not be a significantly down-scaled reactor in comparison to the reference bioreactor. In either case of the biological entity being a live subject or a bioreactor, the local or field measurement system employed is typically down-scaled compared to the measurement systems available in the laboratory, but not necessarily less accurate in the measurements that it does perform. In other words, its ability to capture accurate measurement data under local conditions may be just as high or even higher than that of the reference bioprocess taking place under lab conditions. This can be because the field or local measurement system may have access to more contextual data that is not available in the lab.

The local biological entity undergoing the bioprocess under local conditions generates measured redox data for the bioprocess. The measured redox data typically includes far fewer features than model redox data on which the reference bioprocess model is based. However, the measured redox data can be highly accurate in some embodiments.

The learning system has a local learner typically capable of being implemented in a hardware unit with lower measuring and processing capabilities, lower-power, or lower-bandwidth requirements in comparison to the measuring and processing capabilities of the reference bioprocess model and its references. The local learner receives at least a portion of model redox data from the reference bioprocess model. This portion may contain only model redox data relevant to local conditions or otherwise limited model redox data. In addition, the model redox data may also contain an initial reference learning model and any initial weights or starting points for the local learner. On the other hand, the local learner receives all of the measured redox data from the local biological entity undergoing the bioprocess, including contextual data.

The learning system runs or deploys a learning algorithm that is distributed between the master learner and the local learner. This distributed learning algorithm thus has access to model redox data and measured redox data. By virtue of such distribution the learning algorithm also has access to the observable basis of redox indicators picked or established by the master learner from the model redox data yielded by the reference bioprocess model. It is the purpose of the distributed learning algorithm of the learning system to determine or learn an optimal composition of redox data to be chosen on included in the measured redox data that is collected under local condition from the biological entity undergoing the bioprocess.

The measured redox data may contain data that does not directly pertain to or represent any redox indicators in the observable basis. For example, measured redox data may contain data with proposed, uncertain or as yet unknown biological function or relationship to redox indicators. It may also contain contextual data. Measured redox data may also contain data from systems associated with downstream effects of a prolonged imbalance or defect in the redox system. For example, this data may pertain to biomarkers of chronic inflammation and systemic oxidative stress. It may also be data related to diseases and conditions that may have a relationship to oxidative stress or inflammation. It may also be data the indicates when or in what context the data is or is not to be considered.

The measured redox data is also understood to include contextual data, data about probabilities, measurement accuracy or practical considerations, statistical relationships and/or any or other information that appears to pertain or may be found through learning by the distributed learning algorithm to pertain to one or more redox indicators.

Advantageously, the measured redox data is reduced to just a few of the redox indicators that are also found in the observable basis established by the master learner. Under these conditions the measures of the local bioprocess can focus on just observable measures, i.e., observable redox indicators in the real vector space. This real and observable basis does not include any hidden states or otherwise hidden or inaccessible data. The learning algorithm can further condition the observable redox indicators by assigning a weighting or a confidence level. The weighting can be related to measurement confidence, practicality, availability, cost or other factors. Furthermore, since the reactions of interest concern electron balance, the learning algorithm can focus on just observable redox indicators that are measured on time scales shorter than Gene-Protein-Reaction (GPR) time. That is because GPR processes may be considered as relatively static; they are the background or scaffolding upon which the redox reactions take place.

Upon learning from both the reference bioprocess model and the local bioprocess the learning algorithm can change or adjust the redox indicators used in the observable basis. This learned adjustment in the observable basis of redox indicators is communicated to the local learner. Also, the reference bioprocess model can be configured to receive a reference model adjustment from the learning algorithm based on the learning. The reference model adjustment can involve an alteration in the model redox data, an alteration in the model conditions or an alteration in the hidden states postulated to exist in the model.

Similarly, the learning algorithm can learn how to adjust for changes in local conditions and/or contexts. For this reason, the at least one local entity that is undergoing the bioprocess can be configured to receive a local conditions adjustment from the learning algorithm via whatever local affordances are available. The local conditions adjustment can involve an alteration in the optimal composition of measured redox data, e.g., to account for availability, accuracy, practicality or cost of local measurement. Alternatively, this adjustment can be factored in a conditioning module that applies weights and confidence levels.

The learning system is implemented with one or more feedback loops. In particular, a primary feedback loop is provided between the master learner and the local learner. This primary loop is used to communicate the measured redox data and, more importantly, changes or adjustments to the content or type of the measured redox data. When measured redox data contains only observable redox indicators and/or candidates for such observable redox indicators, then the primary loop can interface directly with local measurement and control instruments. Thus, the primary feedback loop can be advantageously configured for adjusting the redox indicators in the observable basis.

In some embodiments, the primary feedback loop also has a primary feedback mechanism. The primary feedback mechanism is configured to operate on at least one control parameter, which will typically also be a redox indicator or a known redox influencer (if such a redox indicator can be acted upon directly). In general, the control parameter can be a redox active compound or an electron balance influencer, or still other input that can act upon the bioprocess transpiring in the local biological entity under local conditions.

The learning system typically has a secondary feedback loop between the local learner and the at least one local biological entity undergoing the bioprocess. There is also a local feedback mechanism between the local learner and the local biological entity. Of course, there may be cases in which control of the local bioprocess is impossible or impractical. No local feedback mechanism may be present in such embodiments. In other embodiments, the control mechanism may be in the form of a recommendation to an operator or to the subject to change a behavior of a system input.

The local feedback mechanism can be configured to operate on at least one control parameter, which will typically also be a redox indicator (if such a redox indicator can be acted upon directly). As above, the control parameter can be a redox active compound, an electron balance influencer or other input that can act upon the bioprocess transpiring in the local biological entity. Still other examples include changes to activity, such as stirring or aeration adjustments in the case of a local bioreactor. In a physical activity of a live subject there could be adjustments to inputs of glucose, food, nutrients or other system inputs.

The learning system can employ many general methods that extend beyond the method used by the learning algorithm. In other words, the learning algorithm that engages in learning the optimal composition of measured redox data or of observable redox indicators, say by choosing them from a general set of redox indicators need not be implemented within any one particular learning paradigm. In fact, the learning system can employ one or more learning methods. Some particularly useful methods in the embodiments of the present invention include Artificial Intelligence (AI) methods, Hidden Markov methods and Deep Learning (multi-layered neural network) methods. Any of these methods can be implemented in the recursive feedback structure presented by the learning system of the invention.

Sometimes, as a result of the learning performed by the learning system it may become necessary to change the operation of the reference biological entity undergoing the bioprocess on which the model is based. In such cases, a reference feedback mechanism can be provided between the master learner and the reference biological entity. If there is no physical reference biological entity that provides model redox data, i.e., there is neither a reference bioreactor or a reference live organism including even a human subject then it may become necessary to simply tune or adjust the reference bioprocess model.

In general, and independent of the selection of control parameters, and observable redox indicators the redox data should contain at least one known and reliable redox indicator and at least one well known electron balance influencer.

Well established and commonly accepted redox indicators may also be referred to as electron balance indicators. Particularly useful and established electron balance indicators include indicators consisting of an oxidoreductase, an oxidoreductase co-factor, an electron balance influencer compound, an electron balance influencer composition, a redox-active compound, a pK value, a pH value, a threshold value, a context measure and a soft indicator. Furthermore, it is known that useful redox indicators or electron balance indicators should be measured on short time scales in comparison to GPR times, as already indicated above. Hence in advantageous embodiments the at least one electron balance indicator is measured with a frequency of at least once every hour, at least once every 30 minutes, at least once every 10 minutes, at least once every 5 minutes, at least once every minute, at least once every 30 seconds, at least once every 10 seconds, at least once every 5 seconds, at least once every second, at least twice every second, at least 5 times every second, at least 10 times every second, at least 20 times every second, at least 50 times every second, at least 100 times every second, or more.

The computer implemented learning methods learn to describe the redox status of the biological entity undergoing the bioprocess. With the knowledge that the bioprocess has hidden states that are inaccessible to direct measurement in the local biological entity, the method calls for defining what model redox data should be relied on by the bioprocess based on the reference bioprocess model. The model redox data is transmitted to the master learner that establishes from it the observable basis of redox indicators. In establishing the observable basis of redox indicators the master learner takes into account the control and measuring affordances available to the entire learning system, and especially to the local bioreactor. These include any constraints of the local measurement system such as availability, accuracy, practicality or cost of measurements under local conditions. As already pointed out above, these will be typically parts of the feedback mechanisms including, in particular, the local and the reference feedback mechanisms.

The method also calls for performing the bioprocess in the local biological entity to generate the measured redox data for the bioprocess. In some embodiments the bioprocess will occur without supervision, while in other cases the bioprocess can be a tightly supervised process. In any case, the bioprocess in the local biological entity will typically occur under much less controlled conditions than those of the reference biological entity that was used in the reference bioprocess model.

The method further calls for transmitting at least a portion of model redox data and the measured redox data to the local learner. Now, the learning system can deploy its distributed learning algorithm to learn the optimal composition of measured redox data that should be culled from the local biological entity running the bioprocess. Of course, it is preferable to work with redox data that represents select redox indicators in the observable basis. This will ensure that the indicators are all measurable, and most preferably, measurable under local conditions or in the local context. The results of the learning can translate into assigning weightings and/or confidence levels to the observable redox indicators. The step of assigning such weightings and/or confidence levels is performed by the distributed learning algorithm, typically with the aid of a conditioning module.

Since redox status relates to very rapidly occurring reactions, the observable redox indicators are typically measured on short time scales. In a preferred embodiment, the step of measuring is performed or repeated on time scales shorter than GPR time.

The present invention, including the preferred embodiment, will now be described in detail in the below detailed description with reference to the attached drawing figures.

### BRIEF DESCRIPTION OF THE DRAWING FIGURES

FIG. 1A is a high-level diagram of the main parts of a learning system in accordance with the invention in which the biological entity of interest is a bioreactor

FIG. 1B is a high-level diagram of the main parts of a learning system in accordance with the invention in which several local biological entities of interest are live subjects

FIG. 2A is a diagram illustrating an exemplary set of measured redox data

FIG. 2B is a diagram illustrating an exemplary subset of redox data and an exemplary optimal composition of measured redox data

FIG. 2C is a diagram showing the transmission of measured redox data from a subject under local conditions and model redox data from the reference bioprocess model to the master learner

FIG. 2D is a diagram showing the representation of hidden states in the model used by the learning algorithm

FIG. 2E is a diagram showing the details of transitions between hidden states, measurement probabilities and assignment of confidence levels and weightings

FIG. 3 is a diagram illustrating an embodiment using a joint feature vector and deploying a neural net in the learning model of the distributed learning algorithm

FIG. 4A is a diagram illustrating local bioprocess occurring under local conditions with adjustments to local control parameters by a primary feedback mechanism

FIG. 4B is a diagram illustrating local bioprocess occurring under local conditions with adjustments to local control parameters by a local feedback mechanism

FIG. 5 is a diagram illustrating a reference bioprocess performed in a reference bioreactor with adjustments to reference control parameters

FIG. 6 is a diagram illustrating a preliminary learning model with abstract representation of the hidden states

### DETAILED DESCRIPTION

The drawing figures and the following description relate to preferred embodiments of the present invention by way of illustration only. It should be noted that from the following discussion many alternative embodiments of the methods and systems disclosed herein will be readily recognized as viable options. These may be employed without straying from the principles of the claimed invention. Likewise, the figures depict embodiments of the present invention for purposes of illustration only.

### General Configuration of Learning System

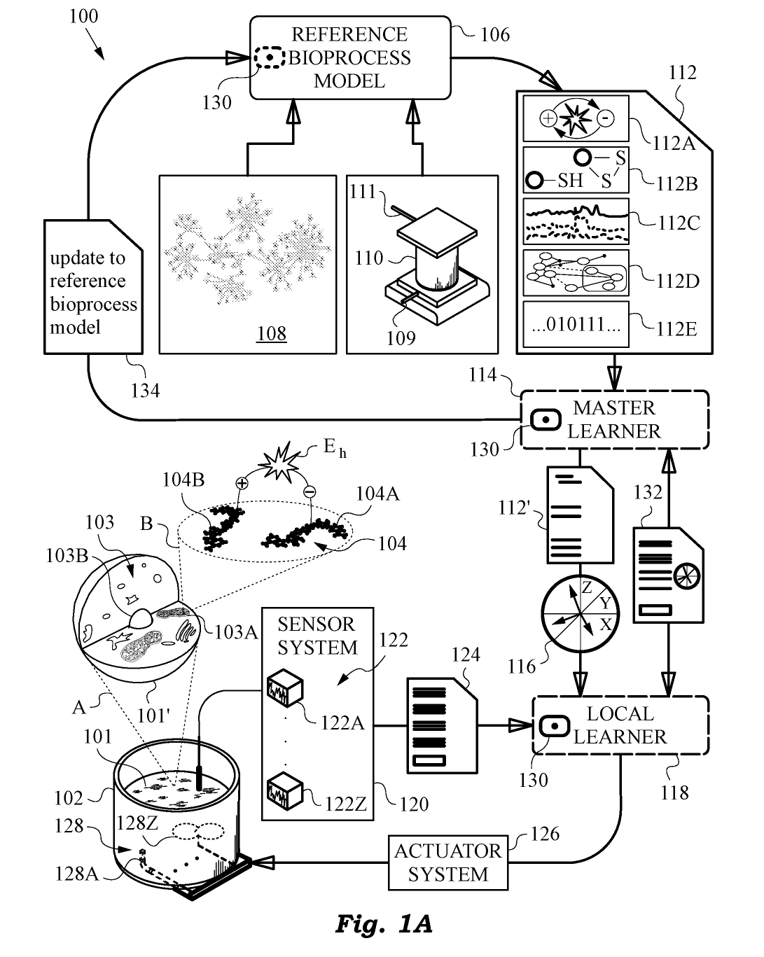

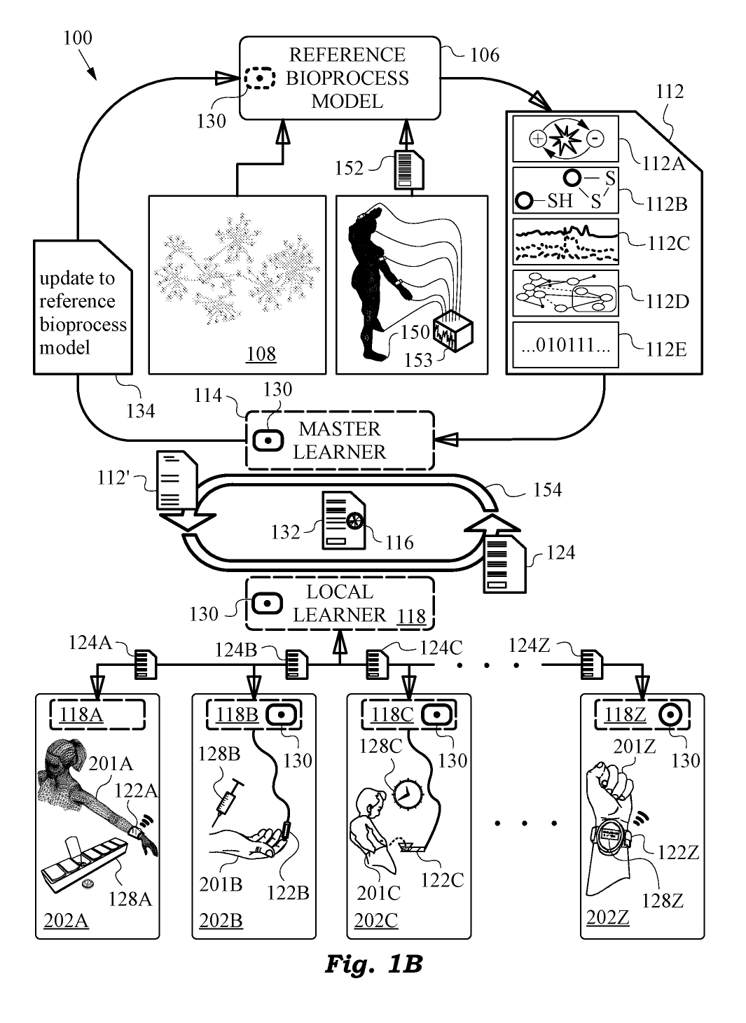

Computer implemented learning methods and systems described herein will be best appreciated by initially reviewing the high-level diagram of FIG. 1A. This diagram shows the main parts and interconnections of a learning system 100 configured to learn about a redox status of a biological process or bioprocess. The bioprocess is being experienced by a local biological entity 101. In this example, local biological entity 101 is a biomass, a cell culture, one or more organisms, a biomaterial or a biologically active substance or substances undergoing the bioprocess of interest in a bioreactor 102.

Bioreactor 102 should be understood to include dedicated reactors as well as incidental mechanisms, and even live systems. A person skilled in the art will thus appreciate that many types of in vitro and in vivo bioprocesses fall within this category. In the present exemplary embodiment, biological entity 101 is undergoing the bioprocess of interest within local bioreactor 102. Thus, local conditions experienced by biological entity 101 are those existing or sustained inside bioreactor 102.

Bioprocesses of interest in the present invention involve those that include reduction-oxidation reactions. To appreciate these types of reactions, FIG. 1A presents a first highly magnified section A of local biological entity 101 that is sufficiently enlarged to show one of its cells 101′. First section A helps to visualize the scale difference between the macroscopic level of entity 101 found inside bioreactor 102 and the microscopic level of cell 101′. At the cell level, exemplary cell 101′ is seen in a partial cut-away view to expose some common cell-level structures 103. Cell structures 103 include organelles familiar to those skilled in the art, such as mitochondria 103A and nucleus 103B surrounded by the cytosol (not expressly labeled).

FIG. 1A includes a second highly magnified section B that expands even further from section A. Section B magnifies a tiny volume within mitochondria 103A belonging to cell 101′. Second section B brings out a redox pair or redox couple 104. At the level of magnification afforded by section B, we see redox couple 104 at the physical chemistry level or layer. The molecular structures of redox pair 104 are visible at this level. Actual redox reactions occur at this level or scale. They typically involve the transfer of hydrogens or electrons and are thus often referred to as electron balance reactions.

FIG. 1A illustrates individual molecules 104A and 104B belonging to redox couple 104. For exemplary purposes only, molecule 104A is the NAD+ (Nicotinamide adenine dinucleotide) coenzyme molecule being reduced as indicated by the minus charge. Molecule 104B is the partner NADH molecule being oxidized, as indicated by the plus charge. The energy involved in the process is indicated by the voltage or potential difference ΔV, which is simply equal to the redox potential Eₕ. The exact numeric value of redox potential Eₕ will depend on departure of thermodynamic conditions from standard conditions, as described by the well-known Nernst equation Eₕ=Eₒ+RT/nF·ln([A]/[B]). Here Eₒ is the standard potential for the redox couple, R is the ideal gas constant, T is the absolute temperature in degrees Kelvin, n is the number of electrons transferred in the redox reaction and F is Faraday's constant. We use the natural logarithm of the ratio of concentrations (indicated by square brackets) of the oxidized and reduced members of the redox couple A, B (e.g., NAD+ and NADH, glutathione couple GSH/GSSH or cysteine and cystine couple Cys/CySS). Those skilled in the art will also be aware of still other parameters and factors that need to be considered in assessing the redox potential of any particular redox couple (e.g., whether it is in cell, in vivo, in vitro, in plasma, etc.).

The reader is cautioned not to rely unduly on the visual representation of the redox reaction shown in FIG. 1A. The quantum mechanical process of charge transfer involves the overlap of wave functions or propensities that cannot even in principle be fully represented in 3-dimensional space (R³). It is the overlaps of these unobservable propensities in a higher-dimensional and complex-valued space (Hilbert space) that “cause” the charge transfer. Specifically, they permit new topologies (i.e., field effects not supported in R³) that in turn dictate the probabilities for any particular type of electron or ion transfer process(es). Only the final charge transfer becomes a measurable, an observable or otherwise “classical quantity” associated with molecules, e.g., redox partners 104A and 104B. Due to these fundamental limitations and the complex environment inside cell 101′, the redox status of any particular reaction partners may not be directly observable.

In contrast, the redox status of a comparatively large number (e.g., hundreds or thousands) of redox couples or of more complex systems becomes measureable, especially under lab conditions. On large scales, electron balance induces changes in well-known parameters, e.g., the pH value (which is a common measure of H⁺ ion concentration in moles per liter of solution expressed on a logarithmic scale). Persons skilled in the art will be very familiar with measurements of redox status using such parameters. These parameters are commonly referred to as electron balance indicators or redox indicators. Depending on conditions and available equipment, the most useful group of redox indicators can include certain oxidoreductases, oxidoreductase co-factors, electron balance influencer compounds, electron balance influencer compositions, redox-active compounds, pK values, pH values, threshold values, context measures and soft or derived indicators (usually derived with reference to a mathematical model).

Unfortunately, under local conditions within bioreactor 102 where bioprocess transpires in biological entity 101, lab equipment is generally not available. Correspondingly, the bioprocess and specifically its model is postulated to have hidden states that are not directly observable by measuring equipment or sensors deployed under local conditions. The hidden states may, and in many cases indeed will, include unknown states beyond those of just the redox status of the bioprocess that local biological entity 101 is experiencing.

The high-level diagram in FIG. 1A lays out a generalized representation of learning system 100. It also shows a general apparatus used by learning system 100 to learn, measure and control or adjust the redox status of the bioprocess that local biological entity 101 is undergoing. The bioprocess from which learning system 100 learns or on which it trains is a reference bioprocess model 106. Reference bioprocess model 106 typically includes an initial or reference learning model. Reference bioprocess model 106 is derived from curated reference model redox data 108 collected from previous runs and tests of the bioprocess. Such curated model redox data 108 may further be labeled, classified or annotated by experts, as is common in this field and known to those skilled in the art.

In some cases, as seen in the present exemplary embodiment, reference bioprocess model 106 is further corroborated. Here, the corroboration is obtained from redox data collected from a reference bioreactor 110 that is undergoing the bioprocess of interest. Reference bioreactor 110 is preferably located in a controlled facility.

It should be noted that in cases where curated model redox data 108 is unavailable, model 106 can be derived from just the redox data collected from reference bioreactor 110. In other words, reference bioprocess model 106 can be derived empirically from a reference run of the same bioprocess as the one being performed or experienced by biological entity 101 in local bioreactor 102. It is desirable to combine empirical data from reference bioreactor 110 with curated model redox data 108 to obtain as complete a reference bioprocess model 106 as is practicable under the specific conditions that are likely to correspond to local conditions.

An input 109 to reference bioreactor 110 is provided for adjusting or altering the bioprocess occurring inside it. Input 109 is to be understood generally as any mechanism, actuator, inlet or other type of mechanical or non-mechanical apparatus capable of acting on the bioprocess. Likewise, an output 111 is provided for drawing outputs or samples from the bioprocess unfolding inside reference bioreactor 110. Actuator systems or mechanisms interfacing with input 109 and sensing or measuring apparatus interfacing with output 111 will be discussed in conjunction with specific embodiments and are therefore not shown in the present high-level diagram of FIG. 1A.

Reference bioprocess model 106 typically runs on a dedicated computer, computer system or even a computer cluster that is collocated or geographically distributed (not shown). Specific computer infrastructure and interfaces will depend on whether reference bioprocess model 106 relies on just curated model redox data 108, or empirical data obtained from reference bioreactor 110, or both. A person skilled in the art will appreciate, that many types of resources and architectures can support the running of reference bioprocess model 106. Herein, when referring to any inputs or outputs of reference bioprocess model 106 we mean the inputs and outputs of the computer or computer system(s) that actually implement(s) or run(s) reference bioprocess 106.

Reference bioprocess model 106 is designed to provide, output or yield model redox data 112 along with a preliminary, initial or reference learning model. Given that redox status is not a directly observable parameter of the bioprocess, knowledge about it will be considered herein as indirect, inferred or otherwise derived knowledge. Correspondingly, the bioprocess is postulated to have hidden states. These will typically be reflected in the reference learning model. The hidden states are ones that include redox status micro-states as well as states that are due to redox reactions, are affected by or related to redox reactions, or are otherwise dependent on electron transfer and/or balance during the bioprocess. As already indicated above, the extremely rapid and typically inaccessible nature of individual redox reactions renders them as prime candidates for hidden state representation. The hidden states may, and in typical embodiments of the present invention do include unknowable states. The unknowable states can extend beyond just those that are related to redox status of the bioprocess of interest.

Model redox data 112, also frequently referred to herein just as model data or redox data 112, can be subdivided into several broad categories based on the redox code. The redox code includes the four principles by which biological systems are organized. The first category contains bio-energetics redox data 112A. These are data pertaining to catabolism and anabolism typically organized through high-flux NAD and NADP systems. The second category contains macromolecular structure and activities that are linked to bio-energetic systems through kinetically controlled sulfur switches. This category will be referred to herein as switching redox data 112B. The third category contains signaling redox data 112C. This category relates to activation and deactivation cycles, e.g., of H₂O₂ production (usually linked to NAD and NADP systems to support redox signaling and spatiotemporal sequencing for differentiation and multicellular development). The fourth category contains network redox data 112D. This type of data relates to redox networks, from micro-compartments to subcellular and cellular organization and includes adaptive responses to the environment.

In addition to the four redox code categories, model redox data 112 also contains a fifth category. This fifth category includes contingent redox data 112E. Contingent redox data 112E includes candidates (e.g., candidate redox indicators that are speculative) for any of the first four categories, as well as contextual information having to do with local conditions or environment in which reference bioprocess transpires. Contingent data 112E can also include other types of information that may be relevant directly or indirectly to oxidation-reduction activity or charge balance. It is possible for contingent redox data 112E to encompass contextual information that can only be inferred from factors not specifically related in any known way to charge balance. Contingent redox data 112E can also include common annotations, labels and other information that curators or experts typically add to ensure proper understanding of the data.

Reference bioprocess model 106 is set up to yield each type of redox data 112A-E. In other words, all or some of bio-energetics redox data 112A, switching redox data 112B, signaling redox data 112C, network redox data 112D and contingent redox data 112E are output by reference bioprocess model 106 for the given local conditions. What is important is that bioprocess model 106 be configured to yield model redox data 112 about the bioprocess that will be useful. This is required despite the fact that the redox status is not a directly observable aspect of either reference bioprocess model 106 based on the bioprocess taking place in reference bioreactor 110, or of the bioprocess occurring in biological entity 101 in local bioreactor 102. In other words, a judicious choice of what to include in model redox data 112 is required to operate learning system 100. This choice involves selecting the appropriate candidates in all or some of the five categories 112A-E that constitute model redox data 112, as discussed in more detail below.

Reference bioprocess model 106, or more specifically the computer or computer system on which it is running, is in communication with a master learner 114. Master learner 114 can operate on the same computer or computer system(s) or another computer or computer system(s). In any event, master learner 114 is configured to receive model redox data 112 from reference bioprocess model 106. In the event biological entity 101 undergoing the bioprocess in local bioreactor 102 requires frequent or even continuous monitoring, the delay in the communication of model redox data 112 to master learner 114 should be kept as short as practicable. In such cases, geographic collocation of the computers or even operating both reference bioprocess model 106 and master learner 114 on the same computer is preferred. A person skilled in the art will be able to make the appropriate decision about the distribution and assignment of the correspondent computational tasks.

In accordance with the invention, master learner 114 is capable of establishing from model redox data 112 an observable basis of redox indicators 116. More specifically, master learner 114 is capable of establishing from knowledge of one or more or a combination of features from one or more of the five categories of redox data 112A-E observable basis of redox indicators 116. In the context of the systems and methods described herein, observable basis 116 has a mathematical meaning. It is a basis for a vector space that is postulated to be real-valued, or real. That is because observable basis 116 established by master learner 114 excludes any hidden states or otherwise hidden or inaccessible information.

Although FIG. 1A illustrates observable basis 116 to include only three vectors in a three-dimensional vector space established by generally known orthonormal basis vectors X, Y and Z it is understood that the vector space is typically of a much higher dimension than three. Any vector space or spaces established using observable basis of redox indicators 116, which we will frequently simply refer to as observable basis 116, are necessarily real-valued and measurable. A consequence of this choice is that any candidate for observable basis 116 in such vector spaces can be measured and assigned real values.

In establishing observable basis 116 of redox indicators master learner 114 should take into account the control and measuring affordances available to entire learning system 100, and especially to local bioreactor 102. These include any constraints of the local measurement system such as availability or accuracy of measurements under local conditions. These will be typically parts of the feedback mechanisms including, in particular, the local and the reference feedback mechanisms, as discussed in more detail below.

Learning system 100 is also equipped with a local learner 118. In most embodiments, local learner 118 is implemented in a low-power and low-bandwidth unit. Such unit is not expressly shown in FIG. 1A. Local learner 118 may possess the processing capabilities of a personal computer, a smart phone or a smaller embedded system. Furthermore, it may be implemented in a mobile unit with limited on-board resources and data access. It may be implemented on a local unit that accesses remote or cloud computing capabilities as needed for specific computations or requirements. Normally, however, local processing may be constrained by local processing power, latency, bandwidth or time requirements. The precise local conditions or field conditions under which local learner 118 is deployed may vary. Several examples will be discussed in conjunction with specific embodiments that will be discussed below. In any event, local learner 118 will typically use all the data that it does receive in an efficient manner.

Local learner 118, or more specifically the unit on which local learner 118 is implemented, is connected to a test or sensor system 120. In turn, sensor system 120 interfaces with local bioreactor 102. Sensor system 120 deploys one or more individual sensors or measurement devices 122 to collect measured redox data 124 from the bioprocess running in local bioreactor 102. In the exemplary embodiment of FIG. 1A a number of measurement devices 122 are deployed to collect measured redox data 124 from local bioreactor 102. Only measurement devices 122A and 122Z are expressly called out for reasons of clarity. It is noted that in some embodiments sensor system 120 may only utilize a single sensor or measurement device, e.g., just device 122A. It is understood that sensor system 120 may be connected to measurement devices 122 indirectly or by means of a data output or file export and data input or file import that includes a manual or hybrid process.

Biological system 101 experiences the bioprocess within local bioreactor 102 for which reference bioprocess model 106 has been prepared, configured or calibrated under lab conditions. Rather than starting without guidance, local learner 118 can be initialized with reference learning model obtained from reference bioprocess model 106 passed on by master leaner 114. Thus, local learner 118 can immediately look for structure in the redox data being collected from local bioreactor 102.

As in the case of local learner 118, local bioreactor 102 is usually a reactor with a significantly down-scaled measurement or sensor system 120. More precisely, it is considered down-scaled in comparison with reference bioreactor 110 that learning system 100 may use to obtain a large number of measurements of various types of redox data. Local bioreactor 102 can be implemented under known or previously tested local conditions. These known local conditions may correspond to just a small subset of model conditions under which reference bioreactor 110 has been or is being operated. The known local conditions may also correspond to just a small subset of model conditions under which curated model redox data 108 has been collected and on which reference bioprocess model 106 and its reference learning model are built.

It is also possible that local bioreactor 104 is implemented under unknown local conditions. Conditions are unknown when neither curated model redox data 108 nor reference bioreactor 110 have undergone the bioprocess of interest under model conditions that replicate local conditions or allow to reliably extrapolate to local conditions. Thus, reference bioprocess model 106 with its reference learning model and model redox data 112 may not properly reflect how bioprocess in local bioreactor 102 may progress under local condition. Under these circumstances, local bioreactor 102 and measured redox data it collects from biological system 101 can be used by learning system 100 to refine reference bioprocess model 106. This mode of operation and on-the-fly learning will be discussed in more detail below.

Sensor system 120 is configured to collect a set of measured redox data 124 from biological entity 101 undergoing the bioprocess of interest inside local bioreactor 102. Measured redox data 124 can contain any of the four redox code categories 112A-D as well as the fifth category of contingent redox data 112E that includes candidates and accounts for local conditions and any other contextual factors. In the embodiment shown in FIG. 1A, measured redox data 124 contains all five categories of redox data.

Measured redox data 124 can include information that is not directly measurable, also known herein as “soft data”. Such “soft data” is inferred on a model applied to a collection of surrogate measures that are weighted to estimate or infer a measure of interest. For more information about soft sensors and soft data the reader is referred to Paulsson D., et al., “A Sensor for Bioprocess Control Based on Sequential Filtering of Metabolic Heat Signals”, Vol. 14, Sensors, 26 Sep., 2014, pp. 17864-17882.

Due to local limitations, sensor system 120 may not be able to recover anywhere near the amount of curated model data 108 or anywhere near the amount of empirical data obtained from reference bioreactor 110. In other words, local conditions may not yield the amounts of measurable data that is available to and deployed in the construction of reference bioprocess model 106. These limitations are understood to include those that are due to the intrinsically lower performance of measuring devices 122 of sensor system 120.

In light of the above, the bioprocess inside local bioreactor 102 is expected to yield measured redox data 124 that correspond to only a subset of model redox data 112. In many practical embodiments, measured redox data 124 may be significantly smaller than a full set of model redox data 112 yielded by reference bioprocess model 106. In some embodiments, the amount of measured redox data 124 is vastly smaller than the full set of model redox data 112.

Local learner 118 (or the unit on which local learner 118 is implemented) can be connected to an actuator system 126. Actuator system 126 interfaces with local bioreactor 102. Actuator system 126 deploys one or more individual actuators or input mechanisms 128 to control, provide inputs or, in any other way, alter or adjust the bioprocess transpiring in local biological entity 101 housed in local bioreactor 102.

In the exemplary embodiment of FIG. 1A a number of actuators 128 are deployed to adjust the bioprocess. Only actuators 128A and 128Z, here an input or inlet pipe and a stirrer, are expressly called out for reasons of clarity. It is noted that in some embodiments actuator system 126 may only utilize a single actuator or input mechanism, e.g., just inlet pipe 128A (or multiple inputs or inlet pipes, coupled to multiple sources of inputs—not shown) to supply additional quantities of biological entity 101 or other inputs. These other inputs could include other feed stock or materials, including, e.g., redox influencers. Alternatively, actuator system 126 can recommend an operation to a local operator (not shown).

Local learner 118, as shown, is connected to master learner 114 and configured to receive at least a portion of model redox data 112 from reference bioprocess model 106. For visualization purposes, a portion of model redox data 112 may be referred to as just a portion and will be designated by reference 112′. It is understood that in some embodiments, portion 112′ may include the full set of redox data 112. For example, portion 112′ could include the full or almost full set of model redox data 112 when local learner 118 is deployed with ample computing resources and disposes of significant communication bandwidth for receiving data.

Local learner 118 also receives the full set of measured redox data 124 obtained from local bioreactor 102 in which biological entity 101 is undergoing the bioprocess of interest. In other words, all measured data collected by measuring devices 122A-Z of measurement or sensor system 120 are supplied to local learner 118.

Meanwhile, portion 112′ of model redox data 112 supplied to local learner 118 from master learner 114 is accompanied by observable basis of redox indicators 116. This means that local learner 118 not only receives portion 112′, but also a mathematical basis in which to review both portion of model redox data 112′ as well as measured redox data 124. This is an advantageous aspect of the invention, since observable basis 116 allows learning system 100 to use a common evaluation measure or metric. Specifically, basis 116 is important for learning from portion 112′ provided for the bioprocess from reference bioprocess model 106 and measured redox data 124 collected from local bioreactor 102 in which biological entity 101 is undergoing the bioprocess.

In the embodiment of FIG. 1A, learning system 100 deploys a distributed learning algorithm 130 to learn. In the illustrated embodiment, distributed learning algorithm 130 resides in master learner 114 and in local learner 118. A person skilled in the art will realize that algorithm 130 can be further distributed among the resources of learning system 100. In fact, a module or part of distributed learning algorithm 130 can also reside within reference bioprocess model 106, as indicated in dashed lines in FIG. 1A. Such distribution can improve the efficiency of the learning process.

In any event, it is important that distributed learning algorithm 130 have access to model redox data 112 and measured redox data 124. By virtue of its distribution between at least master learner 114 and local learner 118 this condition is facilitated. Distributed learning algorithm 130 also has access to observable basis of redox indicators 116 picked or established by master learner 114 from model redox data 112 yielded by reference bioprocess model 106. Supplied with these, distributed learning algorithm 130 of learning system 100 can fulfill its main task. That task is to learn an optimal composition of redox data that should be measured under local conditions. In other words, the objective is to choose what measured redox data 124 is to be collected from the local bioprocess that biological entity 101 is experiencing in local bioreactor 102.

The ability to jointly evaluate locally collected redox data and model redox data, i.e., measured redox data 124 and model redox data 112 or just portion of model redox data 112′ in a common observable basis 116 is important. This joint evaluation enables distributed learning algorithm 130 to learn the optimal composition of measured redox data 132 that should be measured by sensor system 120 according to the method of the present invention. To illustrate this point, an optimal composition of measured redox data 132 described in basis 116 is indicated in FIG. 1A.

Optimal measured redox data 132 is shared between master learner 114 and local learner 118. A person skilled in the art will realize that any distribution and updating to optimal measured redox data 132 can be implemented by learning algorithm 130 anywhere in learning system 100. Indeed, once the learning is complete, local learner 118 could request from sensor system 120 to not measure all possible measured redox data 124 but only the redox data that are optimal 132 and expressed in basis 116. This approach helps to reduce the load on constrained local resources available to local learner 118.

Of course, even prior to discovering optimal measured redox data 132, master learner 114 preferably provides the reference learning model included in reference bioprocess model 106 to local learner 118. The model preferably contains a preliminary indication of optimal measured redox data 132 given context and local conditions. Supplying this information directly to local learner 118 at the very start or in an initialization step allows local learner 118 to train faster with less processing power or time. Meanwhile, learning algorithm 130 will converge on optimal measured redox data 132 to share between master learner 114 and local learner 118.

Once optimal measured redox data 132 are known, reference bioprocess model 106 can be updated. This is illustrated in FIG. 1A by an update protocol 134 that is sent from master learner 114 to reference bioprocess model 106. It should be understood that the update to reference bioprocess model 106 can also result in adjustments to curated model redox data 108. Such update could also lead to adjustments in reference bioprocess being run in reference bioreactor 110. This would be done in practice by changing the input(s) supplied through input 109 and sampling different output(s) drawn through output 111.

Before turning to the operation of learning system 100 it is important to appreciate the many types of local conditions and contexts in which it can be deployed. Most importantly, learning system 100 is not limited to bioprocesses transpiring in bioreactors. It is also not limited to one or just a few local biological entities. Learning system 100 is actually very well configured to applications in which many different biological entities in different contexts or under different local conditions are undergoing the bioprocess of interest. To better appreciate that applicability of the method and learning system 100 of the invention under these conditions we now turn to FIG. 1B.

FIG. 1B shows how learning system 100 is deployed when there are several local biological entities represented by living organisms. Local biological entities are live human subjects 201. Only some important body parts of four subjects 201A, 201B, 201C, . . . 201Z are shown for reasons of clarity. The reference numbers from FIG. 1A are retained in FIG. 1B to designate corresponding and/or analogous parts. Once again, the bioprocesses of interest involve reduction-oxidation reactions. The basics of redox reactions have already been discussed above in conjunction with the diagram of FIG. 1A.

In the configuration of learning system 100 shown in FIG. 1B, system 100 learns from reference bioprocess model 106 that is constructed form model redox data 108 and from model redox data 152 obtained from a reference biological entity 150. Again, reference bioprocess model 106 is understood to include an initial or reference learning model. Reference biological entity is a live human reference subject 150 undergoing the bioprocess of interest in a controlled environment; here under lab conditions. In the lab, model redox data 152 and other relevant parameters are easy to measure by the available measurement apparatus and systems 153. Thus, the bioprocess of interest can be treated as an empirical bioprocess under model conditions.

Alternatively, human reference subject 150 can be placed under model conditions that specifically correspond to local conditions. This is advisable whenever local conditions are expected to have a large influence on redox data or deviate substantially from lab conditions.

Model redox data 152 collected from reference subject 150 is used in generating the full set of model redox data 112. Model redox data 152 from reference subject 150 are further corroborated by curated model redox data 108. Both curated and model redox data 108, 152 are thus used in deriving full set of model redox data 112 for reference bioprocess model 106 and its reference learning model. Curated model redox data 108 can take into account mass spectrometer results resolving as many as 20,000 or even 50,000 potential peaks to locate known redox indicators for the bioprocess of interest. This can be accomplished by using a high-resolution mass spectrometer in which m/z for each ion is measured to several decimal places to differentiate between molecular formulas having similar masses. Suitable mass spectrometers include instruments supplied by commercial manufacturers such as Bruker, Sciex and others. Thus, in most cases, model redox data 108, 152 will far exceed the any measured redox data that can be collected under local conditions.

From reference bioprocess model 106 the full set of model redox data 112 is sent to mater learner 114. Master learner 114 is again shown connected with local learner 118. However, unlike in the embodiment of FIG. 1A, in the embodiment of FIG. 1B the individual connections between master and local learners 114, 118 are replaced by a primary feedback loop 154. Primary feedback loop 154 contains all of the connections required for master learner 114 and local learner 118 to communicate and for distributed learning algorithm 130 to learn efficiently. A person skilled in the art will realize that the connections in FIG. 1A can also be adapted to enforce the conditions of primary feedback loop 154, if desired.

Primary feedback loop 154 is used to communicate the relevant portion of model redox data 112′ from master learner 114 to local learner 118. Loop 154 is also used to communicate measured redox data 124 from local learner 118 to master learner 114. More importantly still, loop 154 is used to communicate changes or adjustments to the content or type of measured redox data 124 between learners 114, 118 under the direction of distributed learning algorithm 130. In other words, determination of optimal measured redox data 132 and its expression in basis 116 are arrived at by the use of primary feedback loop 154. The details of these adjustments will be discussed further below.

In embodiments where measured redox data 124 contains only observable redox indicators and/or candidates for such observable redox indicators, primary feedback loop 154 can interface directly with local measurement and control instruments. Thus, primary feedback loop 154 can be advantageously configured in some embodiments for adjusting the redox indicators in observable basis 116.

We now turn to local biological entities embodied this time by live human subjects 201. Only four particular subjects 201A, 201B, 201C and 201Z are shown experiencing the bioprocess of interest under their own local conditions 202. Once again, only local conditions 202A, 202B, 202C and 202Z of corresponding subjects 201A, 201B, 201C and 201Z are explicitly shown for reasons of clarity. Preferably, local conditions 202A, 202B, 202C and 202Z are simply the conditions under which subjects 201A, 201B, 201C and 201Z live day to day. In other words, local conditions 202A, 202B, 202C and 202Z are field conditions that match those of natural environments or habitats of subjects 201A, 201B, 201C and 201Z, respectively.

Local learner 118 may be implemented in a lower-power and/or lower bandwidth hardware unit such as a low-cost computer or tablet (not shown). The bandwidth and power comparison of the low-cost computer is made here with that of the measuring and processing capabilities of instruments available in the laboratory where human reference subject 150 is measured to yield model redox data 152 for reference bioprocess model 106.

In addition to running on the low-cost computer or local computing device, local learner 118 can be distributed over individual local learning units or devices 118A, 118B, 118C, . . . , 118Z residing in the corresponding local contexts 202A, 202B, 202C, . . . , 202Z of subjects 201A, 201B, 201C, . . . 201Z. Units 118A, 118B, 118C, . . . , 118Z may be embodied by a local computing device or affordance that may in some cases be connected and have access to cloud computing resources (but may be still constrained in comparison to reference and master learner resources). Thus, units 118A, 118B, 118C, . . . , 118Z can range from dedicated local devices, such as health monitoring apparatus, to standard local devices such as personal computers, mobile computing platforms (e.g., smart phones) as well as smart watches and even smaller wearable or stationary devices which may or may not be connected to additional cloud computing resources. In some cases, local learning units 118A, 118B, 118C, . . . , 118Z may have sufficient on-board computing resources to run a local portion of distributed learning algorithm 130. In some embodiments, local portion of distributed learning algorithm 130 is an application (app) that is downloaded and installed on the corresponding local unit.

Under local conditions 201 experienced by subjects 202 the test or sensor system deployed may again be a significantly down-scaled version in comparison to the test or sensor systems available in a laboratory where the reference human subject 150 is tested. Still, in some cases, the ability of local sensor system to capture measurement data under local conditions may be quite high. For some specific measure or redox indicator, the local capability may even be higher.

The sensor system as a whole is not explicitly shown in FIG. 1B. Instead, we see here individual sensors or measurement devices 122 deployed in local contexts or under local conditions 202 of subjects 201. In the illustrated embodiment, all measurement devices 122 are shown as being different and are configured to collect different measurements. Of course, they could also be configured to collect measurements of the same observable redox indicator or parameter from several or all subjects 201.

As shown, distributed local learning units 118A, 118B, 118C, . . . , 118Z are assigned to their subjects 201A, 201B, 201C, . . . , 201Z and connected to corresponding specific measurement devices 122A, 122B, 122C, . . . , 122Z within local contexts 202A, 202B, 202C, . . . , 202Z. Each one of measurement devices 122A, 122B, 112C, . . . , 122Z, as shown, is configured to collect one or more types of measured redox data 124. Relevant redox data that should be measured can fall into any one or more of the five categories of redox data discussed above.

In the illustrated example, measurement device 122A is a wrist band in wireless communication with local learning unit 118A. Wrist band 122A can measure, pulse, blood oxidation level (optically) and blood pressure of human subject 201A. These types of measurements can yield measured redox data 124A that is direct and immediately available to learning algorithm 130. Other measurements that can be obtained from wrist band 122A include activity or exercise measurement from accelerometers and other sensors, respiration or other respiratory measures, heart rate and its variability, hydration or concentrations of fluids, photo or image data of the subject, such as skin or other parts, and other diet or lifestyle-related measurements.

Measurement device 122B, as shown, is a blood sampler connected directly to local learning unit 118B. Blood sampler 122B can draw blood and/or plasma for measurement of any redox indicator. Preferably, blood and/or plasma measurements are performed under local conditions 202B as soon as the blood and/or plasma are drawn. Kits containing sensors and analysis instruments that can be used as measurement device 122B are marketed by a number of commercial suppliers. Blood glucose testing devices from Roche, Abbott, Johnson & Johnson and other suppliers are widely available. Another example includes the home blood test kit from COR that measures HDL cholesterol, LDL cholesterol and total cholesterol, fasting blood glucose, inflammation markers such as fibrinogen and triglycerides. Another example includes hand-held blood test kits from CardioChek that can measure total cholesterol, HDL cholesterol, triglycerides and glucose. Still another example includes ketone testing kits with the Precision Xtra Blood Ketone Monitoring System and combined ketone and blood monitoring systems using the MultiSure GK Blood Glucose & Ketone Monitoring System from Apex Biotechnology Corp. Other examples require devices or samples to be mailed to the lab or for the subject to visit a clinical lab. These are, however, available directly to consumers and include the saliva, blood spot, serum and urine test kits from ZRT Laboratory, the food and chemical sensitivity test kits from Cell Science Systems, and the blood tests provided by clinical labs such as Quest and Labcorp through various direct-to-consumer suppliers including HealthLabs.com and Walk-In-Lab. In many cases, devices 122B that are chosen can reduce hemolysis and autoxidation of the blood (e.g., by proper collection technique(s)) and reduce collection artifacts in plasma (e.g., by using antioxidants and alkylating agents during plasma collection) of subject 201B. They are preferably also able to perform rapid local measurement(s). Thus, measured redox data 124B is made available to learning algorithm 130 with minimal delay.

Measurement device 122C, as shown, is a urine sampler that connects to local learning unit 118C. Urine sampler 122C collects urine from subject 201C for any measurement of a redox indictor that can be made thereon. Preferably, the measurements are performed under local conditions 202C as soon as the urine sample is collected. As in the case of blood and plasma testing, there are kits (home kits or field kits) containing sensors and analysis instruments that can be used as measurement device 122C. Devices in such kits have the ability to perform immediate measurement on the urine of subject 201C to make measured redox data 124C available to learning algorithm 130 with minimal delay. That is because the results can be observed visually from a test strip and entered manually by subject 201C or read automatically by a reader associated and/or coupled with measurement device 122C. Examples include reagent strips such as HealthyWiser Urinalysis Reagent Strips that test urine for glucose, protein pH, leukocytes, nitrites, ketones, bilirubin, blood, urobilinogen and specific gravity.

There are many additional home or field kits with measurement devices capable of collecting still other measurements. These include devices that can collect samples of saliva, serum, skin as well as bodily fluids including excretions and secretions. Further examples include blood spot testers and analyte tests ranging from paper chromatography to electrochemical sensors. To the extent that the measurement can provide measured redox data, i.e., data that is related to the redox status of the bioprocess of interest, such measurement devices are considered suitable in the context of the present invention. It is understood that a wide range of measurement devices 122 can be directly or indirectly connected to local learner 118. Measurement devices 122 may produce data that is transmitted to the system via an application program interface from another database or monitoring system, or connected by means of a file export from another device or system and then imported into the system accessed by the local learner, or other data output is in a format that can be optically scanned, manually entered, or a combination of methods to provide measurement data to the system accessed by local learner 118.

Measurement device 122Z in the present example is shown as a wrist-worn, integrated personal health monitor. In alternative embodiments, measurement device 122Z can be embodied by a personal health monitor in another format including a wearable patch, a wearable device on a location other than the wrist, an implantable device or a device with an implantable or subdermal component, an ingestible or insertable device, or a portable or hand-held device.

As shown, health monitor 122Z is in communication with learning unit 118Z via any suitable communication link. In the present case, the communication link is wireless, as indicated. Health monitor 122Z measures the daily activities of subject 201Z. These may include the number of steps taken, the relative rigor of exercises performed, amount of sleep, calories consumed, and the like. Persons skilled in the art will be familiar with all possible measurable quantities that can be collected with and without the assistance of subject 201Z. Note that direct input by subject 201Z in either prompted or unprompted self-reporting is also considered a measurement.

Each local subject 201 undergoing the bioprocess under their own local conditions 202 generates measured redox data 124 for the bioprocess. Specifically, local subject 201A generates measured redox data 124A. Local subject 201B generates measured redox data 124B. Local subject 201C generates measured redox data 124C. Finally, while under their local conditions 202Z, local subject 201Z generates measured redox data 124Z.

Measured redox data 124A, 124B, 124C, . . . 124Z is passed via distributed local learners 118A, 118B, 118C, . . . , 118Z to local learner 118. There, the combined measured redox data 124 is communicated from local learner 118 to master learner 114 using primary feedback loop 154. It should be noted that even all measured redox data 124 is usually just a small subset of model redox data 112 on which reference bioprocess model 106 is based.

In addition to measurement devices 122 of local sensor system, learning system 100 is shown as including an actuator system for providing inputs, changing, altering or adjusting the bioprocess experienced by local subjects 201. In the embodiment of FIG. 1B, actuator system has individual actuation mechanisms 128 provided for each local subject 201 in their corresponding contexts 202. Mechanisms 128 can be used by subjects 201 to self-administer or receive the requisite adjustment, action or prompt. In principle, mechanisms 128 may also administer actions or adjustments without the participation or awareness of local subjects 201. For example, such situations may arise when one of the local subjects 201 is under active care and their context 202 may be a home care facility. Mechanisms 128 can also include drug delivery devices, an insulin pump, an oxygen-providing device, a device that changes a medication or food formulation automatically, a device that alerts a patient to take medication or some other input, or a device that recommends a change to medication, food, nutritional supplement or any other aspect of a subject's regimen.

FIG. 1B illustrates four exemplary mechanisms 128 belonging to the actuation system. In context 202A mechanism 128A is embodied by a vitamin and supplement pill dispenser. The dosage of vitamins and supplements from dispenser 128A can be adjusted by communicating the dosage to subject 201A upon review of their measured redox data 124A and based on the learning as described below. Alternative embodiments include automating the adjustment or recommendation to an operator to adjust the formulation of vitamins or supplements or their delivery to subject 201A.

In context 202B mechanism 128B is embodied by a syringe for drug self-administration by subject 201B. Once again, the time and dosage for subject 201B is determined upon review of their measured redox data 124B and based on the learning performed by learning system 100, as described below. Alternative embodiments include automating or recommending the adjustment to the formulation of medications, medical foods or nutritionals for self-administration by subject 201B, administration or oversight by an informal or professional caregiver, or administration by an automated delivery system or device.

In context 202C mechanism 128C is embodied by a clock. Clock 128C may be provided with appropriate alarms, chimes, reminders or other prompts that can remind subject 201C or a caregiver or proxy about important actions to take. For example, clock 128C may be set up to remind subject 201C about urine sample collection time. In addition, clock 128C can be set to provide other reminders, e.g., to conduct certain prescribed or therapeutic activities.

In the case of subject 201Z under local conditions 202Z, actuation mechanism 128Z is integrated with measurement device 122Z. Specifically, the display of health monitor 122Z is configured to visually communicate to subject 201Z an action or adjustment that should be undertaken. As above, the adjustment or action are dictated by learning from measured redox data 124Z collected from subject 201Z under local conditions 202Z. The adjustment or action may be automatically undertaken by a device, recommended to a subject or a caregiver of the subject.

### General Principles of Operation of Learning System

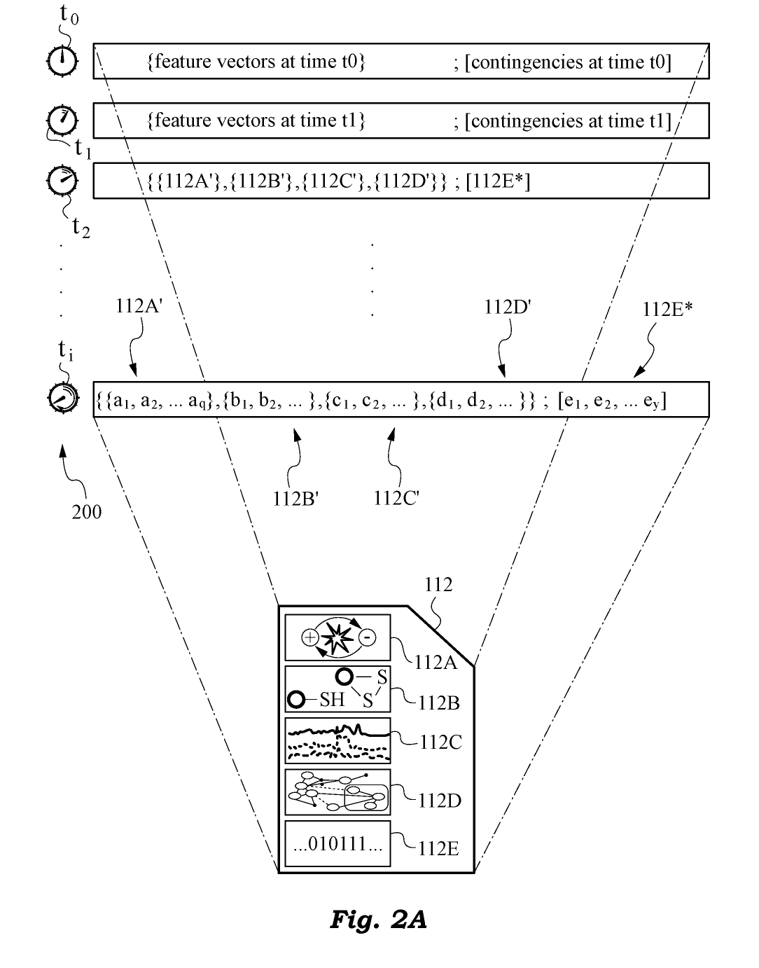

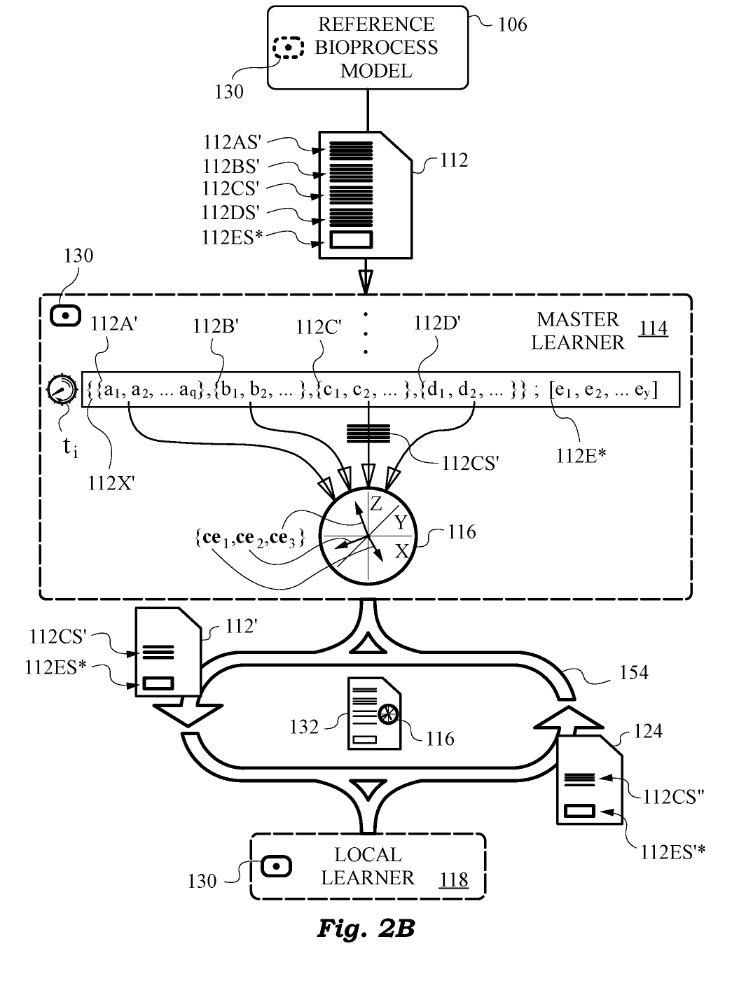

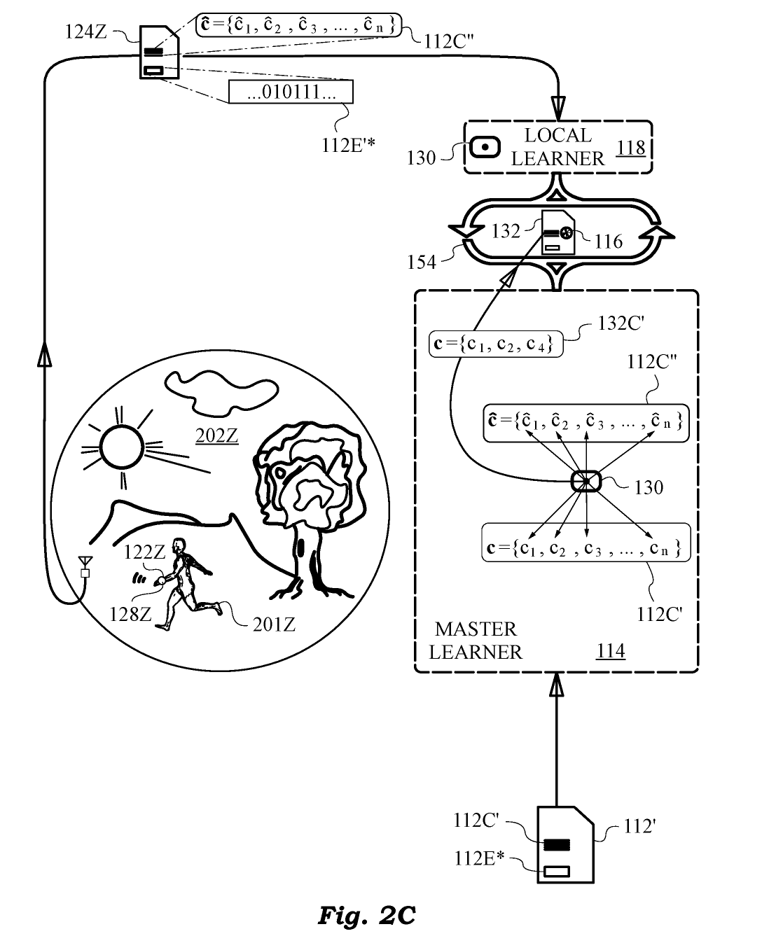

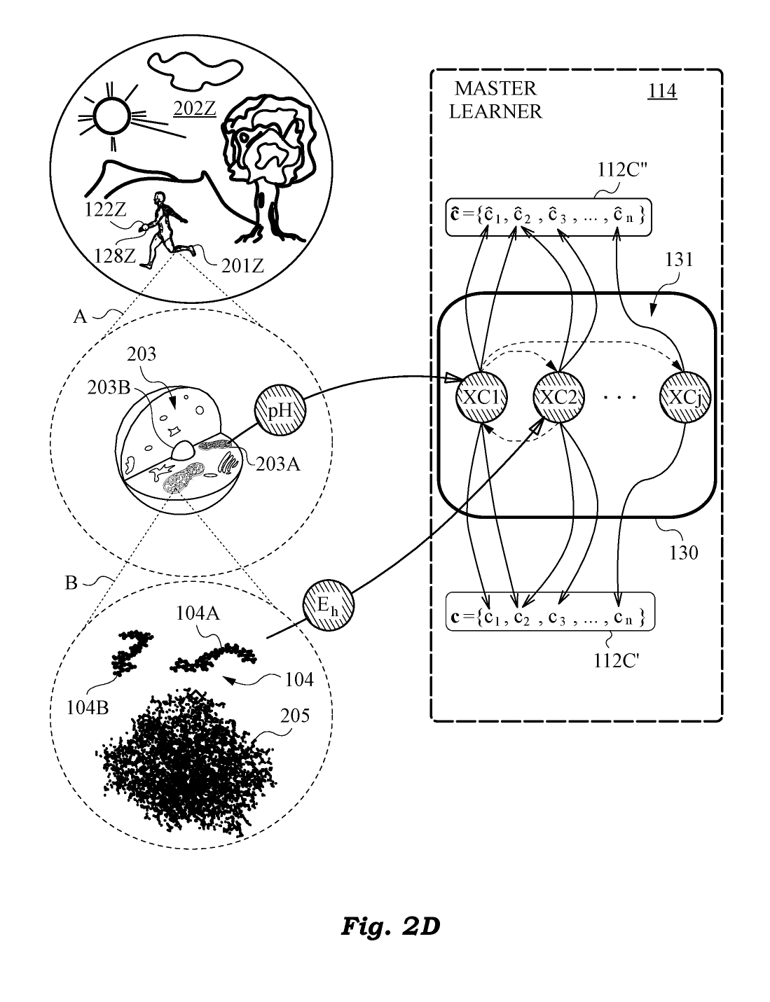

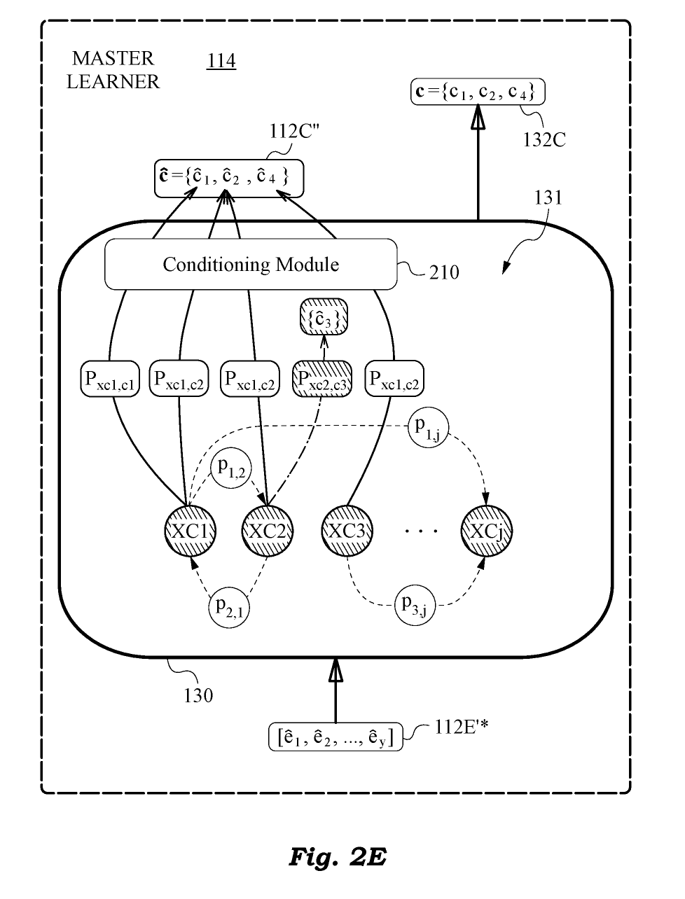

Having reviewed two high-level embodiments of learning system 100 as shown in FIGS. 1A and 1n FIG. 1B we now turn to the operation of distributed learning algorithm 130 and the format of redox data. Specifically, we turn to FIGS. 2A-B to examine an advantageous representation of model redox data 112, measured redox data 124, portion of model redox data 112′ (sent from master learner 114 to local learner 118; see FIGS. 1A-B) and optimal measured redox data 132.

FIG. 2A is a diagram illustrating model redox data 112 for the bioprocess of interest provided by reference bioprocess model 106 (see FIGS. 1A-B). As noted above, model data 112 can contain redox data fitting into any of the five different categories of redox data. Namely it can contain redox data that fits into any one or more of the four redox code categories 112A-D by which biological systems are organized. Model data 112 can further contain redox data that fits into a fifth category of contingent redox data 112E.

In many of the embodiments the most important categories may include the first, third and fifth. These include bio-energetics redox data 112A, signaling redox data 112C and contingent redox data 112E. The fifth category typically includes candidates for any of the first four categories and data about local conditions and model conditions; i.e., contextual data. Contingent information can also include data about items that are not directly measurable, i.e., “soft data”, and any other contingent data including speculatively related information. Some information that is not directly measurable can be placed in the category of candidate data for which further statistical analysis may later discover an association. Although the first, third and fifth categories of redox data 112A, 112C, 112E will be most important in most embodiments we are concerned about herein, we consider all five categories of redox data 112A-E for reasons of completeness.

FIG. 2A expands and visualizes an entire set of model redox data 112 yielded by reference bioprocess model 106. We first consider model data 112 at a particular time tᵢ indicated by a running clock on the left side of the drawing figure for clarity. At time tᵢ model redox data 112 is shown partitioned into generalized feature vectors 112A′-112D′ and a contingency list 112E*. The prime and star notation is used to indicate that the five categories of model redox data 112 contain structured data, here represented as vectors, in the first four categories and a list of generally unstructured data in the fifth category. Of course, candidate features for feature vectors 112A′-112D′ are technically structured data. Meanwhile, purely contextual data such as annotations and labels is typically unstructured but may affect how structured data should be treated. For example, contextual data may indicate in which contexts no data in any of the first four categories is even expected to relate to the bioprocess of interest.

Specific data entries, such as elements, features or other data falling into categories of bio-energetics redox data 112A, switching redox data 112B, signaling redox data 112C and network redox data 112D are incorporated into correspondent feature vectors 112A′, 112B′, 112C′, 112D′ representing redox data in these categories. Thus, data entries ranging from 1 to q and designated by a₁, a₂, . . . , a_{q} falling into the category of bio-energetics redox data 112A become entries in feature vector 112A′. Similarly, data entries b₁, b₂, . . . as well as c₁, c₂, . . . and d₁, d₂, . . . belonging to the other three redox data categories become entries in feature vectors 112B′, 112C′ and 112D′, respectively. Meanwhile, redox data in the fifth category 112E containing candidates, contextual and other subject-related and unstructured data is represented in list 112E*. In other words, as illustrated, no further data representation, format or structure is imparted on redox data 112 belonging to fifth category 112E.

As is made clear in FIG. 2A, model redox data 112 is not only subdivided by category but is further ordered in a time sequence 200. Particular instants in time sequence 200 are denoted by the status of the running clock drawn on the left side in the figure. Only start time, t₀, times t₁, t₂ and a certain time of interest tᵢ are indicated explicitly. However, given that all bioprocesses of interest transpire in time, reference bioprocess model 106 contains the time parameter to describe the unfolding of the bioprocess and provides model data 112 within the framework of time, or in terms of time sequence 200. The formulation of model redox data 112 at times t₀, t₁, t₂ shows in a more compact manner a convenient formatting for use in learning system 100 and distributed learning algorithm 130 (see FIGS. 1A-B). For an unchanging or steady state, the redox status, and hence the corresponding model data 112, do not change with time. The time parameter can be left out when dealing with persistent or steady state redox status, or when the output of the learning process is a classification or other result that is not part of a dynamic process with a feedback loop and control.

FIG. 2B illustrates master learner 114 receiving from reference bioprocess model 106 model redox data 112 formatted as feature vectors 112A′, 112B′, 112C′, 112D′ and as list 112E*. Only model data 112 at time of interest tᵢ is shown explicitly for reasons of clarity. This simplification will allow us to better understand how model data 112 is treated by master learner 114.

In accordance with the invention, master learner 114 is configured to receive model redox data 112 and establish therefrom the observable basis of redox indicators 116. List 112E* is not typically used in establishing observable basis 116. That is because in addition to potential redox indicator candidates in structured data, it also contains unstructured data about contexts, annotations and labels on redox data and any other types of data related to one or more redox categories. As with any machine learning process, list 112E* may contain data that do not associate with the state being inferred through the learning process executed by distributed algorithm 130. Such data may drop out of the regression through methods such as principal components analysis. However, time series 112ES* of lists 112E* at times t₁, t₂, . . . , tᵢ is nonetheless provided to master learner 114 so that it can make the determination whether or not to drop any data from lists 112E*. Master learner 114 can also make a determination to drop other measurement data that turns out not to be a principal component with respect to the learning model.

Meanwhile, data entries in each of the feature vectors 112A′, 112B′, 112C′, 112D′ are used by master learner 114 to estimate corresponding redox category vector spaces. More precisely, time series 112AS′, 112BS′, 112CS′, 112DS′ of corresponding feature vectors 112A′, 112B′, 112C′, 112D′ are used for estimating the corresponding vector spaces using the standard tools of linear algebra and applied mathematics. These include testing for inner products to establish orthogonality, determining vector norms and other tests known to the skilled artisan. Among other, as illustrated, the results yield the dimensionality of the corresponding vector spaces and a measure of their stability.

Preferably, reference bioprocess model 106 provides provisional suggestion about the vector spaces of feature vectors 112A′, 112B′, 112C′, 112D′. These may be based on model data 108 and data from reference bioreactor 110 or reference subject 150, depending on the context. However, because of the limitations under local conditions, available measurement devices as well as contextual factors, master learner 114 needs to re-validate the vector spaces to ensure minimal stability and norm preservation to enable the implementation of learning algorithm 130. Persons skilled in the art will be familiar with many different methods for setting such bounds. Master learner 114 can take advantage of any of these prior art methods in ensuring the requisite stability of the vector spaces for effective machine learning.

One of the challenges of inferring the redox state in any of the four redox categories is that some compartments of biological entity 101, whether a biomass or a living subject (such as human subject 201, see FIG. 1B) are parts of highly redundant pathways with multiple uses. The redundancy of the pathways is the product of evolutionary pressures. The redundancy and many branching points may often present to a learning algorithm as cross-talk, fading, noise and other effects. These may be taken into account when estimating separate vector spaces for the four types of feature vectors 112A′, 112B′, 112C′, 112D′.

As shown in FIG. 2B, feature vectors 112A′, 112B′, 112C′, 112D′ of all four redox categories containing structured data can be collapsed into one joint feature vector 112X′. This simplification may be necessary under some local conditions and/or if the measurement device(s) are not capable of yielding information that clearly fits into the first four redox categories. This simplification may also be used if the vector spaces for feature vectors 112A′, 112B′, 112C′, 112D′ are not sufficiently stable, there is a high level of cross-talk between them and/or the environment, fading, aliasing or any other source of artifacts or noise. The rules that apply distributed machine learning algorithm 130 to joint feature vector 112X′ are the same as in the case of any one or more of the four redox categories. Note that joint feature vector 112X′ will generally be higher-dimensional than any one of feature vectors 112A′, 112B′, 112C′, 112D′.

The need for collapsing feature vectors 112A′, 112B′, 112C′, 112D′ to single joint feature vector 112X′ due to the above-mentioned limitations stems from the real-world, as this inherent noisiness of even model redox data 112 will often be present. Biological entities have evolved redundancies to enable them to survive a wide range of environmental stresses. This creates the challenge that it is therefore difficult to measure and attribute any specific redox indicator to a specific process—e.g., to any specific type of oxidative stress that is exemplified by the bioprocess of interest.

For this reason, among others, learning system 100 attempts to identify the optimal features or redox indicators that can serve as a fingerprint for redox status through distributed learning algorithm 130 and the available learning techniques. Redox status in a hidden compartment is difficult to measure, and is hence treated as hidden. In fact, any such individual measure may be too non-specific to yield meaningful results. However, the present learning algorithm 130 focuses on patterns in measurement redox data including select observable redox indicators that, when taken together with additional available context redox data in the fifth redox category, can yield useful inferences with respect to redox status.

Still in reference to FIG. 2B, we focus on redox category three of signaling redox data 112C as an example to provide a detailed explanation of the workings of learning algorithm 130. A person skilled in the art will recognize that the example of signaling redox data 112C represented in feature vectors 112C′ applies to redox data in any of the first four categories that contain structured redox data. In fact, the manner of dealing with a joint feature vector into which two or more feature vectors 112A′, 112B′, 112C′, 112D′ are collapsed if necessary, would be analogous. Thus, the following description for feature vector 112C′ applies just as well to joint feature vector 112X′.

Reference bioprocess model 106 transmits time series 112CS′ of feature vectors 112C′ collected at times t₁, t₂, . . . , tᵢ from reference biological entity 110 or 150 and/or validated and corroborated with curated model data 108 (see FIGS. 1A-B) to master learner 114. In some cases, times t₁, t₂, . . . , tᵢ are selected in reference bioprocess model 106 to mark distinct stages, transitions, reaction periods or still other important times in the bioprocess of interest.

Each feature vector 112C′ in time series 112CS′ that is not steady state exhibits different values in data entries {c₁, c₂, . . . , cₙ}. The entries are taken to range from 1 to n (i.e., there are n data entries in feature vector 112C′). In order to be suited for machine learning, each one of data entries {c₁, c₂, . . . , cₙ} is preferably an accepted observable redox indicator, as mentioned above.

Redox balance is due to relative oxidation/reduction status between redox couples operating at the physical chemistry level. Some of the most suitable couples without their co-factors are listed in Tables 1A-C below.

TABLE 1A
Redox Pairs
*Isotopically Labeled Standard used

| | Analytes |
|---|---|
| Panel 1 | Cystine* |
| | Cysteine* |
| | Cysteine Persulfide* |
| | GSSG* |
| | GSH* |
| | GSH Persulfide* |
| | HomoCystine* |
| | XOMA |
| | H₂S* |
| | Thiosulfate* |
| | Tetrathionate |
| | CysGly Dipeptide* |
| | GluCys Dipeptide* |
| | Cys-GSH Disulfide |
| | Ophthalmic Acid* |
| | Cystathionine |
| | Lanthionine |
| | GSH-Sulfonic Acid |
| | Lipoic Acid |
| | Cysteamine |
| | Methionine* |
| | Adenosine* |
| | SAM* |
| | SAH |
| | Spermine* |
| | Spermidine* |
| | Citrulline* |
| | Ornithine |
| | Kynurenine |
| | Kynurenic Acid |
| | Serine |
| | Taurine* |
| | Pyroglutamic Acid |
| | α-Aminobutyric Acid* |
| | 3-NitroTyrosine* |
| | 3-ChloroTyrosine* |
| | Glutamate |
| | Homocitrilline |
| | Aspartate |

TABLE 1B
Redox Pairs
*Isotopically Labeled Standard used

| | Analytes |
|---|---|
| Panel 2 | NAD |
| | NADP |
| | AMP |
| | ADP |
| | ATP |
| | cAMP |
| | Xanthine |
| | Hypoxanthine* |
| | 2-deoxy-guanosine* |
| | Inosine |
| | Acetyl-Carnitine* |
| | Carnitine |
| | NADH |
| | NADPH |
| | Urate |
| | 8-OH-dG |
| | Pyrimido purinone |
| | Fumurate* |
| | Succinate* |
| | Lactate* |
| | Pyruvate* |
| | Acetoacetate |
| | 3-Hydroxybutyric |
| | Acid |
| | 743-OH |
| | 743* |
| | 886 |
| | A0001-OH |
| | A0001* |
| | α-TOC |
| | α-CEHC |
| | δ-CEHC |
| | 743-OH-Sulfate |
| | 743-OH-Gluc |
| | A0001-OH-Sulfate |
| | A0001-OH-Gluc |
| | 589* |
| | 589-OH |
| | 589-Sulfate |
| | 589-Gluc |

TABLE 1C
Redox Pairs
*Isotopically Labeled Standard used

| | Analytes |
|---|---|
| Panel 3 | CoQ10 |
| | Ubiquinol (CoQ10-OH) |
| | Docosahexaenoic Acid (DHA)* |
| | Arachidonic Acid (AA)* |
| | Linoleic Acid |
| | Palmitoyl Carnitine |
| | Prostaglandin E2* |
| | tetranor PGE-M* |
| | tetranor PGA-M |
| | 15-Deoxy-PGJ2 |
| | 15-Deoxy-PGJ2-GSH |
| | Leukotriene E4* |
| | Leukotriene C4 |
| | 8-iso-PGF2a* |
| | Creatinine (urine) |
| | 2,3-DPG (RBC contamination of |
| | plasma) |

As discussed above, measures of actual redox balance between individual redox may be inaccessible in many contexts. Even if possible in principle, due to local conditions such measurements may not be feasible in many applications for which the presently described systems may be used. In other words, in some cases, measures of redox reactions at the level of physical chemistry may not be considered as candidates for observable redox indicators.

Of course, even though they may not be accessible, such redox reactions clearly do occur and would advantageously be accounted for in some manner. For this reason, any unobservable redox reactions or their consequences at the level of physical chemistry or higher are tracked herein as hidden states. Even though the real and observable basis of redox indicators will not include any hidden states or otherwise hidden or inaccessible data, their presence is expressly included in the learning model, as discussed below.

Particularly useful and established electron balance indicators that classify as observable redox indicators include the presence or concentration of an oxidoreductase or of an oxidoreductase co-factor. Other observable redox indicators include the presence or concentration of balance influencer compounds, electron balance influencer compositions or still other redox-active compounds. The reader is again referred to Tables A-C above for a partial list.

Still other observable redox indicators include, e.g., pK values, pH values, threshold values, context measures and soft indicators. Note that soft indicators will typically be placed among the contextual and other unstructured data in list 112E*. Data entries {c₁, c₂, . . . , cₙ} of each feature vector 112C′ contain one of the candidate observable redox indicators. Hence, each vector 112C′ can be written as:

112C′=c={c₁,c₂,c₃ . . . cₙ} [Eq. 1]

where boldface lower-case lettering is used to designate a vector quantity. The series 112CS′ can then be described as a series of vectors c composed of observable redox indicators {c₁, c₂, . . . , cₙ} as set forth in Eq. 1.

The underlying rules of redox reactions in the corresponding redox category, here the redox signaling category, may dictate that as time progresses the selection of observable redox indicators {c₁, c₂, . . . , cₙ} exhibit a certain conservation pattern. For example, if observable redox indicators {c₁, c₂, . . . , cₙ} encode all participating elements or molecules in a relatively isolated redox signaling pathway, then their number should be conserved. Therefore, series 112CS′ is expected to obey a certain conservation criterion. An example appreciated by the skilled artisan is the conservation of reagents irrespective of the individual fluxes (reactions) in stoichiometry. In other words, the total of entities at the start and at the end cannot change (also referred to as conservation of elements or constituents). This conservation law allows one to set up and deploy the well-known stoichiometric matrix S.

From a conservation criterion or other known rule a matrix equation, possibly involving stoichiometric matrix S or a transition matrix, can be set up. Once the matrix equation is set up, the vector space of vectors c can be parameterized and a set of linearly independent vectors that span that vector space can be established. When normalized, such vectors represent observable basis 116 for vectors c composed of observable redox indicators. In other words, any vector c can be obtained or decomposed in a linear combination of the vectors in basis 116.

In a preferred embodiment master learner 114 can receive initial guidance on a suitable basis 116 from reference bioprocess model 106. For example, the module of distributed learner 130 residing in reference bioprocess model 106 can be in charge of providing such initial suitable basis 116 as part of the reference learning model (described in more detail below). However, in many cases, this suggestion will be adjusted based on local conditions and what can be measured. For example, if only a small subset of redox indicators that model 106 is based on can be measured, then master learner 114 will have to reduce the dimensionality of basis 116. In applying the tools of linear algebra care needs to be taken to ensure a reasonable level of completeness, orthogonality and other requirements for applying the desired learning algorithm, as discussed below. It is duly noted that some of the observable redox indicators may be present in more than one redox category. In other words, observable redox indicators in feature vectors 112A′, 112B′, 112C′ and 112D′ may be the shared.

In some situations, overlap in observable redox indicators between redox categories leads to unacceptable levels of cross-talk for machine learning. In those cases, joint feature vector 112X′ should be used. As already stated, joint vector 112X′ simply combines available redox indicators into a single feature vector in a single or joint vector space. In situations where the cross-talk is acceptably low, the same process as in the case of feature vector 112C′ is followed for establishing bases in the vector spaces containing feature vectors 112A′, 112B′ and 112D′. In any case, master learner 114 can receive initial guidance from distributed learning algorithm 130 resident in reference bioprocess model 106 about the level of cross-talk to expect and whether combining the vector spaces is advisable.

FIG. 2B shows observable basis 116 for feature vectors 112C′ in third redox category consisting of basis vectors {ce₁, ce₂, ce₃}. Only three basis vectors are shown in this case for reasons of clarity. The vector space containing feature vectors 112C′ could and typically will have a higher dimensionality than 3. The vector spaces containing feature vectors 112A′, 112B′ and 112D′ also have basis vectors {ae₁, ae₂, . . . , ae_{q}}, {be₁, be₂, . . . , beₘ} and {ae₁, ae₂, . . . , aeₙ}, respectively. The dimensionalities of their vector spaces are equal to the numbers of entries or observable redox indicators, i.e., q, m and n. Basis vectors {ae₁, ae₂, . . . , ae_{q}}, {be₁, be₂, . . . , beₘ} and {ae₁, ae₂, . . . , aeₙ} are not shown explicitly in FIG. 2B for reasons of clarity.

When referring to observable basis 116 herein, we mean all basis vectors {ae₁, ae₂, . . . , ae_{q}}, {be₁, be₂, . . . , beₘ}, {ce₁, ce₂, ce₃} and {ae₁, ae₂, . . . , aeₙ} or any joint observable basis. Of course, observable basis 116 can be reduced to just one or a select few of the redox categories in applications where redox status corresponding to just the one or just the select few of the redox categories is being measured.

In addition to providing observable basis 116, master learner 114 also reduces the amount of model redox data 112 communicated to local learner 118 to just portion 112′ based on specific context and local conditions. In the simple case of only concentrating on redox data in the third category, master learner 114 can remove from the portion of model redox data 112′ all redox information in the first, second and fourth categories. In other words, feature vectors 112A′, 112B′ and 112D′ can be dropped by master learner 114 from portion 112′ that is sent to local leaner via primary feedback loop 154. Only time series 112CS′ would thus be included in portion 112′. Furthermore, if the temporal resolution of measurement at the local end is low, then master learner 114 may further reduce the amount of data by sending only a sub-sample of time series 112CS′. Exactly this situation is illustrated in FIG. 2B, wherein portion 112′ contains only a sub-sample of time series 112CS′ and does not contain any redox data in categories one, two and four.

In any particular embodiment, local learner 118 receives at least portion 112′ of model redox data 112 from reference bioprocess model 106. In addition to limiting portion 112′ based on relevancy, i.e., where portion 112′ contains only model redox data relevant to local conditions or is otherwise a limited portion of model redox data 112, master learner 114 can also limit it for other reasons. Such other reasons or considerations can include the bandwidth of primary feedback loop 154 and technical considerations, capabilities and throughput of sensors or measuring devices as well as other aspects of local conditions.

On the other hand, local learner 118 can receive all measured redox data 124 from local biological entity undergoing the bioprocess. Local learner 118 preferably shares all measured redox data 124 with master learner 114 via primary feedback loop 154. This situation is shown in FIG. 2B, where measured redox data 124 contains all measured redox data 124. The number of measured feature vectors 112CS″ (where double prime notation is used here and below to distinguish model from measured quantities) in measured redox data 124 is larger than in portion 112′ that is sub-sampled. It is preferable not to discard extra data if measurement devices or sensors under local conditions are capable of capturing it. A person skilled in the art of signal processing will appreciate how to best take advantage of additional information and headroom in sensor performance.

FIG. 2C is a diagram that focuses on measured redox data 124Z from subject 201Z as introduced in FIG. 1B. Of special interest is measured redox data in third redox category 112C. This redox data is structured and formatted as feature vector 112C″. The entries in measured feature vector 112C″ conform with the requirements of forming a proper vector in the vector space spanned by basis vectors {ce₁, ce₂, ce₃} (see FIG. 2B). The data entries in feature vector 112C″ correspond to the definition provided in Eq. 1 above. However, because each of the data values is obtained from a measurement, a “hat” is placed above it to denote that fact. This is standard notation for measured quantities frequently deployed by those skilled in the art. Measured feature vector 112C″ is thus written as:

112C″=ĉ={ĉ₁,ĉ₂,ĉ₃. . . ĉ₄}.

The measured redox data series 112CS″ can then be described as a series of vectors ĉ, exactly as the series of model vectors c set forth in Eq. 1. Another way to express the temporal dependence of model and measured feature vectors is to introduce time explicitly—i.e., c=c(t) and ĉ=ĉ(t).

FIG. 2C also shows in more detail the local conditions 202Z under which human subject 201Z can be measured. Integrated measurement device 122Z and actuation device or mechanism 128Z are shown in the same wrist-worn health monitoring device that subject 201Z is wearing during their exercise routine. Local conditions 202Z at the level of subject 201Z are outdoors. The contextual information includes list data such as running, weather, elevation, prior subject data and any other information that is relevant to redox status. All the contextual information may then be provided in the fifth category of measured redox data 112E′*. List redox data 112E′* is part of measured redox data 124Z for subject 201Z.

Measurement device 122Z in health monitoring unit is shown using the wireless channel to transmit measured redox data 124Z to local learner 118. More specifically, it is the distributed portion of local learner 118A (see FIG. 1B) running as an application on health monitoring device that effectuates the wireless transmission. In this case local learner may be running on a dedicated computing device at the home of subject 201Z. Alternatively, local learner 118 can run on a computing device assigned to a group of subjects to which subject 201Z belongs. In that case local learner 118 can run on a computer at a health and fitness facility or a health monitoring establishment, including health care facilities. Again, in each case, local computing device could be a combination of a local device or local interface and cloud computing resources. A person skilled in the art will recognize that suitable options and communication architectures for transmitting measured redox data 124Z to local learner 118 are vast and should be chosen in accordance with standard protocols known to the skilled artisan.

FIG. 2C also shows master learner 114 and local learner 118 with learning algorithm 130 distributed between them. This distribution ensures that learning algorithm 130 has access to model redox data 112 arriving through master learner 114 and to measured redox data 124Z arriving through local learner 118. All the necessary communications between master and local learners 114, 118 are supported by primary feedback loop 154.

As illustrated, learning algorithm 130 has access to observable basis of redox indicators 116 for the third redox category, i.e., {ce₁, ce₂, ce₃, ceₚ}. Basis 116 is picked by master learner 114 from model redox data 112 yielded by reference bioprocess model 106 (see FIG. 1B). Knowledge of this useful basis 116 and model data 112 enables algorithm 130 to organize measured redox data 124Z in a useful way. Namely, algorithm 130 expresses the portion of measured redox data 124Z that is structured in vector form to be decomposed or expressed in basis 116. This applies to feature vector 112C″ but not to list 112E′*.

A purpose of distributed learning algorithm 130 of learning system 100 (see FIGS. 1A-B) is to determine, discover or learn an optimal composition of measured redox data 132. Optimal redox data 132 are those that should be chosen or included in the set of measured redox data 124Z that is collected under local conditions 202Z from subject 201Z undergoing the bioprocess. In cases where algorithm 130 has already determined optimal redox data 132 and local learner 118 is collecting measured redox data 124Z according to this optimal selection, measured redox data 124Z correspond to optimal measured redox data 132 and are expressed in basis 116.

The establishment of basis 116 by master learner 114 is used in determining optimal measured redox data 132. Expressing the structured portion of redox data, whether from the model (i.e., model redox data 112) or measured (i.e., measured redox data 124) in terms of feature vectors in common basis 116 allows the necessary comparisons and learning to take place. In other words, common basis 116 for the model and measured data permits evaluation in a common context (otherwise, the data may not be commensurate). Thus, a useful comparison between structured model and measured data could not be made for the purposes of machine learning.

In the present exemplary case, learning algorithm 130 deploys basis 116 and then corroborates it by studying the differences between series of measured feature vectors 112CS″ from measured redox data 124Z amongst each other and with model feature vectors 112C′ found in model redox data 112. In other words, learning algorithm 130 deploys learning approaches to evaluate measured feature vectors ĉ and ideal or model feature vectors c. Algorithm 130 can then determine whether measured feature vectors ĉ exhibit behavior expected from bioprocess reference model 106.

The first step in this process relies on proper decomposition of model feature vector 112C′ and measured feature vector 112C″ over the vectors in basis 116. The decomposition can be performed in any suitable manner known to those skilled in the art. If possible, however, the decomposition attempts to maximize independence between the redox indicators. This means that, learning algorithm 130 picks the best basis vectors {ce₁, ce₂, ce₃, . . . , ceₙ} such that the decompositions take on the following form:

112C′=c={c₁,c₂, . . . ,cₙ}=(c₁·ce₁)+(c₂·ce₂) . . . +(cₙ·ceₙ); [Eq. 2A]

112C″=ĉ={ĉ₁,ĉ₂, . . . ,ĉₙ}=(ĉ₁·ce₁)+(ĉ₂·ce₂)+(ĉₙ·ceₙ). [Eq. 2B]

Clearly, the above decomposition is sensitive to deviations in behavior between model and measured redox indicators. It allows algorithm 130 to determine whether the time series of measured feature vectors ĉ(t) agree with expectations set by model feature vectors c(t). This means that algorithm can monitor the unfolding of the bioprocess occurring in subject 201A against the model.

FIG. 2C illustrates learning algorithm 130 comparing a specific measured features vector ĉ with its model counterpart feature vector c. All redox indicators making up the data entries of the feature vectors are compared as shown. If correspondences are not found then the measurement of the particular redox indicator can be dropped.

In fact, exactly such an adjustment is shown in FIG. 2C, where only data entries or redox indicators {ĉ₁,ĉ₂,ĉ₄} of measured feature vector 112C″ behaving in predictable ways are retained in optimal feature vector 132C. In other words, measured redox data 124Z part represented by measured feature vector 112C″ is reduced to just the few redox indicators {ĉ₁,ĉ₂,ĉ₄} that are also found to decompose over observable basis 116 established by master learner 114.

Per Eq. 2B, decomposition of measured feature vector 112C″ over the vectors in basis 116 is preferably as follows:

112C″=ĉ={ĉ₁,ĉ₂,ĉ₄}=(ĉ₁·ce₁)+(ĉ₂·ce₂)+(ĉ₄·ce₄).

In other words, in the preferred deployment of learning algorithm 130, measured feature vector 112C″ not only includes the redox indicators that are in the observable basis 116, but each redox indicator is the coefficient associated with one of the basis vectors. Under these conditions the measures of the local bioprocess can effectively focus on just the observable measures, i.e., observable redox indicators in the real vector space spanned by basis 116.

Of course, measured redox data 124Z also contains a contextual part. This part is in the list captured by measured redox data 112E′* in the fifth category. This category may contain data that does not directly pertain to or represent redox indicators {ĉ₁,ĉ₂,ĉ₄} in observable basis 116. For example, measured redox data 112E′* may contain contextual data or data with as yet unknown relationship to redox indicators {ĉ₁,ĉ₂,ĉ₄}. The measured redox data is also understood to optionally include data about probabilities, statistical relationships and/or any or other information that appears to pertain or may be found through learning by distributed learning algorithm 130 to pertain to one or more redox indicators {ĉ₁,ĉ₂,ĉ₄}.

In some cases, measured redox indicators {ĉ₁,ĉ₂,ĉ₄} contain at least one commonly accepted redox indicator. In other words, in such cases at least one of the measured redox indicators should not be an untested quantity. Particularly useful and established electron balance indicators include indicators consisting of an oxidoreductase, an oxidoreductase co-factor, an electron balance influencer compound, an electron balance influencer composition, a redox-active compound, a pK value, a pH value, a threshold value, a context measure and a soft indicator.

Furthermore, in many cases, the useful redox indicators will optimally be measured on short time scales in comparison to GPR times, as already indicated above. Hence in advantageous embodiments the at least one electron balance indicator is measured with a frequency of at least once every hour, at least once every 30 minutes, at least once every 10 minutes, at least once every 5 minutes, at least once every minute, at least once every 30 seconds, at least once every 10 seconds, at least once every 5 seconds, at least once every second, at least twice every second, at least 5 times every second, at least 10 times every second, at least 20 times every second, at least 50 times every second, at least 100 times every second, or more.

FIG. 2D is a diagram showing the representation of hidden states in a reference learning model 131 used by learning algorithm 130. Hidden states XC1, XC2, . . . , XCj are placed in reference learning model 131 and connect to observable redox indicators in both model and measured feature vectors 112C′, 112C″. They are inaccessible or not measureable parameters that include individual redox states, redox-related parameters or other inaccessible aspects of the bioprocess of interest transpiring in subject 201Z.

For purposes of illustration, the diagram of FIG. 2D expands in the first highly magnified section A to the cell level. Here we see a cell 203 of subject 201Z. Shown in detail are mitochondria 203A and cell nucleus 203B. A second highly magnified section B enlarges a portion of mitochondria 203A to the physical chemistry level. At this level, we find redox couple 104 including redox couple members 104A, 104B and an oxidoreductase or a co-factor 205.

Many aspects of redox status inside mitochondria 203A may not be accessible to measurement. In particular, internal parameters, such as, e.g., internal pH or pH may not be obtained by measurement device 122Z. Thus, internal pH of mitochondria 203A would not qualify as an observable redox indicator for inclusion in feature vector 112C′. However, internal pH of mitochondria 203A clearly influences the redox status in the bioprocess of interest. In fact, the Nernst equation would have to be used to determine just how much the redox potential is affected by internal pH of mitochondria 203A.

In this context, therefore, internal pH of mitochondria 203A would be taken to correspond to a hidden state. Of course, in most cases described herein the hidden state is understood to be the cumulative state over many hundreds, thousands or even larger numbers of reacting entities in the system or sub-system of interest; i.e., many mitochondria 203A. In the present situation, internal pH is represented in reference learning model 131 of distributed learning algorithm 130 by hidden state XC1. Hidden state XC1 is shown to affect measureable redox indicators c₁ and c₂ in accordance with well-known hidden state models, e.g., the Hidden Markov Model.

Redox reactions between redox couple members 104A, 104B aided by oxidoreductase or co-factor 205 at the physical chemistry level, as visualized in highly magnified section B of mitochondria 203A, may likewise be inaccessible to measurement. Therefore, redox reactions between redox couple members 104A, 104B would also be taken to correspond to a hidden state of reference learning model 131. In this case they correspond to hidden state XC2 that stands for the redox potential Eₕ of redox pair 104 in reference model 131 being run by distributed learning algorithm 130. Hidden state XC2 is shown to affect measurable redox indicators c₂ and c₃.

Hidden states XC1, XC2, . . . , XCj are interconnected. Interconnections are associated with transitions and transition probabilities in accordance with standard hidden state models, e.g., the Hidden Markov Model. In FIG. 2D the transitions are indicated with dashed arrows. Such transitions are probabilistic and are part of the bioprocess reference model 106 and more specifically still of reference learning model 131. That is because model 106 is based on curated reference model redox data 108 collected from previous runs and tests of the bioprocess. These include, whenever possible, actual measures of hidden states XC1, XC2, . . . , XCj and transitions between them. Of course, these hidden states are not accessible under local conditions.

The curated model redox data 108 that contains information about transitions between hidden states XC1, XC2, . . . , XCj is preferably further corroborated or validated by model redox data 152 obtained from reference biological entity or live subject 150 undergoing the bioprocess of interest in the lab (see FIG. 1B). In addition, transition probabilities are preferably further tuned during the learning process in accordance with standard rules for computing a transition matrix, as is known to those skilled in the art.

FIG. 2E affords a more detailed look at transition probabilities p_{1,2}, p_{2,1}, p_{3,j}, p_{j,3} between hidden states XC1, XC2, XC3 and XCj. The first subscript on p_{i,j} refers to the initial hidden state before the transition. The second subscript refers to the final hidden state after transition. We use lower case letters p_{i,j} (rather than the traditional upper case) to denote transition probabilities between hidden states XC1, XC2, XC3 and XCj because they are inaccessible. Still, hidden states XC1, XC2, XC3 and XCj directly affect data entries or measured redox indicators {ĉ₁,ĉ₂,ĉ₄} in measured feature vector 112C″. (Note that these same redox indicators have been selected as optimal redox indicators for optimal feature vector 132C by algorithm 130.)

A transition matrix p is used by algorithm 130 to keep track of transition probabilities p_{1,2}, p_{2,1}, p_{3,j}, p_{j,3}. Transitions between all hidden states XC1, XC2, . . . , XCj are accounted for by transition matrix p as follows:

$$p = [ \begin{matrix}{p}_{1 , 1} & … & {p}_{1 , j} \\ ⋮ & ⋱ & ⋮ \\ {p}_{j , 1} & … & {p}_{j , j}\end{matrix} ] . \qquad [ Eq . 3 ]$$

As illustrated in FIG. 2E, hidden states XC1, XC2 and XC3 are the only ones from which the bioprocess of interest is expected to yield measured redox indicators {ĉ₁,ĉ₂,ĉ₄}. Hidden state XCj is specifically not expected to correspond to a state of the bioprocess that is capable of yielding any locally measurable redox indicator. Still, because of transition probabilities p_{3,j}, p_{j,3} the full transition matrix p has to be used to ensure probability conservation by learning algorithm 130.

Learning algorithm 130 trains or learns on sets of measured redox data 124Z from subject 201Z (see FIG. 2C) and other similar subjects. In accordance with standard learning methods, algorithm 130 iteratively reviews relevant transition probabilities p_{1,2}, p_{2,1}, p_{3,j}, p_{j,3} originally obtained from reference learning model 131 to adjust them as needed. Preferably, measured redox data 112E′* contains measured list entries [ê₁, ê₂, . . . , ê_{y}] of both redox indicator candidates and unstructured data to aid in this process. Furthermore, the transition matrix and the condition for conservation of total probability are used by algorithm 130 to ensure that any adjustments to transition matrix p obey the rule of conservation of probability.

In addition to transitions between hidden states XC1, XC2, XC3, . . . , XCj reference learning model 131 deployed by learning algorithm 130 assigns probabilities to measurement outcomes. These are measurement probabilities leading to observable redox indicators. They are hence denoted by the traditional upper case P_{i,j}. Specifically, if the bioprocess of interest is in hidden state XC1 it has a measurement probability P_{xc1,c1} of yielding observable redox indicator c₁. From the same hidden state XC1, it has a measurement probability P_{xc1,c2} of yielding observable redox indicator c₂.

Outcomes or measurement transition probabilities from hidden states are part of the bioprocess reference model 106 and its reference learning model 131. Model 106 is based on curated reference model redox data 108 collected from previous runs and tests of the bioprocess that includes measurement probabilities. As in the case of transition probabilities, the curated model redox data 108 that contains information about measurement transition probabilities between hidden states XC1, XC2, XC3 and measured redox indicators {ĉ₁,ĉ₂,ĉ₄} is preferably further corroborated or validated by model redox data 152 obtained from reference biological entity or live subject 150 undergoing the bioprocess of interest in the lab (see FIG. 1B). Measurement probabilities are preferably further tuned during the learning process in accordance with standard rules known to those skilled in the art.

In the case shown in FIG. 2E, learning algorithm 130 obtains relevant measurement probabilities P_{xc1,c1}, P_{xc1,c2}, P_{xc2,c2}, P_{xc2,c3}, P_{xc3,c4} from reference learning model 131 that is part of model 106 and tunes them during learning. Note that conservation of probability can be used in order to properly account for all outcomes. This is analogous to tracking transition probabilities between hidden states. Specifically, measurement probability P_{xc2,c3} is still present, but measured redox indicators {ĉ₁,ĉ₂,ĉ₄} in measured feature vector 112C″ do not include observable redox indicator c₃. Thus, the corresponding measurement probability becomes hidden. For this reason, measurement probability P_{xc2,c3} and measurable but not actually measured redox indicator {ĉ₃} are indicated in hatched boxes.

Preferably, list of model redox data 112E* contains information about candidates for measurable redox indicators under local conditions and in changing contexts. Specifically, list 112E* preferably indicates that measurements from hidden state XC2 will not be fully reflected when redox indicator c₃ is dropped from optimal feature vector 132C. In fact, reference bioprocess model 106 preferably provides distributed learning algorithm 130 with a preliminary set of expected hidden states, transition probabilities and measurement probabilities for reference learning model 131 in list 112E. Thus, algorithm 130 running on master learner 114 does not have to start learning these parameters without guidance. Instead, algorithm 130 tunes these parameters based on learning from measured redox data 124Z. When a major deviation or correction is discovered by algorithm 130, then it can send this data to reference bioprocess model 106 in update 134, as shown in FIGS. 1A-B. In other words, master learner 114 may initialize local learner 118 with an initial set of weights or initial conditions from reference bioprocess model 106 to increase the chance that local learner 118 will be able to converge more rapidly given the computational resources.

Information captured by measured redox data 112E′* in the fifth category can also contain data that does not directly pertain to redox indicators {ĉ₁,ĉ₂,ĉ₄} in observable basis 116. For example, measured redox data 112E′* may contain contextual data or data with as yet unknown relationships to redox indicators {ĉ₁,ĉ₂,ĉ₄}. Such relationship may then be found through learning by distributed learning algorithm 130.

As also indicated in FIG. 2E, learning algorithm 130 can further condition observable redox indicators {c₁, c₂, c₄} by assigning a weighting or a confidence level to one or more of them using a conditioning module 210. Such assignment allows for local tuning beyond adjusting measurement probabilities or transition probabilities. For example, confidence levels and weightings can represent relative confidence in the local measurement process, or can be used to factor in the availability, practicality or cost of certain local measurement parameters. Furthermore, since the reactions of interest concern electron balance, learning algorithm 130 can focus on just observable redox indicators that are measured on time scales shorter than Gene-Protein-Reaction (GPR) time.

Upon learning from both reference bioprocess model 106 and the local bioprocess learning algorithm 130 can keep changing or adjusting redox indicators {c₁, c₂, c₄} decomposed over observable basis 116. Of course, any material learned adjustment in observable basis 116 of redox indicators should be communicated to master learner 114. Also, reference bioprocess model 106 can be configured to receive a reference model adjustment from learning algorithm 130 based on what it has learned. Reference model adjustment 134 can involve an alteration in model redox data 112, an alteration in the model conditions or an alteration in the hidden states postulated to exist in reference learning model 131.

Learning system 100 can employ many general methods that extend beyond working from just reference learning model 131 initially used by learning algorithm 130. In other words, learning algorithm 130 that engages in learning the optimal composition of measured redox data 132 or of observable redox indicators {c₁, c₂, c₄}, say by choosing them from a general set of redox indicators need not be implemented within any one particular learning paradigm. In fact, learning system 100 can employ one or more learning methods. Some particularly useful methods in the embodiments of the present invention include Artificial Intelligence (AI) methods, Hidden Markov methods and Deep Learning (multi-layered neural network) methods. Any of these methods can be implemented in the recursive feedback structure presented by learning system 100 of the invention.

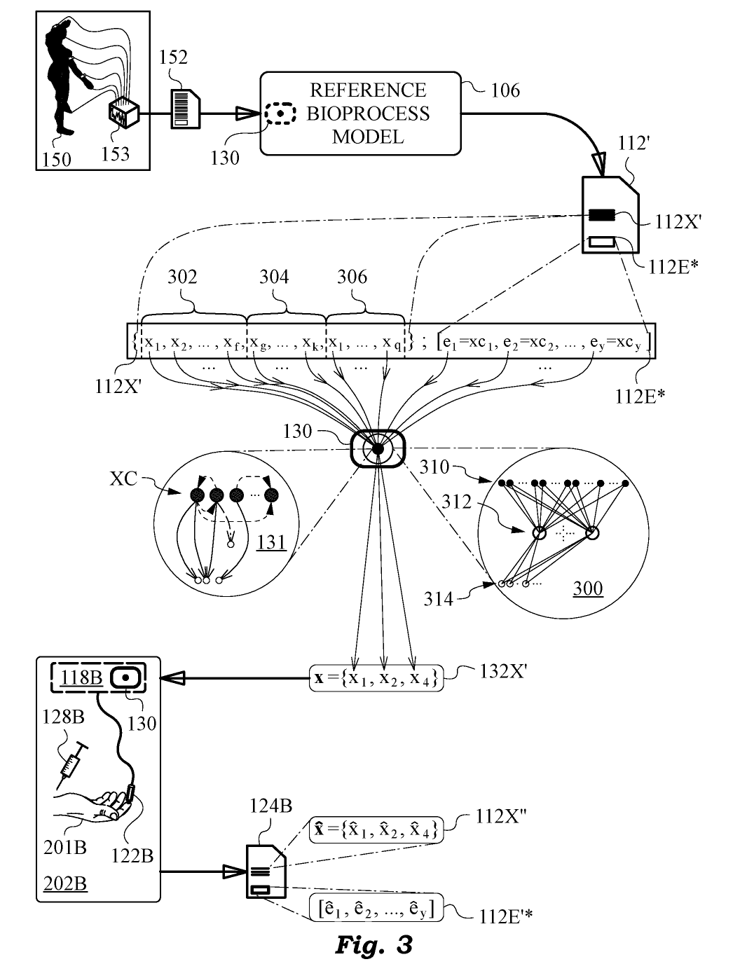

FIG. 3 is a diagram illustrating in more detail a specific learning method. This learning method is embodied by a neural network learning model 300 deployed by learning algorithm 130. In this embodiment, reference bioprocess model 106 is constructed from model redox data 152 obtained from reference biological entity 150 as shown in FIG. 1B. As in the previous embodiment, distributed learning algorithm 130 starts from reference learning model 131.

In this example reference bioprocess model 106 collapses the four redox categories into a single joint model feature vector 112X′. It also provides model redox data 112E* enumerating possible alternative candidate redox indicators xc₁, xc₂, . . . , xc_{y}. These candidates could be used in joint model feature vector 112X′. Thus, model redox data 112′ contains just joint model feature vector 112X′ and list 112E*.

The exploded view of joint model feature vector 112X′ at a specific time (not expressly indicated in the present drawing) shows a further subdivision in the vector's data entries. Specifically, as shown, model redox indicators x₁, x₂, . . . , x_{f} belong to a first panel 302 corresponding to the second redox principle or category (the of redox electron transfers to adjust protein structure through kinetically controlled redox switches, a.k.a. as S-switches or Sulphur switches). Model redox indicators x_{g}, . . . , xₖ belong to a second panel 304 of redox indicators that are likely in the first redox category or in the fourth redox category. Model redox indicators x₁, . . . , x_{q} are redox indicators that cannot be clearly identified with any category. These unassignable redox indicators are put in a third panel 306.

In the present example, neural network learning model 300 receives joint model feature vector 112X′ at its inputs 310. Hidden layer 312 of model 300 deploys neural learning to determine a series of outputs 314 that best satisfy a learning criterion. In the present case, the learning criterion is the selection of optimal composition of measured redox data 132. More specifically, the optimal composition of redox indicators to be used in joint feature vector 112X′—i.e., optimal joint feature vector 132X′.

Preferably, model 300 runs alongside reference learning model 131 based on hidden states XC that are merely inaccessible, but physically real, as described above. At the onset, outputs of reference learning model 131 suggest that optimal joint feature vector 132X′ to be measured in measured redox data 124B collected from subject 201B under local conditions 202B should be {x₁, x₂, x₄}. This is indeed measured joint feature vector 112X″.

Over time, however, deep learning model 300 is expected to diverge from reference learning model 131 in its suggestion of optimal joint feature vector 132X′. This is expected because deep-learning model 300 which will introduce by its very nature non-physical hidden layers and states without any direct correspondence to hidden states XC of reference learning model 131. As long as such states have a material effect on redox status they should be postulated in learning model 300 as a part of the deep-learning process. Distributed learning algorithm 130 should start using the recommendation of learning model 300 as soon as the latter starts performing better than reference learning model 131 on which distributed learning algorithm 130 started.

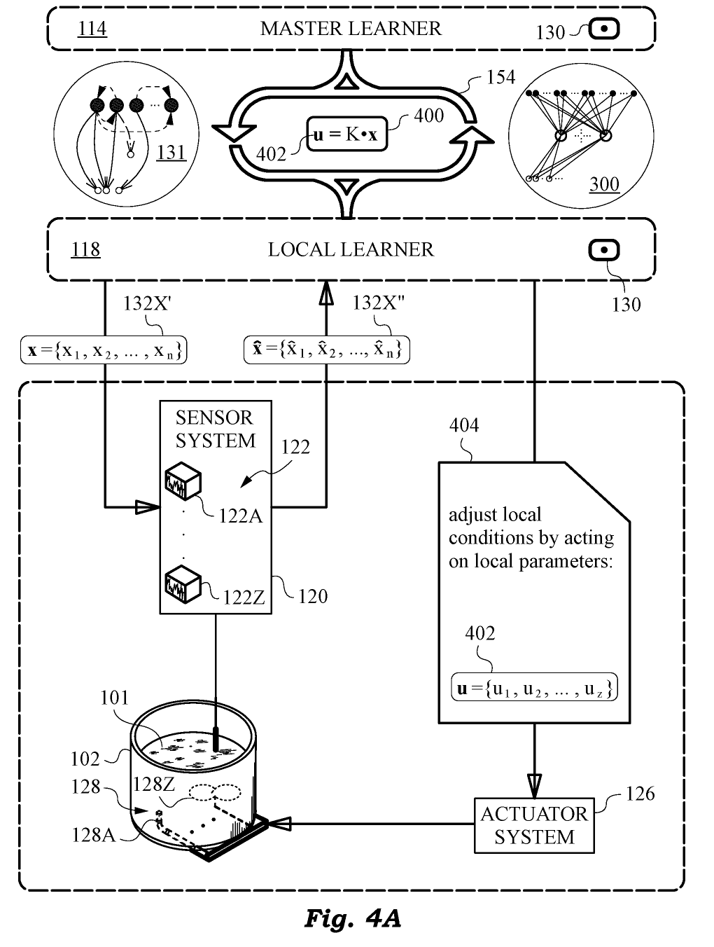

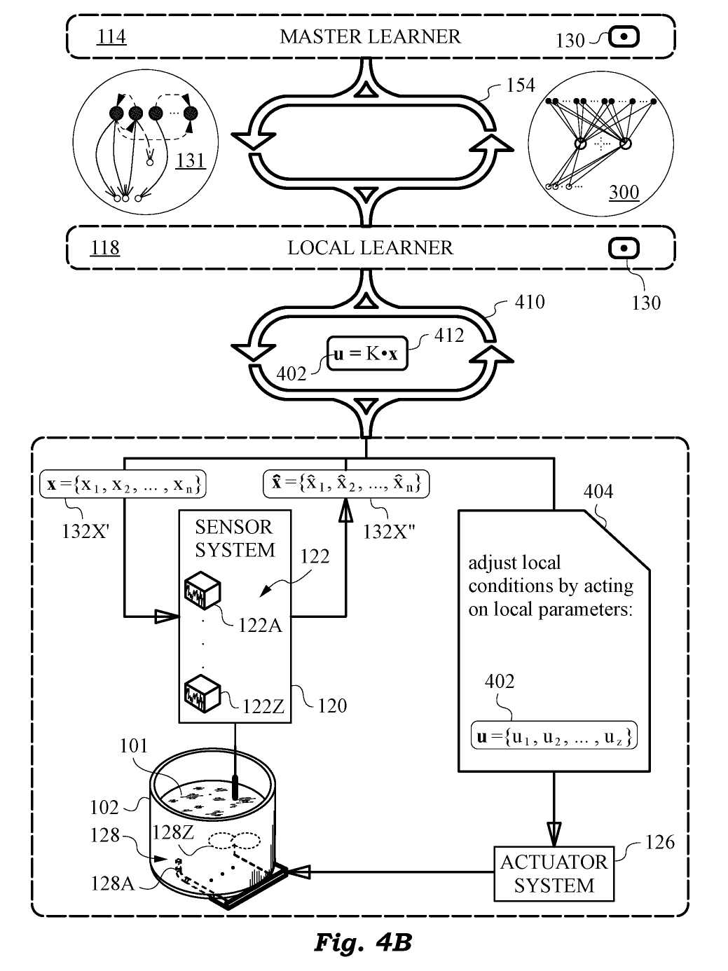

FIG. 4A shows an embodiment in which learning algorithm 130 can learn how to adjust local conditions by making adjustments to local control parameters. For this reason, the at least one local entity that is undergoing the bioprocess is preferably configured to receive a local control parameter adjustment from the learning algorithm via whatever local affordances are available. For exemplary purposes, we review the adjustment of local conditions for an embodiment in which the bioprocess of interest is transpiring in bioreactor 102 of learning system 100 as shown in FIG. 1A. Only the relevant parts of system 100 from FIG. 1A are shown in FIG. 4A for reasons of clarity.

FIG. 4A illustrates aster learner 114 and local learner 118 cooperatively learning about the bioprocess of interest in bioreactor 102 with the aid of distributed learning algorithm 130. Primary feedback loop 154 is sharing the results of tuning and adjustments to reference learning model 131 and the learning achieved by deep learning model 300 between learners 114, 118.

The results of learning by learning algorithm 130 produce optimal feature vector 132′. More precisely, distributed learning algorithm 130 started with reference learning model 131 and its suggesting for redox indicators given conditions in bioreactor 102 and contextual information. Reference learning model 131 was then run alongside deep learning model 300 to corroborate the choice of redox indicators for optimal feature vector 132′. The distributed learning yielded optimal feature vector 132′ after a number of iterations (potentially in corroboration with other instances of the bioprocess of interest being run at other locations under correspondent local conditions). It is this optimal feature vector 132′ that local learner 118 requests to be measured by local sensor system 120.

Optimal feature vector 132′ contains a number n of redox indicators in all four redox principles. The optimal redox indicators are thus contained in the first four redox categories 112A, 112B, 112C and 112D (see, e.g., FIG. 2A and the corresponding teachings). However, because of local inability to distinguish between redox principles, optimal feature vector 132′ is a joint optimal feature vector 132X′. In vector 132X′ all redox categories have been collapsed or combined into a single vector. The number n of entries of optimal feature vector 132X′ are expressed in joint basis 116 as {x₁, x₂, . . . , xₙ} according to the notation convention introduced above. Following the same convention, measured optimal feature vector 132X″ expressed in basis 116 is {\hat{x}₁, \hat{x}₂, . . . , \hat{x}ₙ}.

Local learner 118 requests that sensor system 120 use appropriate measuring devices 122 to collect from bioreactor 120 redox indicators in optimal feature vector 132X′. Correspondingly, sensor system 120 deploys specific measurement devices 122A-Z to collect a time series of optimal measured feature vectors 132XS″ with the desired redox indicators. Only one optimal measured feature vector 132X″ of the series is shown in the diagram of FIG. 4A for reasons of clarity.

Local conditions inside bioreactor 102 can be adjusted with the aid of actuator system 126. Actuator system 126 has at its disposal a number of specific actuators 128 to act on local control parameters in bioreactor 102. In the present embodiment, the adjustments to local control parameters are issued in conjunction with the learning achieved by distributed learning algorithm 130. Since algorithm 130 is distributed, adjustments can be computed and issued from master learner 114 or local learner 118.

When the communication link between learners 114, 118 has a large bandwidth and is reliable, it is advantageous to provide primary feedback loop 154 with a primary feedback mechanism 400. In FIG. 4A primary feedback mechanism 400 is shown to compute an adjustment vector 402 expressed here by u (bold face denotes a vector quantity). Primary feedback mechanism 400 uses its knowledge of the bioprocess of interest and of optimal feature vector 132′, also expressed here as vector x.

Adjustment vector u is arrived by applying matrix K to optimal feature vector x (and/or measured optimal feature vector \hat{x}). Derivation of the K matrix is a standard problem in control theory. In the present case, the computation of K should reflect local conditions in bioreactor 102, context and local constraints and measurement capabilities, including the various sources of measurement noise. Persons skilled in the art of control theory and feedback will recognize various approaches for computing the most effective K matrix.

Primary feedback mechanism 400 is configured to issue a local conditions adjustment 404 that will include any general operating instructions (e.g., to the operator of bioreactor 102) as well as specific adjustments. The specific adjustments correspond to entries in adjustment vector 402. They are part of file of local conditions adjustment 404 sent to actuator system 126. In the present case, a number r of control parameters u₁, u₂, . . . , uᵣ make up adjustment vector u sent to actuator system 126. Advantageously, control parameters u₁, u₂, . . . , uᵣ can be adjusted by actions that can be performed by specific actuators 128A-Z (or combinations of their actions) deployed by actuator system 126.

Many if not most control parameters u₁, u₂, . . . , uᵣ will be redox indicators or redox influencers. These can be selected from the same group of candidates as those for feature vectors 112A-D. However, the best candidates for this purpose are redox indicators that can be acted upon directly by actuator system 126. In other words, control parameters should correspond to redox indicators that can be affected in known ways by any one actuator 128 or by any combination of specific actuators 128A-Z. Thus, control parameters u₁, u₂, . . . , uᵣ can include a redox active compound or an electron balance influencer, or still other inputs that can act upon the bioprocess transpiring in local bioreactor 102.

FIG. 4B illustrates an implementation of feedback control to provide local conditions adjustment 404 when communications between local and maters learners 118, 114 are not robust. Not robust can mean low bandwidth, noisy and/or subject to frequent or unacceptable interruptions. Under such conditions it is preferable to rely on a secondary feedback loop 410 established between local learner 118 and the biological entity of interest. In this example, the biological entity of interest is again biomass 101 in bioreactor 102, as also shown in FIG. 4A. It is noted, that biological entities of interest can be organisms including live subjects 201.

Secondary feedback loop 410 is set up between local learner 118 and local resources that run sensor system 120 and actuator system 126. Thus, feedback loop 410 channels the local connections that were previously sent to local learner 118 (see FIG. 4A). These connections include the ones for transmitting optimal feature vector 132X′ and measured optimal feature vector 132X″ to and from sensor system 120.

Secondary feedback loop 410 has a local feedback mechanism 412. In operational respects, local feedback mechanism 412 performs the work of primary feedback mechanism 400 (see FIG. 4A). Thus, local feedback mechanism 400 determines the K matrix and also adjustment vector 402 also represented by u. Local feedback mechanism 400 also issues local conditions adjustment 404 that will include any general operating instructions (e.g., to the operator of bioreactor 102) as well as specific adjustments. As before, specific adjustments correspond to entries in adjustment vector 402. They are part of file of local conditions adjustment 404 sent to actuator system 126.

In the embodiments of FIGS. 4A-B and in general, local conditions adjustment can involve an alteration in the optimal composition of measured redox data, redox candidate data, contextual data and any additional data related to the subject. In other words, the adjustments can extend beyond those that can be expressed in adjustment vector 402 and applied directly. Of those that can be acted on by actuator system 126 with its specific actuators 128, the most commonly are parameters affecting: off-gas, air, O₂, CO₂, pressure, viscosity, stirrer speed, temperature, pO₂, pH, photometrics, calorespirometric measures and other biomeasureables. Of course, there may be cases in which control of the local bioprocess is impossible or impractical. This could occur in rapidly transpiring reactions or reactions that go to completion without allowing for meaningful intervention. No local feedback mechanism may be present in such embodiments.

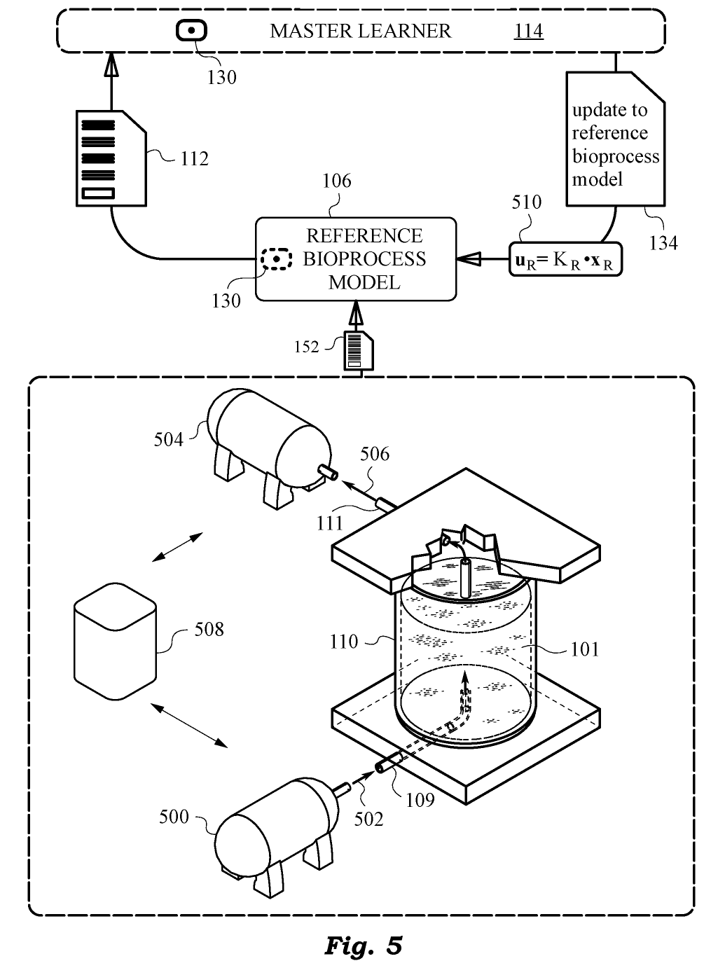

FIG. 5 is a diagram illustrating a reference bioprocess performed in a reference bioreactor with adjustments to reference control parameters. This is done when, as a result of the learning performed by learning system 100, it becomes necessary to change the operation of the reference biological entity undergoing the bioprocess on which the model is based. As an example, we take reference bioprocess model 106 derived from model redox data 152 collected from reference bioreactor 110 (see FIG. 1A).

Reference bioprocess is transpiring in biomass 101 within reference bioreactor 110. An input 109 to reference bioreactor 110 is provided for adjusting or altering reference bioprocess occurring inside it. Input 109 is to be understood generally as any mechanism, actuator, inlet or other type of mechanical or non-mechanical apparatus capable of acting on the bioprocess. Actuator systems or mechanisms 500 interface with input 109. Mechanisms 500 are capable of making input adjustments 502 to the conditions in reference bioreactor 110 as a result of learning that occurs during construction of reference bioprocess model 106.

Likewise, an output 111 is provided for drawing outputs or samples from the bioprocess unfolding within biomass 101 inside reference bioreactor 110. Sensing or measuring apparatus 504 interface with output 111. Measuring apparatus 504 is to be understood generally as any apparatus or device capable of drawing, collecting, inferring, sensing and measuring outputs 506 of the bioprocess. Measuring apparatus 504 can use outputs 506 in any direct in-line measures such as: off-gas, air, O₂, CO₂, pressure, viscosity, stirrer speed, temperature, pO₂, pH, photometrics, calorespirometric measures and other biomeasureables. Measuring apparatus 504 can also obtain indirect in-line measures by techniques such as: near-infrared spectroscopy, dielectric spectroscopy, fluorescence spectroscopy, Fourier-transform infrared spectroscopy, Raman spectroscopy. The sampling methods and measures that can be used include: high performance liquid chromatography, enzyme-linked immunosorbent assay, gas chromatography, electrophoresis microscopy, mass spectroscopy, proton transfer reaction MS, MALDI-TOF MS, nuclear magnetic resonance, flow injection analysis. In addition, measuring apparatus 504 can apply data or model-driven analysis to derive measures such as: levels or quantities of active biomass 101, glucose, lactate, amino acids, enzymes, antibodies, organic acids, vitamins, recombinant proteins, volatile organic compounds.

Actuator mechanisms 500 and measuring apparatus 504 are connected to a central reference coordinator unit 508. Unit 508 coordinates the regular operation of reference bioprocess and production of model redox data 152. In addition, reference coordinator unit 508 receives updates 134 sent from master learner 114 to reference bioprocess model 106 that is based on model redox data 152. In fact, central reference coordinator unit 508 can be in charge of running reference bioprocess model 106 on its own resources in some embodiments. In such embodiments, the inputs or outputs of reference bioprocess model 106 discussed above, will refer to inputs and outputs of the computer or computer system(s) of unit 508. Clearly, a module of distributed learning algorithm 130 will then run on unit 508 as well.

In order for unit 508 to implement the learning that algorithm 130 derived from the one or more local reactors 102 (see FIG. 1A) that perform the same bioprocess a reference feedback mechanism 510 is provided between master learner 114 and reference bioprocess model 106. In the event model 106 is running on unit 508, reference feedback mechanisms 510 is established between master learner 114 and unit 508. The fact that mechanism 510 refers to the reference bioprocess and its model is expressed by the subscripts “R” on the vectors and the matrix.

Given that mechanism 510 executes directly on reference biological entity, here biomass 101, the feedback is actually provided between master learner 114 and the reference biological entity. For the purposes of applying the feedback, unit 508 can simply use all of the already available affordances. Specifically, unit 508 uses actuator mechanisms 500 for making input adjustments 502.

In embodiments where there is no physical reference biological entity that provides model redox data 152, i.e., there is neither a reference bioreactor 110 or a reference biological entity or live organism including such as a human subject then it may become necessary to simply tune or adjust reference bioprocess model 106 on curated data 108 alone (see FIGS. 1A-B).

In some embodiments, the bioprocess will occur without supervision, while in other cases the bioprocess can be a tightly supervised process. In any case, the bioprocess in the local biological entity will typically occur under much less controlled conditions than those of the reference biological entity that was used in the reference bioprocess model.

In some embodiments, the elements of the learning system are directly coupled to each other as part of an integrated system. In other embodiments, the system elements may be in separate physical systems and coupled by one or more application program interfaces. In still other embodiments, the measurement systems are indirectly connected to the learning system by exporting data in formats that can be imported or scanned into the database accessed by the local or master learner. In still other embodiments, the system is directly connected to a control mechanism, while in other embodiments the control may be a recommendation to another system or operator, or may not be present at all. Also, there are embodiments in which the control mechanism provides an instruction to a third party system for formulation of a nutritional, supplement, vitamin, medication or combination.

The chemical reaction networks that underlie cellular processes are complex systems built upon non-deterministic and ultimately even quantum mechanical interactions that have an inherent level of random fluctuation or noise. This creates a level of unpredictable variation that may limit the contexts in which any deterministic or classical learning model may apply. This inherent noise indeed may be the basis for the evolution and diversity of life in the first place. While it is tempting to think that if all the parameters of a biological system were known, measurable, and tunable, that one could perfectly control health and disease in biological systems, this is unlikely. Consequently, this invention provides an alternative approach that assumes imperfect measurement, hidden states, and inherent limits to observability and controllability of the state of any biological entity under consideration. Despite these inherent limits, biological entities and larger biological systems strive for homeostasis, or stability. In such a stable state of “health” where the reduction and oxidation systems of energy production are in balance without causing damage over sustained periods of time. Living systems also can slip into states of “disease” when the reduction system begins to fail and the oxidation systems of energy production cumulate damage. Such accumulation increases the chance that the entire biological entity or system eventually enters a cascading failure resulting in death.

In other words, a healthy state of a biological entity or system is one in which it and its internal regulatory system can balance the disturbances and pressures of the internal and external environment. This healthy state is not a singular point within the space of possibilities but rather an attraction basin in which the system as a whole is stable despite the inherent random fluctuation or noise in a large number of component parts. A complex biological entity or system can be maintained over time in such a quasi-potential basin despite the inherent noise in its component parts and within a variety of environmental contexts and disturbances. This is largely because of its internal regulatory processes that continuously tune a large number of parameters. Such a complex system is stable when the quasi-potential basin is deep and the walls are high in comparison with the inherent noise. Under these conditions the system can continuously make small adjustments that keep moving the state toward the basin. A working reduction system that counteracts the damaging effects of oxidation in a metabolic process despite a wide range of environmental variation and stress is a regulatory process aiming to keep the biological entity or system in a stable state.

As life evolved over 4 billion years, nature's internal regulatory systems have been highly adapted after generations of natural selection to take advantage of any optimizations or efficiencies afforded by physics and chemistry. This includes the ability of quantum systems to take advantage of non-classical features such as coherence and quantum correlations (e.g., entanglement) to optimize processes and store information. As such, the evolved biological system has available to it a much larger set of tunable parameters within a broader set of paradigms than those designed for modern medicine and other life sciences. The regulatory approaches proposed by modern biotechnology are primarily attempts to fix or tune single inputs or very simple sets of tunable inputs to a classically described biological entity or system. These approaches have been successful in some contexts where a single or a very small set of tunable parameters can restore a balance or compensate for an imbalance in the biological entity or system.

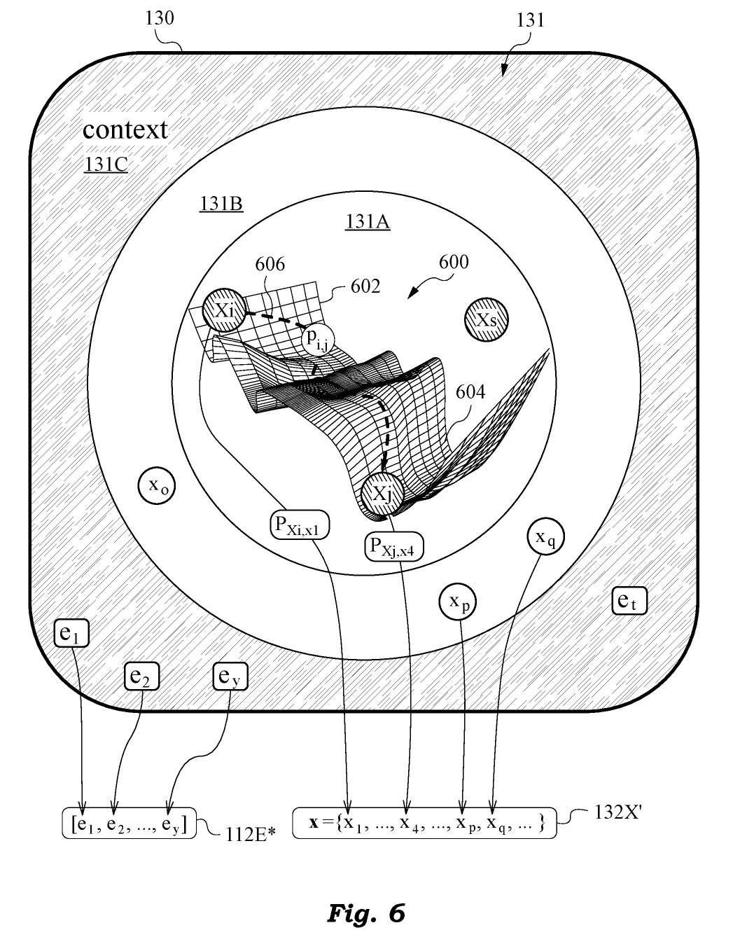

We turn to the diagram of FIG. 6 in light of the above to examine one of the reasons for explicit introduction of hidden states. Only three hidden states Xᵢ, Xⱼ and Xₛ (where capital letters designate hidden states) for reasons of clarity. In the example of FIG. 6 distributed learning algorithm 130 and preliminary learning model 131 are given an abstract representation different than a graph structure (e.g., FIG. 2E).

In FIG. 6 preliminary learning model 131 is broken up into three domains. At the very center is a hidden domain 131A delimited by the inner circle and containing hidden states Xᵢ, Xⱼ and Xₛ. Hidden domain 131A uses a representational space 600 within which is embedded a multi-well quasi-potential 602. Effectively, quasi-potential 602 is a landscape (sometimes also referred to as fitness landscape by those skilled in the art) that states Xᵢ, Xⱼ can be considered to inhabit. When using other classical models, representational space 600 may introduce a phase space spanned by certain conjugate variables or still another useful abstraction known in the art. When using quantum models, representational space 600 may introduce Hilbert space or even Fock space.

The topology of quasi-potential 602 dictates possible evolution between states (transitions or dynamics). It also graphically shows where meta-stable and stable states (wells) are to be found. In the present example, a transition between hidden state Xᵢ and hidden state Xⱼ may occur with a transition probability p_{i,j} (recall that lower case denotes transition probabilities between hidden states, as before).

Clearly, given exemplary landscape 602, hidden state Xⱼ is quite stable. That is because it is in a deep potential well 604 with high potential barriers or walls. Hidden state Xᵢ is only meta-stable because it is not in a deep well.

Perturbations, inherent noise or even intended actions (e.g., introduced by actuator system 126) may aid the transition from hidden state Xᵢ to hidden state Xⱼ. The response to the unintended or intended action is indicated by dashed arrow 606. Arrow 606 illustrates the path in abstract representational space 600 along which the state transition Xᵢ to Xⱼ takes place.

Of course, appropriate actions can also change landscape 602 itself. As will be appreciated by those skilled in the art, such modifications to quasi-potential 602 should be accounted for by an adjustment or tuning of transition probabilities in transition matrix p (see Eq. 3). In the present case, it is especially important to adjust transition probability p_{i,j}.

A second non-hidden and measurable domain 131B of learning model 131 resides between inner hidden domain 131A and a third conditional or context domain 131C. Measurable domain 131B contains states indicated by lower case letters. In the present case, three such measurable states are shown, namely xₒ, xₚ and x_{q}. These states correspond to quantities that are directly measurable both in the lab and under local conditions (in the field). They are typically not associated with hidden aspects or transition probabilities that need to be tracked. Hence, they are not placed in a representational space. Other than being subject to well-known measurement errors, noise etc., states xₒ, xₚ and x_{q} inhabiting measurable domain 131B are directly measurable. Thus, there is no measurement probability associated with them. This is unlike hidden states Xᵢ, Xⱼ and Xₛ inhabiting hidden domain 131A. These, even during measurement, still exhibit a probabilistic aspect that translates into their associated measurement probabilities P_{Xi,x1}, P_{Xj,x4}, P_{Xs,xz} (see FIG. 2E and related description).

Redox indicators or features that correspond to states in either hidden or measurable domains 131A, 131B may belong to redox indicators in any one of the first four redox categories 112A-D. In fact, the careful reader will have noticed that by adopting the joint feature variable names X and x, we have collapsed the first four redox categories 112A-D into one joint category 112X and are using the joint feature vector representation.

Conditional or context domain 131C contains all other conditional redox data in the fifth redox category 112E. Of course, this data can contain candidates for either hidden or measureable states X and x to be placed into hidden or measureable domains 131A, 131B of preliminary learning model 131. In addition, it contains purely contextual data, e.g., the weather. In the present example four specific data entries e₁, e₂, eₜ and e_{y} are shown.

As shown in FIG. 6, preliminary learning model 131 already contains a preliminary contingency list 112E* and preliminary joint feature vector 112X′. These may be selected in reference bioprocess model 106 given the biological entity under study, the bioprocess of interest and the local conditions. Alternatively, this may already be a tuned learning model 131 prepared by distributed learning algorithm 130 after a few iterations of learning between master learner 114 and local learner 118.

In fact, as shown, hidden states Xᵢ, Xⱼ as well as measurable states xₚ, x_{q} corresponding to directly accessible redox indicators are selected from preliminary joint feature vector 112X′ for optimal joint feature vector 132X′. Hidden state Xₛ and measurable state xₒ are not included in optimal joint feature vector 132X′. Also, states or data entries e₁, e₂, and e_{y} are selected for contingency list 112E*. State or data entry eₜ is not chosen. These choices are made given the local conditions and, possibly, preliminary knowledge of context under location conditions.

We can now see some of the reasons for the explicit introduction of hidden states and transitions between them into learning system 100 and the initial or preliminary learning model 131. Postulating hidden states, some of which are inaccessible in principle, provides us with an inherent ability to deal with unknown features. Specifically, the present invention can ascribe to them states and transitions that are hidden and not part of the observable basis of redox indicators 116. Thus, the invention teaches a way to expand the subset of parameters available to model the status of a hidden compartment. This also permits to introduce additional opportunities for tuning parameters or providing related control inputs, e.g., in the form of adjustment vectors. Using further control theory approaches, the inputs or adjustment vectors may aim to maintain or restore balance in the biological entity under the local conditions and within the context. The hidden states approach also sets up a framework in which non-classical features can be explored. Specifically, hidden states may be placed into a classical or even a non-classical state in representation space 600, such as a phase space or Hilbert space.

In terms of measureable redox indicators, in either structured or unstructured form (e.g., feature vectors 112A-D, joint feature vector 112X, or contingency list 112E*) they should include concentrations of compounds from a network of orphan enzymes and small molecules capable of encoding electrons to transfer information rapidly between proteins. This system is comprised of unique enzymes called oxidoreductases, already mentioned above, and unique small molecule redox signaling molecules. The dimensions of this network in biology may be 2,000 enzymes, including 584 human oxidoreductase enzymes, and over 10,000 redox small molecules. The preliminary learning model may initially focus on the subset of this matrix that is common to all biological systems and regulates energy generation. More specifically, the measured redox data includes Flavin-containing oxidoreductase quinones (believed to be critical and common to metabolic control and members of the network with biological functions and importance which has not yet been established).

There are a variety of measurements that could comprise an observable basis of redox indicators 116 for determining the redox status of the bioprocess or other hidden states of the biological entity. There are also variety of tunable inputs with the potential to balance or control the biological entity or complex living system. To account for these in reference bioprocess model 106 a measurement system such as a high-resolution mass spectrometer can be used in a controlled laboratory environment. There, specific enzymes and cofactors from the above-mentioned matrix of possibilities can be upregulated, downregulated or inhibited in a range of cell cultures from a reference biological entity or reference subject 150. These actions can be performed under a range of environmental disturbances or insults, with and without providing reference entity 150 any of a range of rescue compounds, and observed over a range of time slices. Examples of such cell cultures that may be used in the bioprocess reference model 106 can be found in Table 2A. Examples of stressors or insults that can be used in the bioprocess reference model can be found in Table 2B. The measurement time slices to observe the network of reactions following a disturbance or insult in the laboratory can have a frequency of at least once every hour, at least once every 30 minutes, at least once every 10 minutes, at least once every 5 minutes, at least once every minute, at least once every 30 seconds, at least once every 10 seconds, at least once every 5 seconds, at least once every second, at least twice every second, at least 5 times every second, at least 10 times every second, at least 20 times every second, at least 50 times every second, at least 100 times every second, or more.

TABLE 2A

| Cell Line | Description |
|---|---|
| SH-SY5Y | Human neuroblastoma |
| Hep G2 | Human Caucasian hepatocyte carcinoma |
| 293 (also known as | Human Embryo Kidney |
| HEK 293) | |
| RAW 264.7 | Mouse monocyte macrophage |
| HeLa | Human cervix epitheloid carcinoma |
| MRC-5 (PD 19) | Human foetal lung |
| A2780 | Human ovarian carcinoma |
| CACO-2 | Human Caucasian colon adenocarcinoma |
| THP 1 | Human monocytic leukaemia |
| A549 | Human Caucasian lung carcinoma |
| MRC-5 (PD 30) | Human foetal lung |
| MCF7 | Human Caucasian breast adenocarcinoma |
| SNL 76/7 | Mouse SIM strain embryonic fibroblast |
| C2C12 | Mouse C3H muscle myoblast |
| Jurkat E6.1 | Human leukaemic T cell lymphoblast |
| U937 | Human Caucasian histiocytic lymphoma |
| L929 | Mouse C3H/An connective tissue |
| 3T3 L1 | Mouse Embryo |
| HL60 | Human Caucasian promyelocytic leukaemia |
| PC-12 | Rat adrenal phaeochromocytoma |
| HT29 | Human Caucasian colon adenocarcinoma |
| OE33 | Human Caucasian oesophageal carcinoma |
| OE19 | Human Caucasian oesophageal carcinoma |
| NIH 3T3 | Mouse Swiss NIH embryo |
| MDA-MB-231 | Human Caucasian breast adenocarcinoma |
| K562 | Human Caucasian chronic myelogenous leukaemia |
| U-87 MG | Human glioblastoma astrocytoma |
| MRC-5 (PD 25) | Human foetal lung |
| A2780cis | Human ovarian carcinoma |
| B9 | Mouse B cell hybridoma |
| CHO-K1 | Hamster Chinese ovary |
| MDCK | Canine Cocker Spaniel kidney |
| 1321N1 | Human brain astrocytoma |
| A431 | Human squamous carcinoma |
| ATDC5 | Mouse 129 teratocarcinoma AT805 derived |
| RCC4 PLUS VECTOR | Renal cell carcinoma cell line RCC4 stably transfected |
| ALONE | with an empty expression vector, pcDNA3, conferring |
| | neomycin resistance. |
| HUVEC (S200-05n) | Human Pre-screened Umbilical Vein Endothelial Cells |
| | (HUVEC); neonatal |
| Vero | Monkey African Green kidney |
| RCC4 PLUS VHL | Renal cell carcinoma cell line RCC4 stably transfected |
| | with pcDNA3-VHL |
| Fao | Rat hepatoma |
| J774A.1 | Mouse BALB/c monocyte macrophage |
| MC3T3-E1 | Mouse C57BL/6 calvaria |
| J774.2 | Mouse BALB/c monocyte macrophage |
| PNT1A | Human post pubertal prostate normal, immortalised with |
| | SV40 |
| U-2 OS | Human Osteosarcoma |
| HCT 116 | Human colon carcinoma |
| MA104 | Monkey African Green kidney |
| BEAS-2B | Human bronchial epithelium, normal |
| NB2-11 | Rat lymphoma |
| BHK 21 (clone 13) | Hamster Syrian kidney |
| NS0 | Mouse myeloma |
| Neuro 2a | Mouse Albino neuroblastoma |
| SP2/0-Ag14 | Mouse × Mouse myeloma, non-producing |
| T47D | Human breast tumour |
| 1301 | Human T-cell leukaemia |
| MDCK-II | Canine Cocker Spaniel Kidney |
| PNT2 | Human prostate normal, immortalised with SV40 |
| PC-3 | Human Caucasian prostate adenocarcinoma |
| TF1 | Human erythroleukaemia |
| COS-7 | Monkey African green kidney, SV40 transformed |
| MDCK | Canine Cocker Spaniel kidney |
| HUVEC (200-05n) | Human Umbilical Vein Endothelial Cells (HUVEC); neonatal |
| NCI-H322 | Human Caucasian bronchioalveolar carcinoma |
| SK.N.SH | Human Caucasian neuroblastoma |
| LNCaP.FGC | Human Caucasian prostate carcinoma |
| OE21 | Human Caucasian oesophageal squamous cell carcinoma |
| PSN1 | Human pancreatic adenocarcinoma |
| ISHIKAWA | Human Asian endometrial adenocarcinoma |
| MFE-280 | Human caucasian endometrial adenocarcinoma |
| MG-63 | Human osteosarcoma |
| RK 13 | Rabbit kidney, BVDV negative |
| EoL-1 cell | Human eosinophilic leukaemia |
| VCaP | Human Prostate Cancer Metastasis |
| tsA201 | Human embryonal kidney, SV40 transformed |
| CHO | Hamster Chinese ovary |
| HT 1080 | Human fibrosarcoma |
| PANC-1 | Human Caucasian pancreas |
| Saos-2 | Human primary osteogenic sarcoma |
| Fibroblast Growth | Fibroblast Growth Medium Kit |
| Medium (116K-500) | |
| ND7/23 | Mouse neuroblastoma × Rat neurone hybrid |
| SK-OV-3 | Human Caucasian ovary adenocarcinoma |
| COV434 | Human ovarian granulosa tumour |
| Hep 3B | Human hepatocyte carcinoma |
| Vero (WHO) | Monkey African Green kidney |
| Nthy-ori 3-1 | Human thyroid follicular epithelial |
| U373 MG (Uppsala) | Human glioblastoma astrocytoma |
| A375 | Human malignant melanoma |
| AGS | Human Caucasian gastric adenocarcinoma |
| CAKI 2 | Human Caucasian kidney carcinoma |
| COLO 205 | Human Caucasian colon adenocarcinoma |
| COR-L23 | Human Caucasian lung large cell carcinoma |
| IMR 32 | Human Caucasian neuroblastoma |
| QT 35 | Quail Japanese fibrosarcoma |
| WI 38 | Human Caucasian foetal lung |
| HMVII | Human vaginal maligant melanoma |
| HT55 | Human colon carcinoma |
| TK6 | Human lymphoblast, thymidine kinase heterozygote |
| SP2/0-AG14 (AC- | Mouse × mouse hybridoma non-secreting, serum-free, |
| FREE) | animal component (AC) free |
| AR42J RAT | Rat exocrine pancreatic tumour |
| PANCREATIC TUMOUR | |

TABLE 2B

| Stressor | Type |
|---|---|
| Concussive force | Environmental |
| Electric shock | Environmental |
| Freezing | Environmental |
| Heat | Environmental |
| High-glucose | Environmental |
| Low-glucose | Environmental |
| Microwave radiation | Environmental |
| Particle radiation | Environmental |
| Ultrasound | Environmental |
| Ultraviolet Light | Environmental |
| X-Ray radition | Environmental |
| Arsenic (As) | Heavy/Transition |
| | metals |
| Cadmium (Cd) | Heavy/Transition |
| | metals |
| Chromium (Cr) | Heavy/Transition |
| | metals |
| Cobalt (Co) | Heavy/Transition |
| | metals |
| Copper (Cu) | Heavy/Transition |
| | metals |
| Iron (Fe) | Heavy/Transition |
| | metals |
| Lead (Pb) | Heavy/Transition |
| | metals |
| Mercury (Hg) | Heavy/Transition |
| | metals |
| Nickel (Ni) | Heavy/Transition |
| | metals |
| Acetic Acid | Industrial Solvent |
| Acetone | Industrial Solvent |
| Acrylonitrile | Industrial Solvent |
| Adipic Acid | Industrial Solvent |
| Aluminum Sulfate | Industrial Solvent |
| Ammonia | Industrial Solvent |
| Ammonium Nitrate | Industrial Solvent |
| Benzene | Industrial Solvent |
| Bisphenol-A | Industrial Solvent |
| Butadiene | Industrial Solvent |
| Butyraldehyde | Industrial Solvent |
| Carbon Black | Industrial Solvent |
| Chlorine | Industrial Solvent |
| Cumene | Industrial Solvent |
| Cyclohexane | Industrial Solvent |
| Ethylbenzene | Industrial Solvent |
| Ethylene | Industrial Solvent |
| Ethylene Dichloride | Industrial Solvent |
| Ethylene Gylcol | Industrial Solvent |
| Ethylene Oxide | Industrial Solvent |
| Formaldehyde | Industrial Solvent |
| Hydrochloric Acid | Industrial Solvent |
| Isobutylene | Industrial Solvent |
| Methanol | Industrial Solvent |
| Methyl tert-butyl ether | Industrial Solvent |
| Nitric Acid | Industrial Solvent |
| Nitrobenzene | Industrial Solvent |
| Nitrogen | Industrial Solvent |
| Oxygen | Industrial Solvent |
| Phenol | Industrial Solvent |
| Phosphoric Acid | Industrial Solvent |
| Potash | Industrial Solvent |
| Propylene | Industrial Solvent |
| Propylene Oxide | Industrial Solvent |
| Sodium Carbonate | Industrial Solvent |
| Sodium Hydroxide | Industrial Solvent |
| Sodium Silicate | Industrial Solvent |
| Styrene | Industrial Solvent |
| Sulfuric Acid | Industrial Solvent |
| Terephthalic Acid | Industrial Solvent |
| Titanium Dioxide | Industrial Solvent |
| Toluene | Industrial Solvent |
| Urea | Industrial Solvent |
| Vinyl Acetate | Industrial Solvent |
| Vinyl Chloride | Industrial Solvent |
| Xylene | Industrial Solvent |
| Bleomycin | Medication |
| Carbon tetrachloride (CC14) | Medication |
| Doxorubicin | Medication |
| Halothane | Medication |
| Metronidazole | Medication |
| Paracetamol | Medication |
| Antimycin A from Streptomyces sp. | Mitochondrial |
| | inhibitor |
| BMS-199264 hydrochloride ≥98% (HPLC) | Mitochondrial |
| | inhibitor |
| BTB06584 ≥98% (HPLC) | Mitochondrial |
| | inhibitor |
| Carbonyl cyanide 3-chlorophenylhydrazone | Mitochondrial |
| ≥97% (TLC), powder | inhibitor |
| Carbonyl cyanide 4- | Mitochondrial |
| (trifluoromethoxy)phenylhydrazone ≥98% | inhibitor |
| (TLC), powder | |
| Lonidamine mitochondrial hexokinase inhibitor | Mitochondrial |
| | inhibitor |
| m-Iodobenzylguanidine hemisulfate salt ≥98% | Mitochondrial |
| (HPLC and TLC) | inhibitor |
| ML-3H2 | Mitochondrial |
| | inhibitor |
| Oligomycin from Streptomyces diastatochromogenes | Mitochondrial |
| ≥95% total oligomycins basis (HPLC) | inhibitor |
| Pyrrolnitrin from Pseudomonas cepacia ≥98% | Mitochondrial |
| (HPLC), solid | inhibitor |
| Rotenone ≥95% | Mitochondrial |
| | inhibitor |
| TT01001 ≥98% (HPLC) | Mitochondrial |
| | inhibitor |
| α-Cyano-4-hydroxycinnamic acid ≥98% | Mitochondrial |
| (TLC), powder | inhibitor |
| Arsenite | Other Chemical |
| Ethanol | Other Chemical |
| Methyl methanesulfonate | Other Chemical |
| Hydrogen peroxide | Oxidant |
| Hydroperoxyl radical | Oxidant |
| Hydroxyl radical | Oxidant |
| Hypochlorous acid | Oxidant |
| Peroxynitrite | Oxidant |
| Superoxide anion | Oxidant |
| Atrazine | Pesticide |
| Chlorpyrifos | Pesticide |
| Glyphosate | Pesticide |
| Metam sodium | Pesticide |
| Metolachlor | Pesticide |
| Neonicotinoids | Pesticide |
| Paraquat | Pesticide |
| Telone | Pesticide |
| Carbon Dioxide | Pollutant |
| Carbon Monoxide | Pollutant |
| Methane | Pollutant |
| Nitrogen Oxides | Pollutant |
| Ozone | Pollutant |
| Sulfur Dioxide | Pollutant |

The below examples indicate useful extensions and applications of many aspects of the present invention. Although they do not refer to any drawing figure(s) in particular, reference numbers to analogous elements that have previously been introduced in FIGS. 1-6 and described above will be used to aid in the explanations, whenever appropriate.

### Standardized Lab Test Systems

Learning system 100 and method can be applied to standardizing lab test systems for reference bioprocess model 106 when working with biological entities represented by cells or cell lines. Cell lines can be chosen for their ability to model specific conditions or diseases. They can then be subjected to a plurality of stressors that represent a variety of environmental conditions that correspond to various possible local conditions and/or contexts of interest. This matrix of scenarios can be explored in the laboratory by repeated stress and unstressed measurement at standardized intervals to build a more consistent database of time sequences 200 of redox data 112 to be made available to master learner 114. By standardizing the process in this way, a broader range of molecular masses can be measured in a less targeted manner in order to explore the matrix of oxidoreductases and co-factors for features with biological function that may be associated with the system, local conditions, context of interest, and candidate redox indicators that may form the observable basis for a redox status.

### Sensor Fusion Applications

Learning system 100 and method can be applied to the design of field measurement devices 122 by selecting a set of measurements that form an observable basis 116 for a redox status of a bioprocess of interest. One may then combine those measurements into field sensors or sensor fusion systems. Such sensor systems may be initialized with the weights trained by master or local learner 114, 118 and further trained in local contexts according to the method as a soft-sensor model for a sensor fusion device or a combination of stand-alone sensor devices or probes.

### Biological Aging Status Soft Sensor

Defects in the redox system fundamental to metabolism can be a persistent cause of oxidative stress to biological entities. Over time, the stress results in degrading many biological systems in different ways and is inherently related to biological aging status. While there are measures of systemic oxidative stress and chronic inflammation that are associated with aging and chronic disease, these measures look at downstream consequences and stable by products of oxidative stress. It would be advantageous to look instead for any underlying cause(s). One of these may be due to defects causing an imbalance in one or more parts of the redox system in the biological entity of interest.

For example, when misdirected electrons from the redox system form reactive oxygen species. If not reduced by antioxidant such as glutathione, these reactive oxygen species may end up oxidizing proteins, lipids, nucleic acids, and other compounds important to the biological entity and resulting in damage to its system. Oxidized protein products such as amyloid are associated with degenerative diseases such as Alzheimer's. Electrons that oxidize lipids can damage cell membranes and form isoprostanes, MDA and other toxic and carcinogenic compounds. Electrons that oxidize nucleic acids can damage DNA and cause changes to gene expression. Electrons that oxidize small molecules interfere with a wide range of biological processes. Oxidative stress is associated with failure in just about every organ system and disease, particularly chronic diseases and diseases of aging, including but not limited to the heart (CHD, cardiac fibrosis, hypertension, ischemia, myocardial infarction), skin (skin aging, sunburn, psoriasis, dermatitis, melanoma), kidney (chronic kidney disease, renal graft, nephritis), joint (rheumatoid arthritis, osteoarthritis, psoriatic arthritis), lung (asthma, COPD, allergies, ARDS, cancer), brain (Alzheimer's disease, Parkinson's disease, OCD, ADHD, autism, migraine, stroke, trauma, cancer), Immune System (chronic inflammations, autoimmune disorders, lupus, IBD, MS, cancer), blood vessels (restenosis, atherosclerosis, endothelial dysfunction, hypertension), Multi-Organ (diabetes, aging, chronic fatigue), eyes (macular degeneration, retinal degeneration, cataracts).

The use of chronological age as an anchor measure and using learning system 100 and method as described herein with biological samples, redox data and annotations from test subjects at a range of different ages can be advantageous. The data should include healthy subjects and subjects with specific diseases and conditions as listed above, and in combination with other measures that are the downstream consequences and byproducts of oxidative stress, such as chronic inflammation and systemic oxidative stress markers. Using data thus collected, master learner 114 may identify a subset of redox data and its indicators to form an observable basis 116 for chronological age in healthy subjects. To the extent that such a model can be trained by distributed learning algorithm 130 to predict age in healthy subjects, a difference between predicted age and chronological age may be calibrated to represent a “biological age” or “viability” metric in unhealthy or super-healthy subjects. This learning process can be repeated for unhealthy subjects with known diseases and conditions with epidemiologically projected impact on lifespan used as an offset to chronological age in order to calibrate such differences. For subsets of observable measures that also can be collected in the field and also can predict age, a soft-sensor or sensor fusion approach can be provided. In some cases, where field measurement does not yet exist or has not been sufficiently trained for a given context, a biological sample can be collected in the field and sent to the lab for high resolution testing. An initial intake of contextual data determines whether or not a field measurement exists and routes or recommends the sample to a lab that can measure features that quality for observable basis 116.

The system and method can be applied to searching for models that are patterns of measures that regress to an anchor measure of interest, including chronic inflammation and oxidative stress associated with age-related chronic diseases and biological aging in general. To the extent that an observable basis 116 can be identified and trained by distributed learning algorithm 130 to predict the anchor measure, the model becomes a “soft sensor” for that anchor measure. The system and method are first applied using master learner 114 to identify an observable basis 116 for the anchor measure. For example, the anchor measure may be for chronic inflammation and oxidative stress associated with a chronic disease or aging. Local learner 118 is then deployed to determine contexts in which a field-observable subset predicts the same anchor measure. The initial weights are determined by distributed learning algorithm 130 that in this embodiment combines known inflammation and oxidative-stress-related data and redox indicator candidate data into a vector of features for each subject in order to attempt to find weights that regress to the anchor measure.

In the example of an aging model, chronological age of a healthy subject can be used as the anchor measure. Data collected for healthy subjects at a range of ages using full data sets and samples is analyzed in a controlled laboratory environment. This analysis should cover a wide range of known inflammation and oxidative stress markers, sulfur-related redox couples such as ratio of reduced to oxidized glutathione, and a survey of clinical, environmental and behavioral factors believed to have an association with oxidative stress and inflammation such as diet, exercise, sleep, stress, disease diagnoses, injury, medications, environment, and subject history.

Based on this weighting, the aging model would be configured to predict chronological age in healthy subjects by using the weighted model of principal components that regress to natural chronological age in healthy subjects. The initial model would be restricted to the narrow context of the specific healthy test subjects recruited, and could be generalized to the extent that more healthy test subjects are added from broader contexts. For example, in addition to physical health as determined by medical records and recent blood panels, specific contexts include age ranges, gender, ethnic and demographic factors, environmental factors, living conditions, living situation and family, known stressors, psychosocial factors, behavioral factors, cognitive factors, employment, education, family history, DNA and other factors. Any factors known in the literature to be associated with inflammation, oxidative stress, chronic disease, cancer, morbidity or mortality may be exclusions so that the initial model training is on a healthy cohort with no known risk factors.

With unhealthy subjects, to the extent that the same model predicts a deviation from chronological age, this deviation can be used as a metric of “biological age”, “viability” or a combined inflammation and aging status depending on the anchor measures used and success in regressing to that anchor measure within a context. To calibrate this model, well known and well-studied risk factors of inflammation, oxidative stress and aging can be added as cohorts. For example, cohorts of subjects with specific diseases known to have specific links to aging such as diabetes, obesity, hypertension, or specific risk factors such as smoking, sedentary lifestyles, or unhealthy diets may be added. In the other direction, cohorts of subjects who are performance athletes, marathon runners, or other higher than norm performance individuals can be recruited to calibrate for biological age that is younger than chronological age.

Additional metrics such as the HeartAge test from the Centers for Disease Control based on the Framingham Heart Study can be used to calibrate the subject in each cohort. As an example, the Framingham Study Heart Age Calculator from the National Heart Lung and Blood Institute uses gender, chronological age, systolic blood pressure, hypertension treatment, smoking status, diabetes status, and body mass index to predict heart age for people between ages of 30 and 74 who have no history of cardiovascular disease (heart attack, stroke, peripheral artery disease, or heart failure). It is based on the observations that began with 5,209 subjects from Framingham Mass. in 1948 and is now in its third generation of participants.

Measured redox data may contain data associated with the downstream consequences or byproducts of a prolonged imbalance or defect in the redox system. For example, biomarkers of chronic inflammation and systemic oxidative stress, or data related to diseases and conditions that may have a relationship to oxidative stress or inflammation, can be important redox data in many contexts. Many of these biomarkers already have established measurement protocols and some have home or field tests. Examples of systemic oxidative stress measures that can be used with the invention include but are not limited to those found in Table 3A. Examples of chronic inflammation measures that can be used with the invention include but are not limited to those found in Table 3B.

TABLE 3A

| Marker and Type of Damage | Cells | Tissues | Blood | Urine | Other |
|---|---|---|---|---|---|
| DNA/RNA Damage | | | | | |
| 8-hydroxyguanosine (8-OHG) | X | X | X | X | Spinal |
| 8-hydroxydeoxyguanosine (8-OHdG) | X | X | X | X | |
| Abasic (AP) sites | X | X | | | |
| BPDE DNA Adduct | X | X | | | |
| Double-strand DNA breaks | X | | | | |
| Comet Assay (general DNA damage) | X | | | | |
| UV DNA Damage (CPD, 6-4PP) | X | | | | |
| Lipid Peroxidation | | | | | |
| 4-Hydroxynonenal (4-HNE) | X | X | X | | |
| 8-iso-Prostaglandin F2alpha (8-isoprostane) | X | X | X | X | |
| Malondialdehyde (MDA) | X | X | X | X | |
| TBARS | X | X | X | X | |
| Protein Oxidation/Nitration | | | | | |
| Protein Carbonyl Content (PCC) | X | X | X | | |
| 3-Nitrotyrosine | X | X | X | | |
| Advanced Glycation End Products (AGE) | X | X | X | | |
| Advanced Oxidation Protein Products (AOPP) | X | X | X | | |
| BPDE Protein Adduct | X | X | X | | |
| Reactive Oxygen Species | | | | | |
| Universal ROS/RNS | X | X | X | X | |
| Hydrogen Peroxide | X | X | X | X | |
| Nitric Oxide | X | X | X | X | |
| Antioxidants | | | | | |
| Catalase | X | X | X | | |
| Glutathione | X | X | X | X | |
| Superoxide Dismutase | X | X | X | | |
| Oxygen Radical Antioxidant Capacity (ORAC) | X | X | X | X | Food |
| Hydroxyl Radical Antioxidant Capacity | X | X | X | X | Food |
| (HORAC) | | | | | |
| Total Antioxidant Capacity (TAC) | X | X | X | X | Food |
| Cell-Based Exogenous Antioxidant Assay | | | | | Food |

TABLE 3B

| Measure | Other Names | Purpose | Sample |
|---|---|---|---|
| Blood Glucose | Blood Sugar; Fasting | To determine if blood glucose | Blood draw, fingerstick, |
| | Blood Sugar; FBS; | level is within a healthy range; | urine sample in some cases, |
| | Fasting Blood Glucose; | to screen for and diagnose | continuous or frequent |
| | FBG; Fasting Plasma | diabetes and prediabetes and to | glucose monitor with |
| | Glucose; FPG; Blood | monitor for high blood glucose | inserted or implanted |
| | Glucose; Oral Glucose | (hyperglycemia) or low blood | sensor some cases. |
| | Tolerance Test; OGTT; | glucose (hypoglycemia); to | |
| | GTT; Urine Glucose | check for glucose in your urine | |
| C-Reactive | CRP | To identify the presence of | Blood draw |
| Protein (CRP) | | inflammation and to monitor | |
| | | response to treatment for an | |
| | | inflammatory disorder | |
| Calprotectin | Fecal Calprotectin; | To detect inflammation in the | Stool sample |
| | Stool Calprotectin | intestines; to distinguish | |
| | | between inflammatory bowel | |
| | | disease (IBD) and non- | |
| | | inflammatory bowel conditions; | |
| | | to monitor IBD activity | |
| Erythrocyte | Sed Rate; | To detect the presence of | Blood draw |
| Sedimentation | Sedimentation Rate; | inflammation caused by one or | |
| Rate (ESR) | Westergren | more conditions such as | |
| | Sedimentation Rate | infections, tumors or | |
| | | autoimmune diseases; to help | |
| | | diagnose and monitor specific | |
| | | conditions such as temporal | |
| | | arteritis, systemic vasculitis, | |
| | | polymyalgia rheumatica, or | |
| | | rheumatoid arthritis | |
| Ferritin | Serum Ferritin | To determine the subject's total | Blood draw |
| | | iron storage capacity | |
| HDL | HDL; HDL-C; High- | Monitoring at regular intervals | Blood draw or from a |
| Cholesterol | density Lipoprotein | as part of a lipid profile when | fingerstick |
| | Cholesterol | risk factors for heart disease are | |
| | | present, when prior results | |
| | | showed high risk levels, and/or | |
| | | when undergoing treatment for | |
| | | unhealthy lipid levels | |
| High-sensitivity | hsCRP; High- | To help assess your risk of | Blood draw |
| C-reactive | sensitivity CRP; Ultra- | developing cardiovascular | |
| Protein | sensitive CRP; Cardiac | disease | |
| | CRP; CRP for heart | | |
| | disease | | |
| Homocysteine | Plasma Total | To help determine folate or | Blood draw, sometimes |
| | Homocysteine; Urine | vitamin B12-deficiency; to | urine sample |
| | Homocysteine; | determine increased risk of | |
| | Homocysteine Cardiac | heart attack or stroke; to help | |
| | Risk | diagnose a rare inherited | |
| | | disorder called homocystinuria | |
| Interleukin-6 | IL-6 | To help evaluate conditions | Blood draw |
| | | such as diabetes and | |
| | | cardiovascular disease or | |
| | | conditions associated with | |
| | | inflammation such as lupus and | |
| | | rheumatoid arthritis or with | |
| | | infection, such as sepsis | |
| Lactoferrin | Fecal Lactoferrin; | To detect inflammation in the | Stool sample |
| | Stool Lactoferrin; | intestines; to help identify | |
| | Fecal WBC Non- | active inflammatory bowel | |
| | microscopic | disease (IBD); to distinguish | |
| | | between IBD and non- | |
| | | inflammatory bowel conditions; | |
| | | to monitor IBD activity | |
| White Blood | WBC Count; Leukocyte | To screen for or diagnose a | Blood draw or by a |
| Cell Count | Count; White Count | variety of conditions that can | fingerstick or heelstick |
| | | affect white blood cells (WBC) | |
| | | such as an infection, | |
| | | inflammation or a disease that | |
| | | affects the production or | |
| | | survival of WBCs; to monitor | |
| | | treatment of a blood disorder or | |
| | | therapy that is known to affect | |
| | | WBCs | |

### Chronic Inflammation

Learning system 100 and present methods can be applied to the identification and calibration of patterns of measures for inflammation that include subjective and self-assessed measures and contextual cues. Inflammation is a normal immune response to injury, including trauma, bacterial or viral infection, burns including sunburn, chemical irritants, frostbite, cuts in the skin, and allergic reactions. Pain, swelling, redness, and warmth are all signs of inflammation arriving at the site of an injury and are the first step in the healing process. Acute inflammation is a brief inflammatory response to an injury or illness that only lasts a few days. Inflammation becomes chronic when the acute response is no longer necessary but a constant low-level physiological response remains. With chronic inflammation, the organism no longer has the ability to turn off the inflammatory response, and the inflammatory response designed to clear out damage starts to cause more damage to healthy tissues. Examples include damaging the intestinal lining of the gut and causing inflammatory bowel disease such as ulcerative colitis and Crohn's disease, damaging the lining of the stomach and causing chronic peptic ulcers, damaging the mucus membranes of the sinuses and causing chronic sinusitis, damaging the gums and causing chronic periodontitis, damaging arteries and causing coronary artery disease and atherosclerosis, damaging the tissues in the joints and causing rheumatoid arthritis, damaging structures in the skin and causing eczema, rosacea, seborrheic dermatitis, and psoriasis, damaging the lungs and causing asthma, chronic obstructive pulmonary disease (COPD), and pulmonary fibrosis, and many other systems. Chronic inflammation also is associated with chronic neurodegenerative diseases such as Alzheimer's disease and Parkinson's disease, and has been associated with the emergence of many cancers.

The five classic signs of acute inflammation from an injury or insult close to the skin and the peripheral nerves have been recognized in medicine for over 2,000 years, and can be remembered by the modern acronym PRISH:
Pain—the inflamed area is likely to be painful, especially when touched. Chemicals that stimulate nerve endings are released, making the area much more sensitive.
Redness—this is because the capillaries are filled up with more blood than usual
Immobility—there may be some loss of function
Swelling—caused by an accumulation of fluid
Heat—as with the reason for the redness, more blood in the affected area makes it feel hot to the touch.

In 1992, the American College of Chest Physicians (ACCP) and the Society of Critical Care Medicine (SCCM) introduced definitions for systemic inflammatory response syndrome (SIRS), sepsis, severe sepsis, septic shock, and multiple organ dysfunction syndrome (MODS). The idea behind defining SIRS was to define a clinical response to a nonspecific insult of either infectious or noninfectious origin. SIRS is defined as 2 or more of the following variables:
Fever of more than 38° C. (100.4° F.) or less than 36° C. (96.8° F.)
Heart rate of more than 90 beats per minute
Respiratory rate of more than 20 breaths per minute or arterial carbon dioxide tension (PaCO2) of less than 32 mm Hg
Abnormal white blood cell count (>12,000/μL or <4,000/μL or >10% immature [band] forms)

SIRS is nonspecific and can be caused by ischemia, inflammation, trauma, infection, or several insults combined. Thus, SIRS is not always related to infection, but it has the advantage that three of the four variables in the model can be readily and accurately measured by home monitoring devices.

When inflammation is chronic and especially when it is deeper in the body, the signs are less specific and can be harder to recognize. Many subjective markers associated with chronic inflammation can be assessed at home or monitored more directly by subjects themselves:
High blood pressure or blood sugar problems
Flare-up of autoimmune conditions: This includes sore joints, ongoing or irritating muscle pains, dry, patchy, and/or red skin, bloodshot eyes, allergies and asthma.
Water retention: Where acute inflammation is often characterized by swelling at the site of injury, systemic inflammation can result in a non-localized water retention.
Gastrointestinal problems and disturbances such as ulcers, constipation, diarrhea, including irritable bowel syndrome.
Stress load: While stress is highly individual and subjective, there are common indicators of stress such as rubbing your temples, face palming, frequent sighing, and pinching the space between your eyes.
Persistent unexplained nasal congestion: Could be related to allergies, hay fever and food allergy, which also may be exacerbated by other inflammation.
Overtraining: Exercise causes inflammation and if done in excess of what the body is ready for or without proper recovery time, this inflammation can become chronic.
Constant feeling of fatigue or lethargy, a subjective measure that can become an essential metric with consistent self-assessment over time. More specific questions can make this metric more concrete as a measurement.

Even if these metrics are subjective and not calibrated to a gold standard, as long as the subject is consistent, such inputs may be included in redox data according to the system and method for consideration as part of an overall pattern of data that could be part of an inflammation measurement. Taken alone, any subjective measure could be a non-specific or harmless artifact, but in combination with other measures they could become an important component of an overall soft-sensor indicator.

The most common way of measuring inflammation is the blood test for CRP or C-Reactive Protein. CRP is a protein produced in the liver that binds with phosphocholine on dead and dying cells and bacteria in order to clear them from the body. With the acute inflammation caused by infection, for example, CRP can spike by up to 50,000-fold. CRP spikes due to acute inflammation peak at around 48 hours and decline pretty quickly thereafter, with a half-life of about 18 hours after the acute phase inflammation peak. With an acute inflammation from an injury, trauma or pathogen, CRP goes back to normal a few days after the incident is resolved. If CRP persists, the injury, infection or trauma probably also persists.

CRP is highly sensitive to many different kinds of stressors, and elevates in response to anything that causes inflammation. It is a valuable marker determining that inflammation is occurring, but it is not specific, so it is difficult to impossible to determine why the inflammation is occurring. Still, CRP is considered an independent predictor of high risk for coronary artery disease. According to the American Heart Association and the Centers for Disease Control and Prevention, a CRP concentration of below 1.0 mg/L indicates low risk for heart problems; between 1.0 to 3.0 mg/L is an average risk for heart problems; above 3.0 mg/L as high risk for heart problems. Very high levels of CRP (more than 10 mg/L) can also indicate impaired immune response or inflammatory disease. If the measurement is over 1.0 mg/L in the absence of any acute stressors, chronic, other sources of systemic inflammation could be the cause. Note that exercise can be a stressor that causes a temporary rise in CRP, as can be pregnancy, so context is an important factor.

White blood cell (WBC) or leukocyte count also is a measure associated with inflammation. White blood cells are an essential agent of the body's immune system and the body produces more when body senses a foreign threat in the bloodstream. A high WBC count (considered to be 10,500 leukocytes per microliter of blood in most labs) can indicate an infection, stress, inflammation, trauma, allergy, or presence of certain diseases, while a count of 4,500-10,500 is within the normal range.

CRP is produced by the liver and increases following the interleukin-6 (IL-6) secretion by T Cells, a type of white blood cell that plays a huge role in the immune response, and macrophages, cells that engulf and digest stray tissue and pathogens. Because both T Cells and macrophages secrete IL-6 as part of the inflammatory response, an elevated IL-6 can indicate systemic inflammation. Other measurements of markers of inflammation are well established in medicine in addition to C-Reactive Protein, White Blood Cells, and Interleukin-6. Most are measured from a blood sample in a lab, but some are accessible with small samples from a finger-stick. Other measures also are found in the stool, urine and other fluids.

The above referenced biomarkers and subjective or self-assessed measures may be included in the redox data for test subjects providing data to learning system 100 for two purposes. First, this data may be used to define or narrow a context in which the learned model can apply. Second, to the extent that the above measures are related to redox status or are correlated with redox status measures, they may be selected as features of the model itself. This becomes more important when such a measure is available or easier to measure in the field than alternative features.

The full set of markers that forms an observable basis 116 for predicting biological age or combined inflammation-aging status available in a lab environment may not be available or practical in the home or field environment (i.e., under local conditions and context). The invention further adjusts the weights with a conditioning module that can further weight observable measures or exclude them based on the availability in the home or field environment, or based on practicality of home or field measurement. An observable basis 116 that also can be measured in the home or field environment may be restricted at first only to narrow contexts or may be very imprecise because of insufficient data to calibrate the home or field measurement. Noting the limitations, the objective is to provide a method to systematically improve the home or field prediction model through local learner 118 that is connected with master learner 114.

Master learner 114 provides local learner 118 with an initial set of weights based on reference bioprocess model 106 that also reflects the cohorts of subjects studied in the lab environment. Local learner 118 then calibrates or trains based on the contextual data and local field measurements. The greatest limitation to useful monitoring in the field is that precise measurement of factors known to be associated with oxidative stress, inflammation and aging are non-specific and difficult to measure in a consistent manner. The invention can be used in applications that address this issue by training both master learner 114 and local learner 118 with the inclusion of passive data sources that are indicators of lifestyle, exercise, diet, disease, and behavioral factors. This includes the direct measurement of activity from wearable devices, the measurement of psychosocial factors and behaviors from social media models, and the measurement of dietary factors from credit card and loyalty card data, and if available, from smart refrigerators or in-home smart assistants like Amazon Alexa and others.

As learning system 100 accumulates a pattern of data associated with oxidative stress, inflammation and aging, including inputs from consumer mobile and social media devices, the system also can be applied to recommending changes to these same behavioral inputs. This can be in the form of a recommendation to the user, or in the form of formulation of medical foods or nutritionals, vitamins or supplements, or inputs to the grocery basket of an online food ordering and delivery service such as Blue Apron.

The system and method described above can be applied in several areas with lab test systems and field measurement approaches that yield more specific data of interest to a therapeutic area or application. This includes but is not limited to the following:

Improved Patient Monitoring Systems.

The system and method can be applied to identifying and training soft-sensor models of oxidative stress that are coupled to or incorporated in patient monitoring systems including oxygen concentration, oxygen consumption rate, glucose concentration, glucose consumption rate and combinations thereof. In vivo measurement at the beginning of energy metabolism process, blood glucose, and at the end of the metabolic process, blood oxygen, are standards of care for many conditions. However, many of the metabolic steps in between remain a “black box”. It is not completely a black box, because we know generally how the system works and we can measure some individual features of that system. 95% of the electrons from the glucose source flow through the electron transport chain to generate cellular energy before ending up in the oxygen sink. 4%-5% of the electrons flow to three systems that are pillars of the antioxidant system responsible for cleaning up the toxic byproducts of cellular respiration and regulating homeostasis in cells. These pillars are Glutathione, Thioredoxin, and Cysteine, all part of the sulfur metabolome. Although the individual components may vary and there may be many alternative pathways that can account for specific measures in the system, there are more specific and more predictive nodes in the network, and the overall balance of reduced sulfur to oxidized sulfur is related to the overall oxidative stress in the system.

Even if biomarkers of energy metabolism can be measured in vivo from blood, plasma, urine, breath, sweat, saliva or other fluids, these biomarkers may lose essential information about their source, such as a specific organ system, injury or infection. The accepted processes of developing clinically validated measurements are further complicated by the calibration of the result because of the fact that the cellular energy system is so adaptable and responsive to environmental variations and stresses. It has been difficult to measure many of the more specific nodes or redox indicators with precision and specificity in vivo because the measurements of interest are in hidden compartments and hard-to-reach systems, and are parts of a complex dynamic network that has evolved to adapt to a wide range of environmental variation, making any measurement highly context dependent. This leads to a Catch-22 situation where the only way to learn and validate surrogate measures may require us to deploy measurement at scale in real-world situations to observe patterns of measures in context, but clinical practice generally will not allow the deployment of such measurements until after they are validated.

The present system and method may be applied under conditions that combine validated measurements of blood oxygen concentration, oxygen consumption rate, and/or blood glucose with candidate redox indicator measurements and other patient data and clinical annotations. This combined vector of redox data would be provided to the learning system according to the invention to identify an observable basis for the internal state of hidden compartments and hard-to-reach systems by training the learning model with a large number of observed patient state vectors that include labeled data from more precise laboratory systems and clinical annotations that relate to the internal state.

The measurement of the electron source, glucose, and the electron sink, oxygen, constrain the possible states available to the system. Blood glucose and total glucose consumption rate, and blood oxygen and total oxygen consumption rate, can be directly measured. Because cellular respiration involves electron flow from glucose to oxygen, these measures can provide strong constraints on the overall metabolic model based on known chemistry, which can be calibrated for the whole person based on a known set of inputs including weight, nutrient intake, and other standard measures.

Clinical annotations and medical records and laboratory systems with more precise measurement capabilities serve as a source labeled data that correspond to specific diagnoses and organ systems. Based on this labeled data, collected from a large number of patient monitoring systems and labs, the system and method can be applied to identifying and training a set of redox indicators of the internal state that more closely associate with specific organ systems.

Medical Foods and Vitamin E Application.

An inherently tunable part of nature's system to regulate balance and maintain a stable state of health in a living system—and a source of potential environmental variation and disturbance—is food. Other tunable inputs include lifestyle factors such as exercise, sleep, stress, living situation, relationship status, stress mitigation activities including meditation, and other behaviors. Biological entities in nature have evolved as part of food systems or networks that provide a complex cocktail of nutrients and behaviors that comprise many of the tunable inputs that maintain homeostasis. After billions of years of natural evolution of these complex networks, human activity has begun to disrupt these networks in unprecedented ways that are not well understood and have led to a rise in chronic diseases in humans and other biological entities, and the instability or even collapse of natural ecosystems.

Some of the simpler dietary inputs have been observed for decades, such as the observations that led to the discovery of Vitamin E in 1922: Rats given a simple diet of carbohydrates, fats and proteins with no vegetables became sterile. Fertility was restored once green leafy vegetables were reintroduced into the diet, leading to the hypothesis that there must be a mystery substance in such vegetables. Vitamin E turned out to be a more complex system of molecules with a number of different forms with different functional outcomes. Of course, food and nutrient balances include a far more complex set of inputs, and a method is needed to uncover and tune a much larger number of parameters to regulate a complex living system in a healthy state for a longer period of time, or to compensate for a growing number of environmental disturbances and insults. Even then, the regulation or control of a complex system still may be limited to specific contexts. The methods presented herein may be applied to learning which subsets parameters can form an observable basis for status of a hidden state in a complex biological entity, and for learning which sets of tunable parameters can be used to regulate a complex biological entity, and can be applied to further improve the measurement and regulation of complex biological entities by learning the contexts in which they apply.

Other subjective measures related to systemic oxidative stress, inflammation and aging which also are potential tunable inputs that in addition to specific diet inputs can be part of a control recommendation from the system include but are not limited to:
Avoiding processed foods that are high sugar, high carbohydrate, high fat, high gluten or high protein from animals that have been subject to concentrated artificial feeding.
Increasing omega-3 and reducing omega-6 intake: Omega-3 fats form the precursors for anti-inflammatory eicosanoids, while Omega-6 fats form the precursors of inflammatory eicosanoids, both of which are part of the inflammatory response. A high ratio of omega-6 to omega-3 fats can produce and imbalanced inflammatory response to normal stimuli.
Improving sleep: Poor or insufficient sleep is linked to elevated inflammatory markers and is a chronic problem especially in developed or urban environments.
Exercising more: In modern societies, many people tend to lead sedentary lives, and this lack of activity is linked to systemic, low-grade inflammation.
Allowing recovery time: Overtraining with too little rest and recovery can produce chronic inflammation.
Mitigating chronic stress: Modern life is stressful and emotional stress has a cumulative effect inflammatory response. This response is compounded by being “always on” without downtime or time in nature that allows the body to recharge.
Improving gut health: The gut houses the bulk of the human immune system which is regulates inflammation, and contains an entire microbiome of organisms that participate in the process.

The food-related inputs to a subject can be measured with a variety of self-reporting devices such as mobile or wearable food loggers. Automated or semi-automated reporting data can be gathered from smart refrigerators or food storage systems that report consumption data and may be accessed directly or via an application program interface. For institutional settings served by a food service operator, restaurant chain, or cafeteria, as well as most agricultural settings where nutrition is provided in an industrialized and planned manner, the meal or nutritional plan and ingredient data can be captured from meal or nutritional planning systems. In addition, generalized information about food consumption patterns can be obtained automatically through purchase behaviors including credit card and loyalty card behaviors. Depending on the precision and confidence in measurement, this food data may be binned based on detailed ingredients and cross-referenced with food databases, or based on more general classifications such as high versus low consumers of categories of food associated with health and redox status, such as fresh fruits and vegetables, red meat, or sugary drinks. Recommendations to changes in tunable inputs such as food choices, composition, vitamins or nutritional supplements be presented to the consumer, shopper or caregiver, or can be implemented automatically in food formulation systems, supplement formulation systems, medical foods, food delivery systems, meal kits and the like. These additional inputs of redox data and annotations can be applied to systems aiming to enhance regulation and control for a wide range of consumer and clinical use cases involving consumer food, medical food, nutritionals, vitamins and supplements.

Skin Care Applications.

The system and method can be adapted for skin care applications that incorporate skin-specific forms of measurement of redox data and annotations that complement sensor or chemical measurement of redox data. One embodiment includes a self-reported skin assessment in combination with mobile imaging of skin regions such as face, blemishes, rashes or other areas of interest. These images may be classified and scored based on skin assessment data using automated machine learning methods to provide data with increasing structure related to skin conditions and skin care. In addition, control inputs related to skin can be measured through purchase behavior monitoring, self-reporting, and also through direct measurement, or measurement of subject location from a smartphone or other location measurement system and access to location-based databases with solar radiation or UV data by location.

Neuro-Degenerative Diseases and Mental Health Applications.

The system and method can be applied to systems targeting redox balance and oxidative stress associated with many neuro-degenerative diseases including Parkinson's Disease, Alzheimer's Disease, depression, anxiety, attention deficit and other conditions that have been difficult to measure especially in their earlier days. In addition to measuring dietary and lifestyle inputs through self-reporting, mobile or wearable devices, and monitoring of purchase behaviors, important metrics of neuro-degenerative diseases and mental health conditions can be yielded from social media behaviors and communications data alone or in combination with other activity data, including sentiment analysis and classification of communications.

Diabetes and Metabolic Syndrome Monitoring and Management Systems.

The system and method can be applied to systems for the management of diabetes and metabolic syndrome. In combination with blood glucose monitoring, insulin delivery systems, including implantable insulin delivery devices, continuous blood glucose monitors, and closed-loop systems, and other regiments aimed at improving the monitoring and management of blood glucose in diabetes and metabolic syndrome or pre-diabetes, the above teachings can be combined with existing glucose monitoring regimens to improve the management and care of subjects. Blood glucose and related analytes can be an important redox-related field measurement especially in combination with measurement and control of diet and lifestyle inputs which may be supplemented by the diet and behavioral measurement described above.

Industrial Biology Applications.

The systems and methods herein may be implemented in a system designed as a bioreactor monitoring and control agent in which existing data on bioreactor operational status accessed via a direct connection or application program interface. Control signals to the bioreactor with respect to a specific ingredient or combination of ingredients or controls can be transmitted to the operating control system for the bioreactor via a direct connection or application program interface. Examples include increasing or decreasing a specific enzyme used in bioreactor production to extend the productive stationary phase based on monitoring redox status signals.

Agriculture Applications.

The systems and methods herein may be applied to agriculture management applications designed to improve the feeding, nutrition and management of livestock and other animals used for food, food production, and other purposes. They may be used for crop nutrition, fertilization, and management in the same manner. The methods also can be deployed to identify an observable basis for systemic health status of agricultural land, ecosystems and food webs when an anchor measure of such systems can be described, such as productive yield or other measures of health and productivity.

The above teachings are provided as reference to those skilled in the art in order to explain the salient aspects of the invention. It will be appreciated from the above disclosure that a range of variations on the above-described examples and embodiments may be practiced by the skilled artisan without departing from the scope of the invention(s) herein described. The scope of the invention should therefore be judged by the appended claims and their equivalents.

1. A learning system for learning a redox status of a bioprocess having hidden states, said learning system comprising:
a) a reference bioprocess model configured to yield model redox data for said bioprocess under model conditions;
b) a master learner configured to receive said model redox data and to establish therefrom an observable basis of redox indicators;
c) at least one local biological entity undergoing said bioprocess under local conditions and generating measured redox data for said bioprocess;
d) a local learner configured to receive said measured redox data and at least a portion of said model redox data;
wherein said learning system deploys a learning algorithm distributed between said master learner and said local learner to learn an optimal composition of said measured redox data under said local conditions.

2. The learning system of claim 1, wherein said reference bioprocess model is further configured to receive a reference model adjustment from said learning algorithm.

3. The learning system of claim 2, wherein said reference model adjustment comprises alteration in said model redox data.

4. The learning system of claim 2, wherein said reference model adjustment comprises alteration in said model conditions.

5. The learning system of claim 2, wherein said reference model adjustment comprises alteration in said hidden states.

6. The learning system of claim 1, wherein said learning algorithm learns and communicates to said master learner an adjustment in said observable basis of redox indicators.

7. The learning system of claim 1, wherein said at least one local biological entity undergoing said bioprocess is configured to receive a local conditions adjustment from said learning algorithm.

8. The learning system of claim 7, wherein said local conditions adjustment comprises alteration in said optimal composition of said measured redox data.

9. The learning system of claim 7, wherein said at least one local biological entity comprises a live subject.

10. The learning system of claim 7, wherein said at least one local biological entity comprises a bioreactor.

11. The learning system of claim 1, wherein said measured redox data comprises redox indicators in said observable basis of redox indicators established by said master learner, thereby presenting observable redox indicators.

12. The learning system of claim 11, wherein said observable redox indicators are assigned a weighting by said learning algorithm.

13. The learning system of claim 11, wherein said observable redox indicators are assigned a confidence level by said learning algorithm.

14. The learning system of claim 11, wherein said observable redox indicators are measured on time scales shorter than Gene-Protein-Reaction (GPR) time.

15. The learning system of claim 1, wherein said learning algorithm comprises a primary feedback loop between said master learner and said local learner for adjusting said measured redox data.

16. The learning system of claim 15, wherein said measured redox data comprises redox indicators in said observable basis of redox indicators, and wherein said primary feedback loop is configured for adjusting said redox indicators in said observable basis.

17. The learning system of claim 15, wherein said primary feedback loop further comprises a primary feedback mechanism configured to operate on at least one control parameter selected from the group consisting of a redox active compound and an electron balance influencer.

18. The learning system of claim 1, wherein said learning algorithm comprises a secondary feedback loop between said local learner and said at least one local biological entity.

19. The learning system of claim 18, further comprising a local feedback mechanism between said local learner and said at least one local biological entity.

20. The learning system of claim 19, wherein said local feedback mechanism is configured to operate on at least one control parameter selected from the group consisting of redox active compounds and electron balance influencers.

21. The learning system of claim 1, wherein said learning system employs at least one learning method selected from the group consisting of an Artificial Intelligence method, a hidden Markov method, a Deep Learning method.

22. The learning system of claim 1, wherein said reference bioprocess model is obtained from a reference biological entity undergoing said bioprocess.

23. The learning system of claim 22, wherein said reference biological entity is a reference live subject.

24. The learning system of claim 22, wherein said reference biological entity is a reference bioreactor.

25. The learning system of claim 22, further comprising a reference feedback mechanism between said master learner and said reference biological entity.

26. The learning system of claim 1, wherein said model redox data and said measured redox data comprises at least one electron balance indicator.

27. The learning system of claim 26, wherein said at least one electron balance indicator is selected from a group of indicators consisting of an oxidoreductase, an oxidoreductase co-factor, an electron balance influencer compound, an electron balance influencer composition, a redox-active compound, a pK value, a pH value, a threshold value, a context measure and a soft indicator.

28. The learning system of claim 26, wherein said at least one electron balance indicator is measured at least once every 5 minutes, at least once every minute, at least once every 30 seconds, at least once every 10 seconds, at least once every 5 seconds, at least once every second, at least twice every second, at least 5 times every second, at least 10 times every second, at least 20 times every second, at least 50 times every second, at least 100 times every second, or more.

29. The learning system of claim 1, wherein said model redox data and said measured redox data comprises at least one electron balance influencer.

30. The learning system of claim 1, wherein said model redox data is provided by said reference bioprocess model and by a reference biological entity undergoing said bioprocess.

31. A method for learning a description of a redox status of a bioprocess with hidden states, said method comprising:
a) defining model redox data for said bioprocess from a reference bioprocess model under model conditions;
b) transmitting said model redox data to a master learner configured to establish therefrom an observable basis of redox indicators;
c) subjecting at least one local biological entity to said bioprocess under local conditions to generate measured redox data for said bioprocess;
d) transmitting said measured redox data and at least a portion of said model redox data to a local learner;
wherein said learning system deploys a learning algorithm distributed between said master learner and said local learner to learn an optimal composition of said measured redox data under said local conditions to describe said redox status.

32. The method of claim 31, further comprising:
a) learning a reference model adjustment by said learning algorithm; and
b) applying said reference model adjustment to said reference bioprocess model.

33. The method of claim 32, wherein applying said reference model adjustment comprises altering said model redox data.

34. The method of claim 32, wherein applying said reference model adjustment comprises altering said model conditions.

35. The method of claim 32, wherein applying said reference model adjustment comprising altering said hidden states.

36. The method of claim 31, further comprising:
a) learning by said learning algorithm an adjustment in said observable basis of redox indicators; and
b) communicating said adjustment in said observable basis of redox indicators to said master learner.

37. The method of claim 30, further comprising applying a local conditions adjustment by said learning algorithm to said at least one local biological entity undergoing said bioprocess.

38. The method of claim 37, wherein applying said local conditions adjustment comprises altering said optimal composition of said measured redox data.

39. The method of claim 37, wherein said at least one local biological entity comprises a live subject.

40. The method of claim 37, wherein said at least one local biological entity comprises a bioreactor.

41. The method of claim 31, further comprising the step of selecting redox indicators in said observable basis to present observable redox indicators.

42. The method of claim 41, further comprising the step of assigning a weighting by said learning algorithm to said observable redox indicators.

43. The method of claim 41, further comprising the step of assigning a confidence level by said learning algorithm to said observable redox indicators.

44. The method of claim 41, further comprising measuring said observable redox indicators on time scales shorter than Gene-Protein-Reaction (GPR) time.

45. The method of claim 31, further comprising the step of adjusting said measured redox data in a primary feedback loop between said master learner and said local learner.

46. The method of claim 45, wherein said measured redox data is selected from said redox indicators in said observable basis of redox indicators.

47. The method of claim 45, further comprising the step of operating on at least one control parameter selected from the group consisting of redox active compounds, and electron balance influencers.

48. The method of claim 31, further comprising the step of providing a secondary feedback loop between said local learner and said local biological entity.

49. The method of claim 48, further comprising the step of providing a local feedback mechanism between said local learner and said local biological entity, said local feedback mechanism being configured for operating on at least one control parameter selected from the group consisting of electron balance influencers, electron balance indicators, contextual parameters.
